(19) United States
(12) Patent Application Publication
(10) Pub. No.: US 2026/0223162 A1
(43) Pub. Date: Jul. 30, 2026

(54) METHOD PERFORMED BY USER EQUIPMENT, AND USER EQUIPMENT

(71) Applicant: Sharp Kabushiki Kaisha, Sakai City, Osaka (JP)

(72) Inventors: Chao LUO, Shanghai (CN); Yinan ZHAO, Shanghai (CN); Renmao LIU, Shanghai (CN)

(21) Appl. No.: 19/146,328

(22) PCT Filed: Dec. 29, 2023
(86) PCT No.: PCT/CN2023/143429

§ 371 Date: Jul. 8, 2025

(30) Foreign Application Priority Data
Jan. 10, 2023 (CN) 202310038021.1

(51) Int. Cl. H04W 74/08; H04W 92/18

(52) U.S. Cl. CPC H04W 74/08; H04W 92/18

(57) ABSTRACT

According to the present invention, provided are a method performed by a user equipment, and a user equipment. The method performed by a user equipment comprises: determining multiple sidelink transmissions to be performed in one or more slots, and performing a type 1 channel access procedure, so as to initiate a channel occupancy time (COT) for the multiple sidelink transmissions, wherein a channel access priority class (CAPC) value for the type 1 channel access is a maximum value among CAPC values associated with the multiple sidelink transmissions, respectively.

### TECHNICAL FIELD

The present invention relates to a method performed by a user equipment, and a user equipment.

### BACKGROUND ART

In a wireless communication system, information may be exchanged between different communication nodes. Wireless communication may be performed on a licensed spectrum and/or an unlicensed spectrum. One example of a wireless communication system is a system standardized by the 3rd Generation Partnership Project (3GPP), for example, a 4G system based on Long-Term Evolution (LTE) radio access technology or an evolved system thereof, or a 5G system based on New Radio (NR) radio access technology or an evolved system thereof. In a communication system based on 3GPP specifications, examples of the communication nodes may include a user equipment (UE) and a base station (e.g., an eNB or a gNB). A radio link from a base station to a UE may be referred to as a downlink (DL). A radio link from a UE to a base station may be referred to as an uplink (UL). A radio link between UEs may be referred to as a sidelink (SL). An interface for wireless transmission and/or reception between a base station and a UE may be referred to as a Uu interface (e.g., an NR-Uu interface based on NR, or an LTE-Uu interface based on LTE). An interface for wireless transmission and/or reception between UEs may be referred to as a PC5 interface.

In order to support communication on a licensed spectrum and/or an unlicensed spectrum, a series of issues need to be addressed, such as channel access mechanisms, physical layer channel and/or signal structures, physical layer control information and/or signaling procedures (e.g., a synchronization procedure and a feedback and/or determination mechanism), control information and/or signaling procedures of a higher layer, resource allocation and/or management, and coexistence among different systems.

### PRIOR ART DOCUMENTS

### Non-Patent Documents

Non-Patent Document 1: RP-152293, New WI proposal: Support for V2V services based on LTE sidelink, 3GPP TSG RAN Meeting #70
Non-Patent Document 2: RP-170798, New WID on 3GPP V2X Phase 2, 3GPP TSG RAN Meeting #75
Non-Patent Document 3: RP-170855, New WID on New Radio Access Technology, 3GPP TSG RAN Meeting #75
Non-Patent Document 4: RP-190766, New WID on 5G V2X with NR sidelink, 3GPP TSG RAN Meeting #83
Non-Patent Document 5: RP-201385, WID revision: NR sidelink enhancement, 3GPP TSG RAN Meeting #88e
Non-Patent Document 6: RP-221938, Revised WID on NR sidelink evolution, 3GPP TSG RAN Meeting #97e

### SUMMARY OF THE INVENTION

In order to solve at least some of the above issues, the present invention provides a method performed by a user equipment, and a user equipment, whereby a corresponding recovery timer is set when a consistent LBT failure is triggered for a resource pool, and the consistent LBT failure is canceled after the recovery timer times out, such that a UE can recover from consistent LBT failure without being connected to a base station.

According to the present invention, a method performed by a user equipment is provided. The method is characterized by comprising: determining multiple sidelink transmissions to be performed in one or more slots, and performing a type 1 channel access procedure, so as to initiate a channel occupancy time (COT) for the multiple sidelink transmissions, wherein a channel access priority class (CAPC) value for the type 1 channel access is a maximum value among CAPC values associated with the multiple sidelink transmissions, respectively.

Furthermore, according to the present invention, a user equipment is provided, comprising: a processor; and a memory storing instructions, wherein the instructions, when run by the processor, perform the above method.

Therefore, the present invention provides a method whereby a corresponding recovery timer is set when a consistent LBT failure is triggered for a resource pool, and the consistent LBT failure is canceled after the recovery timer times out, such that a UE can recover from consistent LBT failure without being connected to a base station.

### BRIEF DESCRIPTION OF THE DRAWINGS

The above and other features of the present invention will be more apparent from the following detailed description in combination with the accompanying drawings, in which:

FIG. 1 shows a flowchart corresponding to a method performed by a user equipment according to Embodiment 1 of the present invention.

FIG. 2 shows a flowchart corresponding to a method performed by a user equipment according to Embodiment 2 of the present invention.

FIG. 3 shows a flowchart corresponding to a method performed by a user equipment according to Embodiment 3 of the present invention.

FIG. 4 shows a flowchart corresponding to a method performed by a user equipment according to Embodiment 4 of the present invention.

FIG. 5 shows a flowchart corresponding to a method performed by a user equipment according to Embodiment 5 of the present invention.

FIG. 6 shows a block diagram of a user equipment according to the present invention.

### DETAILED DESCRIPTION OF PREFERRED EMBODIMENTS

The following describes the present invention in detail with reference to the accompanying drawings and specific embodiments. It should be noted that the present invention should not be limited to the specific embodiments described below. In addition, detailed descriptions of well-known technologies not directly related to the present invention are omitted for the sake of brevity, in order to avoid obscuring the understanding of the present invention.

A plurality of embodiments according to the present invention will be specifically described below using 5G (also referred to as NR or 5G NR) wireless communication system specifications formulated by the 3GPP and subsequent evolved versions thereof (e.g., 5G Advanced) as an exemplary application environment. However, it shall be noted that the present invention is not limited to the following embodiments, but rather is applicable to many other wireless communication systems, such as wireless communication systems later than 5G, or 4G mobile communication systems earlier than 5G, e.g., Long Term Evolution (LTE), LTE-Advanced, LTE-Advanced Pro, etc.

The terms given in the present invention may be named differently in different wireless communication systems, but unified terms are used in the present invention. When applied to a specific system, the terms may be replaced with terms used in the corresponding system.

Unless otherwise specified, in all embodiments and implementations of the present invention:
A “node” (or “communication node”) may be a UE, or a network node (e.g., a base station).
A “base station” may be an E-UTRAN Node B (eNB; E-UTRAN stands for Evolved Universal Terrestrial Radio Access Network), or a gNB (a node which provides to a UE termination of NR user plane and control plane protocols and is connected to a 5G core network via an NG interface), or an ng-eNB (a node which provides to a UE termination of E-UTRA user plane and control plane protocols, and is connected to a 5G core network via an NG interface; E-UTRA stands for Evolved Universal Terrestrial Radio Access), or another node having a similar function.
“Higher layer(s)” or “upper layer(s)” may refer to, in a specific protocol stack, one or more protocol layers or protocol sub-layers above a reference protocol layer or a reference protocol sub-layer. For example, if the reference protocol layer or the reference protocol sub-layer is a physical layer (also referred to as “Layer 1”), “higher layer” may refer to a Medium Access Control (MAC) layer, and/or a Radio Link Control (RLC) layer, and/or a Packet Data Convergence Protocol (PDCP) layer, and/or a PC5-RRC (Radio Resource Control) layer, and/or a PC5-S layer, and/or an RRC layer, and/or another protocol layer or protocol sub-layer. Unless otherwise specified, the reference protocol layer or the reference protocol sub-layer is a physical layer. A “higher layer” may also be referred to as a “high layer” if this causes no ambiguity.
“Lower layer(s)” may refer to one or more protocol layers or protocol sub-layers below a reference protocol layer or a reference protocol sub-layer in a specific protocol stack. For example, if the reference protocol layer or the reference protocol sub-layer is the RRC layer, then “lower layer” may refer to the MAC layer, and/or the physical layer; as another example, if the reference protocol layer or the reference protocol sub-layer is the MAC layer, then “lower layer” may refer to the physical layer. Unless otherwise specified, the reference protocol layer or the reference protocol sub-layer is the MAC layer. A “lower layer” may also be referred to as a “low layer” if this causes no ambiguity.
“Signaling” may refer to signaling of a physical layer, or signaling of a higher layer.
“Configure” may mean that in a communication node (e.g., a UE), a protocol layer (e.g., an RRC layer) entity provides configuration information to an entity of another protocol layer (e.g., a physical layer).
“Configure” may mean that a protocol layer (e.g., an RRC layer) entity of a communication node (e.g., a base station) provides configuration information to a peer protocol layer entity of another communication node (e.g., a UE) (for example, transmission, from the base station to the UE, of RRC signaling in which the configuration information is included, or transmission, from a UE-A to a UE-B, of PC5-RRC signaling in which the configuration information is included).
“Pre-configure” may mean that corresponding configuration information is preset in a specific storage location in a communication node (e.g., a UE), or corresponding configuration information is preset in a specific storage location accessible by a UE.
“Configure” may refer to “configure or pre-configure”.
“Number” may refer to “total number”. For example, “the number of subchannels in a resource pool” may refer to the total number of subchannels in the resource pool.
For N=1, the sequence “a₀, a₁, . . . , a_{N-1}” may be expressed as a₀.
The order in which the respective elements in a time sequence (e.g., denoted as t₀, t₁, . . . , t_{N-1}) may be the chronological order thereof. For example, the time corresponding to t₀ is earlier than the time corresponding to t₁.
μ may represent a subcarrier spacing configuration, for example μ=0. Δf may represent a corresponding subcarrier spacing (SCS). For example, μ=0 corresponds to Δf=15 kHz.
A “symbol” may refer to an Orthogonal Frequency Division Multiplexing (OFDM) symbol.
A resource may correspond to one or a plurality of the following:
   One or more parameters in a time-domain. For example, a starting symbol of the resource, a starting slot of the resource, the number of symbols occupied by the resource, or the number of slots occupied by the resource.
   One or more parameters in a frequency-domain. For example, a starting sub-channel of the resource, a starting resource block (RB) of the resource, a starting subcarrier of the resource, the number of sub-channels occupied by the resource, the number of RBs occupied by the resource, or the number of subcarriers occupied by the resource.
   One or more parameters in a code-domain. For example, a cyclic shift value corresponding to the resource or a corresponding cyclic shift index, or a cyclic shift pair value corresponding to the resource or a corresponding cyclic shift pair index.
   One or more parameters in a spatial-domain. For example, a layer corresponding to the resource, where a “layer” may refer to a Multiple Input Multiple Output (MIMO) layer.
A “layer” may refer to one of the one or more layers to which a Transport Block (TB) is mapped in spatial multiplexing. The mapping may also be considered as a mapping of a codeword corresponding to the TB to the one or more layers.
An “RB” may refer to a Physical Resource Block (PRB), a Virtual Resource Block (VRB), a common resource block (CRB), or an Interlaced Resource Block (IRB).
“Numbering” and “indexing” are interchangeable. For example, the number of an RB may also be referred to as the index of the RB. As another example, “numbering an RB as 0” may also be expressed as “indexing an RB as 0”.
An RB represented by a CRB number may also be represented by a corresponding PRB number, and vice versa.
The numbering of elements in a sequence (or an array, or a list, or an ordered set, or the like) may start from 0. For example, the first RB of an RB set may be referred to as RB 0 of the RB set.
An object (e.g., a subcarrier, a slot, a cyclic shift, etc.) may be represented by its index, wherein the index may be an index within a set. For example, in the set of CRBs

$${A}_{CRB}^{ref} = \{ {a}_{0}^{ref} , {a}_{1}^{ref} , {a}_{2}^{ref} , {a}_{3}^{ref} , {a}_{4}^{ref} \} ,$$

the index of

$${a}_{0}^{ref}$$

is 0.
In signaling, an object may be indicated by the index of the object.
If an object is mentioned without a number thereof being specified, then the number of the object may be singular or plural. For example, in the expression “performing transmission(s) on a channel”, the “transmission(s)” may correspond to one transmission, or a plurality of transmissions.
Δ(x₁, x₂) may represent an offset between x₁ and x₂, wherein x₁ and x₂ may be two parameters (or variables) that can be compared, or two possible values of one parameter (or variable) (e.g., x₁ and x₂ may be two slots, or two sub-frames, or two frames or two subcarriers, or two RBs, or two sub-channels, etc.).
Δ(x₁, x₂) may be equal to x₂−x₁. For example, a set of CRBs is denoted as

$${A}_{CRB}^{ref} = \{ {a}_{0}^{ref} , {a}_{1}^{ref} , {a}_{2}^{ref} , {a}_{3}^{ref} , {a}_{4}^{ref} \} ,$$

wherein

$${a}_{0}^{ref} = 5 , {a}_{1}^{ref} = 15 , {a}_{2}^{ref} = 25 , {a}_{3}^{ref} = 35 and$$

$${a}_{4}^{ref} = 45 , and {x}_{1} = {a}_{0}^{ref}$$

and

$${x}_{2} = {a}_{3}^{ref} ,$$

then Δ(x₁, x₂) may be equal to

$${a}_{3}^{ref} - {a}_{0}^{ref} = 35 - 5 = 30 .$$

Δ(x₁, x₂) may be equal to idx(x₂)−idx(x₁), wherein idx(x₁) and idx(x₂) are indexes of elements corresponding to x₁ and x₂ in the same set, respectively. For example, a CRB set is denoted as

$${A}_{CRB}^{ref} = \{ {a}_{0}^{ref} , {a}_{1}^{ref} , {a}_{2}^{ref} , {a}_{3}^{ref} , {a}_{4}^{ref} \} ,$$

wherein

$${a}_{0}^{ref} = 5 , {a}_{1}^{ref} = 15 , {a}_{2}^{ref} = 25 , {a}_{3}^{ref} = 35 and {a}_{4}^{ref} = 45 , and {x}_{1} = {a}_{0}^{ref} and {x}_{2} = {a}_{3}^{ref} ,$$

Δ(x₁, x₂) may be equal to 3−0=3.
The “offset between x₁ and x₂” may also be referred to as an offset of x₂ with respect to x₁ or an offset of x₂ relative to x₁.
The “offset between x₁ and x₂” may also be referred to as an offset from x₁ to x₂.
If Δ(x₁, x₂)=D, then x₂ may be denoted as x₂=ADD(x₁, D).
If Δ(x₁, x₂)=D, then x₁ may be denoted as x₁=SUBTRACT(x₂, D).
An offset between two subcarriers may be an offset between the center frequencies of the two subcarriers.
A modulo operation may be defined as r≡a mod N, wherein
   r is a remainder;
   a=N×q+r, wherein q=└a/N┘. q may be referred to as an integer quotient of a and N.
   0≤r<|N|.
A round operation may be denoted as b=round(a), wherein b may be defined as the integer closest to a. If there are two integers closest to a, b may be defined as the larger of the two integers, or as the smaller of the two integers.
Sidelink control information (SCI) may refer to 1^{st}-stage SCI and/or 2^{nd}-stage SCI.
SL refers to NR SL.
“Sidelink” refers to an NR sidelink.
“Carrier” refer to a sidelink carrier.
“Bandwidth part” refers to a sidelink bandwidth part.
“Resource pool” refers to a sidelink resource pool.
A “sidelink slot” may refer to a slot in which a sidelink resource has been configured. The “sidelink resource” may or may not include a resource for a specific purpose. The “resource for a specific purpose” may be a resource for a synchronization procedure, for example, a resource for transmitting an S-SS/Physical Sidelink Broadcast Channel or Sidelink-Synchronization Signal/Physical Sidelink Broadcast Channel (S-SS/PSBCH) block.
A “physical slot” may refer to a slot belonging to a certain set of physical slots, where the set of physical slots may be all of the slots in a continuous period of time (e.g., a frame period having a duration of 1024 frames). Physical slots in the set of physical slots may be sequentially numbered as 0, 1, . . . in chronological order.
A “logical slot” may refer to a slot belonging to a set of slots of a certain resource pool, where the set of slots may be all of the slots belonging to the resource pool in a continuous period of time (e.g., a frame period having a duration of 1024 frames); logical slots in the set of slots may be sequentially numbered as 0, 1, . . . in chronological order.
A “logical slot” may refer to a slot that may be configured to belong to a set of slots of a certain resource pool.
A “sidelink slot” may refer to a slot that belongs to a set of slots of a certain resource pool.
A “sidelink slot” may refer to a slot that may be configured to belong to a set of slots of a certain resource pool.
A set of sidelink symbols in an sidelink slot may be denoted as

$${L}_{SL} = \{ {l}_{0}^{SL} , {l}_{1}^{SL} , … , {l}_{{N}_{length}^{S L} - 1}^{S L} \} ,$$

wherein

$${l}_{0}^{S L} , {l}_{1}^{SL} , … , and {l}_{{N}_{length}^{S L} - 1}^{SL}$$

represent the indexes of corresponding symbols in the slot, respectively, wherein

$${l}_{0}^{SL} = {l}_{start}^{SL} , {l}_{1}^{SL} = {l}_{start}^{S L} + 1 , … , {l}_{{N}_{length}^{SL} - 1}^{SL} = {l}_{start}^{SL} + {N}_{length}^{SL} - 1 ,$$

wherein

$${l}_{start}^{SL}$$

is the index of the first sidelink symbol in the slot (e.g., configured via parameter sl-StartSymbol), and

$${N}_{length}^{SL}$$

is the number of sidelink symbols in the slot (e.g., configured via the parameter sl-LengthSymbols).
A sidelink transmission which multiplexes a Physical Sidelink Shared Channel (PSSCH) and a Physical Sidelink Control Channel (PSCCH) associated therewith in the same resource (e.g., a number of continuous symbols in a sidelink slot in a time-domain, and a number of continuous sub-channels in a frequency-domain) may be referred to as a “PSCCH/PSSCH transmission”.
In a time-domain, a “frame” (also referred to as a “radio frame”) may be a system frame or a direct frame. A frame number period (e.g., denoted as T_{FNP}) may be a pre-defined or configured value, or may be determined according to one or more pre-defined or configured values, e.g., T_{FNP}=1024 frames. The duration of each frame may be T_{f}=10 milliseconds, in which 10 subframes may be included, where the duration of each subframe is T_{sf}=1 millisecond. Each subframe may include

$${N}_{slot}^{subframe , μ}$$

slots, e.g.,

$${N}_{slot}^{subframe , μ} = {2}^{μ} .$$

The index of a slot in a subframe may be denoted as

$${n}_{s}^{μ} ( {n}_{s}^{μ} ∈ \{ 0 , 1 , … , {N}_{slot}^{subframe , μ} - 1 \} ) .$$

The index of a slot in a frame may be denoted as

$${n}_{s , f}^{μ} ( {n}_{s , f}^{μ} ∈ \{ 0 , 1 , … , {N}_{slot}^{frame , μ} - 1 \} ) ,$$

wherein

$${N}_{slot}^{frame , μ}$$

may be equal to 10·2^{μ}. The index of a slot in a frame numner phod may be denoted as

$${n}_{s , f , p}^{μ} ( {n}_{s , f , p}^{μ} ∈ \{ 0 , 1 , … , {N}_{slot}^{FNP , μ} - 1 \} ) ,$$

wherein

$${N}_{slot}^{FNP , μ}$$

may be equal to

$${T}_{FNP} \cdot {N}_{slot}^{frame , μ}$$

(e.g., 1024·(10·2^{μ})).
“Sidelink grant” may refer to “sidelink dynamic grant or sidelink configured grant”.
“Sidelink dynamic grant” and “dynamic sidelink grant” are interchangeable.
“Sidelink configured grant” and “configured sidelink grant” are interchangeable.
“Type 1 sidelink configured grant” and “sidelink configured grant type 1” are interchangeable.
“Type 2 sidelink configured grant” and “sidelink configured grant type 2” are interchangeable.
“Channel” refers to a shared spectrum channel. For example, a shared spectrum channel having a bandwidth of 20 MHz on which a “channel access procedure” may be performed.

5G is capable of operating in both a licensed spectrum (e.g., some or all of 3300 MHz to 3800 MHz) and an unlicensed spectrum (e.g., some or all of 5150 MHz to 5925 MHz, some or all of 5925 MHz to 7125 MHz, or some or all of 5925 MHz to 6425 MHz).

For an unlicensed spectrum, a communication node that supports an “operation with shared spectrum channel access” in 5G may perform a “channel access procedure” (also referred to as single-channel access procedure, and also referred to as channel access procedure for transmission(s) on a single channel) on a “shared-spectrum channel” (also referred to as “channel” for short), or perform a “multi-channel access procedure” (also referred to as channel access procedure for transmission(s) on multiple channels) on a plurality of shared-spectrum channels, so as to assess whether some or all of the corresponding one or more shared spectrum channels can be used to perform (one or more) transmission(s) (for example, downlink transmission, uplink transmission, or sidelink transmission), wherein one shared-spectrum channel may include a number of contiguous RBs. In the present invention, unless otherwise specified, a “channel access procedure” (or “channel access”) may correspond to a channel access procedure for single-channel transmission or a channel access procedure for multi-channel transmission. The result of a channel access procedure may be “success” (also referred to as “channel access success” or “LBT success”) or “failure” (also referred to as “channel access failure” or “LBT failure”).

A shared spectrum channel may correspond to a carrier, or part of the carrier. For example, one shared spectrum channel may correspond to one carrier having a bandwidth of 20 MHz; as another example, one shared spectrum channel may correspond to the lower-frequency 20-MHz portion of one carrier having a bandwidth of 40 MHz, and another shared spectrum channel may correspond to the other 20-MHz portion (i.e., the higher-frequency 20-MHz portion) of the same carrier.

The operation of assessing whether the one or more shared spectrum channels can be used to perform one or more transmission(s) may be referred to as Clear Channel Assessment (CCA). Such a mechanism of first performing CCA before using one or more shared spectrum channels may be referred to as Listen Before Talk (LBT), and accordingly, each of the one or more shared spectrum channels may be referred to as an “LBT channel”. Whether a communication node needs to perform CCA (also referred to as “needs to perform LBT”), and a specific procedure of the CCA, may be related to the regulations of the country and/or region in which the communication node is located.

One or more “sensing” operations may be performed on a channel during channel access, wherein the state of the channel (e.g., “busy”; or e.g., “idle”) may be determined in each sensing operation. For example, within a sensing slot duration Tₛₗ, if a duration in which power detected on the channel (e.g., denoted as X_{detected}) is less than (or, less than or equal to) a power detection threshold (e.g., denoted as Xₜₕᵣₑₛₕ) is at least T_{sl,thresh}, then it can be considered that the channel is idle within the sensing slot duration Tₛₗ; otherwise, it can be considered that the channel is busy within the sensing slot duration Tₛₗ. T_{sl,thresh} may be a pre-defined or configured value, e.g., T_{sl,thresh}=4 μs. The sensing slot duration Tₛₗ may be a pre-defined or configured value, e.g., Tₛₗ=9 μs.

In a channel access procedure for single-channel transmission performed for one or more intended transmissions, whether some or all of the one or more intended transmissions can be performed can be determined, and/or the result of the single-channel access procedure can be determined, on the basis of one or more sensing operations on a channel (e.g., denoted as ch₀) within a first channel access duration, with the duration of each operation being a second channel access duration (e.g., this may correspond to a sensing slot duration Tₛₗ), and according to the state (e.g., “idle”; or e.g., “busy”) of the channel ch₀ determined in each “sensing” operation. For example, if, within the first channel access duration, the number of times which the channel ch₀ is consecutively determined to be “idle” reaches (or exceeds) a pre-defined or configured threshold, then the one or more intended transmissions may be performed, and/or the channel ch₀ may be considered to have been successfully accessed (correspondingly, the result of the channel access procedure is “success”, also referred to as “channel access success”, and also referred to as “LBT success”); otherwise, the one or more intended transmissions cannot be performed, and/or it may be considered that the channel ch₀ cannot be accessed (correspondingly, the result of the channel access procedure is “failure”, also referred to as “channel access failure”, and also referred to as “LBT failure”).

In a channel access procedure for multi-channel transmission performed for one or more intended transmissions, channel access may be performed on some or all of the channels in a set of channels respectively, and according to channel access result(s) corresponding to one or more of the channels, respectively, whether some or all of the one or more intended transmissions may be performed is determined, and/or the result of the multi-channel access procedure is determined (for example, the result may be “success”, also referred to as “channel access success”, and also referred to as “LBT success”; or, the result may be “failure”, also referred to as “channel access failure”, and also referred to as “LBT failure”).

After a channel access procedure is performed, (one or more) transmissions performed on the corresponding (one or more) channel(s) may be referred to as “channel occupancy” (CO), and a corresponding duration may be referred to as a “channel occupancy time” (COT). A COT may be shared between one or more communication nodes, and accordingly, the time corresponding to the COT may include the duration of (one or more) transmissions performed by the one or more communication nodes on the corresponding (one or more) channels, and optionally, the time corresponding to a transmission gap between the transmissions (e.g., when the duration of the transmission gap is less than or equal to 25 us). A COT may not exceed a pre-defined or configured maximum value (e.g., referred to as a maximum COT, or simply referred to as a MCOT).

The channel access procedures may be classified into a plurality of types according to usage, applicable scenarios, etc. For example, “Type 1 channel access procedure” may correspond to the case in which

$${T}_{l a s t , i n t v l}^{s n s}$$

is a random value, and for example, “Type 2 channel access procedure” may correspond to the case in which

$${T}_{l a s t , i n t v l}^{s n s}$$

is a definite value, wherein

$${T}_{l a s t , i n t v l}^{s n s}$$

is the time spanned by (one or more) sensing slots which precede (one or more) transmissions associated with the corresponding channel access procedure and which have a sensing result of “idle”. A type 1 channel access procedure may be used to “initiate” a COT; a type 2 channel access procedure may be used to perform channel access in a COT shared by other communication nodes.

A channel access procedure (e.g., a type 1 channel access procedure) may be associated with a Channel Access Priority Class (CAPC). When there is no risk of confusion, a CAPC value may be referred to as a CAPC for short. For example, “a CAPC value corresponding to type 1 channel access is 1” may be expressed as “a CAPC corresponding to type 1 channel access is 1”.

A UE (e.g., referred to as an “initiating UE”) may share a COT (or a remaining time of the COT) initiated thereby with (one or more) other UEs (e.g., referred to as “responding UE”). The initiating UE may, by means of signaling (e.g., SCI; or MAC CE; or RRC message) transmitted on a sidelink, indicate information related to the COT to be shared. A UE that receives a COT sharing indication may use the corresponding COT when one or more conditions are met, and/or may not use the corresponding COT when one or more conditions are met.

In a communication system (e.g., a communication system using NR technology), the start time of an intended transmission may not be arbitrary, but may be a value in a set consisting of some discrete time points. For example, the start time may only be located at the start time of the first symbol (or the first sidelink symbol) of a slot, which greatly limits the flexibility of performing transmission in an unlicensed spectrum (e.g., this may make it impossible for a communication node to immediately perform a transmission after successfully detecting that a channel is available). This problem can be alleviated to some extent by introducing a cyclic prefix extension (CPE) function. For example, assuming that t=0 corresponds to the start time of a subframe and the start time of the symbol numbered as

$$l ∈ \{ 0 , 1 , … , {N}_{slot}^{subframe , μ} {N}_{s y m b}^{slot} - 1 \}$$

in the subframe is

$${t}_{start , l}^{μ} ,$$

and the symbol length (also referred to as the “symbol duration”) is

$${T}_{symb , l}^{μ} ,$$

then in e case that the CPE is used, a transmission (e.g., denoted as TRₗ_{₀}) with a start symbol of l₀ may start at

$$t = {t}_{start , {l}_{0}}^{μ} - {T}_{ext , {l}_{0}}$$

(rather than

$$t = {t}_{start , {l}_{0}}^{μ}$$

in the case that the CPE is not used), wherein the time-continuous signal at

$${t}_{start , {l}_{0}}^{μ} - {T}_{ext , {l}_{0}} \leq t < {t}_{start , {l}_{0}}^{μ}$$

may be defined as

$${s}_{ext , {l}_{0}}^{( p , u )} ( t ) = {\overline{s}}_{{l}_{0}}^{( p , μ )} ( t )$$

wherein

$${t}_{start , l}^{μ}$$

may be in units of a second.

$${T}_{symb , l}^{μ}$$

may be in units of a second.

$${T}_{symb , l}^{μ}$$

includes the length (e.g., denoted as

$${N}_{CP , l}^{μ} {T}_{c} )$$

of the cyclic prefix (CP) in the corresponding symbol and the length (e.g., denoted as

$${N}_{u}^{μ} {T}_{c} )$$

of the core OFDM symbol.

$${\overline{s}}_{{l}_{0}}^{( p , μ )} ( t )$$

may represent the time-continuous signal of the symbol l₀ at

$${t}_{start , {l}_{0}}^{μ} \leq t < {t}_{start , {l}_{0}}^{μ} + {T}_{s y m b , {l}_{0}}^{μ} .$$

p may represent a corresponding antenna port.
μ may be a corresponding subcarrier spacing configuration.
T_{ext,l}_{₀} may be referred to as a CPE length (or a CPE duration).
T_{ext,l}_{₀} may be in units of a second.

In the case that CPE is used, the “start time” of a transmission may refer to

$${t}_{start , {l}_{0}}^{μ} - {T}_{ext , {l}_{0}} ,$$

or refer to

$${t}_{start , {l}_{0}}^{μ} .$$

A carrier (e.g., denoted as c) may comprise one or more contiguous channels, for example, in ascending order of frequency, denoted as ch₀, ch₁, . . . , and

$$c {h}_{{N}_{C}^{CH} - 1} ,$$

respectively, and the corresponding set of channels may be denoted as

$$C {H}_{C} = \{ c {h}_{0} , {ch}_{1} , … , {ch}_{{N}_{C}^{C H} - 1} \} ,$$

wherein

$${N}_{C}^{C H}$$

may be an integer greater than or equal to 1. On the other hand, the carrier c may comprise one or more contiguous “RB sets”, for example, in ascending order of frequency, denoted as rs₀, rs₁, . . . ,

$${rs}_{{N}_{C}^{RS} - 1} ,$$

respectively, and the corresponding set of RB sets may be denoted as

$$R {S}_{C} = \{ r {s}_{0} , r {s}_{1} , … , {rs}_{{N}_{C}^{R S} - 1} \} ,$$

wherein each RB set may correspond to a number of contiguous RBs;

$${N}_{C}^{R S}$$

may be an integer greater than or equal to 1; for

$$i ∈ \{ 0 , 1 , … , {N}_{C}^{R S} - 1 \} ,$$

the lowest number of CRB, the highest number of CRB and the number of RBs of rsᵢ may be denoted as

$${N}_{i}^{RS , start} , {N}_{i}^{RS , end} and {N}_{i}^{RS , size} ,$$

respectively, wherein

$${N}_{i}^{R S , s i z e}$$

may be equal to

$${N}_{i}^{R S , e n d} - {N}_{i}^{R S , s t a r t} + 1 .$$

There may be a guard band (e.g., referred to as an “intra-cell guard band”) between two adjacent RB sets, wherein each intra-cell guard band may correspond to a number of contiguous RBs. For example, in the carrier c, there may be

$${N}_{C}^{G B} = {N}_{C}^{R S} - 1$$

intra-cell guard bands used to separate the

$${N}_{C}^{R S}$$

RB sets, e.g., denoted as gb₀, gb₁, . . . , and

$$g {b}_{{N}_{C}^{G B - 1}}$$

respectively, and the corresponding set of intra-cell guard bands may be denoted as

$$G {B}_{C} = \{ g {b}_{0} , {gb}_{1} , … , {gb}_{{N}_{C}^{GB} - 1} \} ,$$

wherein for

$$j ∈ \{ 0 , 1 , … , {N}_{C}^{G B} - 1 \} ,$$

gbⱼ may be used to separate the RB set rsⱼ and the RB set rsⱼ₊₁; the lowest number of CRB, the highest number of CRB and the number of RBs of gbⱼ may be denoted as

$${N}_{j}^{G B , s t a r t} , {N}_{j}^{G B , e n d} , and {N}_{j}^{G B , s i z e} ,$$

respectively, wherein

$${N}_{j}^{G B , s i z e}$$

may be equal to

$${N}_{j}^{G B , e n d} - {N}_{j}^{GB , start} + 1 .$$

For example, in a carrier having a bandwidth of 40 MHz, for a 15-kHz SCS, there may be 216 contiguous RBs (e.g., the CRB numberings thereof being respectively denoted as 0, 1, . . . , and 215), and the 216 RBs may be classified into 3 subsets, which correspond to a RB set rs₀

$$( {N}_{0}^{R S , s t a r t} = 0 , {N}_{0}^{R S , e n d} = 104 , and {N}_{0}^{R S , s i z e} = 105 ) ,$$

an intra-cell guard band

$$g {b}_{0} ( {N}_{0}^{G B , s t a r t} = 105 , {N}_{0}^{G B , e n d} = 110 , and {N}_{0}^{G B , s i z e} = 6 )$$

### and a RB set rs₁

$$( {N}_{1}^{R S , s t a r t} = 111 , {N}_{1}^{R S , e n d} = 215 , and {N}_{1}^{R S , s i z e} = 105 )$$

respectively.

For

$$j ∈ \{ 0 , 1 , … , {N}_{C}^{G B} - 1 \} ,$$

if gbⱼ is an empty set, then it may be considered that there is no corresponding intra-cell guard band. If, for j=0, 1, . . . ,

$${N}_{C}^{G B} - 1 ,$$

gbⱼ is invariably an empty set, then it may be considered that there is not any intra-cell guard band between the RB sets of the carrier c.

The

$${N}_{C}^{C H}$$

may be equal to the

$${N}_{C}^{R S} ,$$

and correspondingly, for

$$i ∈ \{ 0 , 1 , … , {N}_{C}^{RS} - 1 \} ,$$

the RB set rsᵢ may correspond to a number of contiguous RBs within the bandwidth of the channel chᵢ; the rsᵢ may be referred to as the RB set corresponding to the chᵢ; the chᵢ may be referred to as the channel corresponding to the rsᵢ; optionally, if rsᵢ is in a resource pool, then it can be considered that the chᵢ is in the resource pool; optionally, if chᵢ is in a resource pool, then it can be considered that the rsᵢ is in the resource pool; optionally, if a resource pool comprises the rsᵢ, then it can be considered that the resource pool comprises the chᵢ; and optionally, if a resource pool comprises the chᵢ, then it can be considered that the resource pool comprises the rsᵢ.

A set of RB sets corresponding to a set of channels may be defined as a set consisting of RB sets corresponding to all of the channels in the set of channels, respectively.

A set of channels corresponding to a set of RB sets may be defined as a set consisting of channels corresponding to all of the RB sets in the set of RB sets, respectively.

One or more bandwidth parts (BWPs) may be configured in the carrier c, e.g., denoted as b₀, b₁, . . . , and

$${b}_{{N}_{C}^{B} - 1}$$

respectively, wherein

$${N}_{C}^{B}$$

may be an integer greater than or equal to 1. When there is no risk of confusion (e.g., in an operation in which one bandwidth part in the carrier c is involved), it suffices to only consider the case of

$${N}_{C}^{B} = 1 ,$$

and the bandwidth part b₀ is denoted as b.

The bandwidth part b may comprise one or more contiguous channels, e.g., denoted as chᵢ_{₀}, chᵢ_{₀}₊₁, . . . , and

$${ch}_{{i}_{0} + {N}_{B}^{CH} - 1}$$

respectively, and the corresponding set of channels may be denoted as

$${CH}_{B} = \{ {ch}_{{i}_{0}} , {ch}_{{i}_{0} + 1} , … , {ch}_{{i}_{0} + {N}_{B}^{CH} - 1} \} ,$$

wherein

$${N}_{B}^{CH}$$

may satisfy

$$1 \leq {N}_{B}^{CH} \leq {N}_{C}^{CH} ,$$

and the set CH_{B} may be a subset of the set CH_{C}. On the other hand the bandwidth part b may comprise

$${N}_{B}^{RS}$$

RB sets, e.g., denoted as rsⱼ_{₀}, rsⱼ_{₀}₊₁, . . . , and

$${rs}_{{j}_{0} + {N}_{B}^{RS} - 1}$$

respectively, and the corresponding set of RB sets may be denoted as

$${RS}_{B} = \{ {rs}_{{j}_{0}} , {rs}_{{j}_{0} + 1} , … , {rs}_{{j}_{0} + {N}_{B}^{RS} - 1} \} ,$$

wherein

$${N}_{B}^{RS}$$

may satisfy

$$1 \leq {N}_{B}^{RS} \leq {N}_{C}^{RS} ,$$

and the set RS_{B} may be a subset of the set RS_{C}. The lowest numbering of CRB (e.g., denoted as

$${N}_{B}^{start} )$$

and the number of RBs (e.g., denoted as

$${N}_{B}^{size} )$$

of the bandwidth part b may be equal to

$${N}_{{j}_{0}}^{R S , s t a r t} and {N}_{{j}_{0} + {N}_{B}^{R S} - 1}^{R S ,} - {N}_{{j}_{0}}^{R S , s t a r t} + 1$$

respectively.

The

$${N}_{B}^{C H}$$

may be equal to the

$${N}_{B}^{R S} .$$

The i₀ may be equal to the j₀.

A set consisting of all of the transmission resource pools configured in the bandwidth part b may be denoted as

$${E}_{b}^{T X} ,$$

wherein the set

$${E}_{b}^{T X}$$

may be a subset of the set (e.g., denoted as

$${E}_{c}^{T X} )$$

consisting of all of the transmission resource pools configured in the carrier c.

The set

$${E}_{b}^{T X}$$

may be related to the sidelink resource allocation mode used by the UE. For example, the set

$${E}_{b}^{T X}$$

may be determined differently in each of sidelink resource allocation mode 1 and in sidelink resource allocation mode 2. The set

$${E}_{b}^{T X}$$

may be related to the operation performed by the UE. For example, the set

$${E}_{b}^{T X}$$

may be determined differently in each of sidelink communication and in sidelink discovery.

Specifically, for example, for sidelink resource allocation mode 1, the set

$${E}_{b}^{T X}$$

may comprise one or more of the following (e.g., the set

$${E}_{b}^{T X}$$

may be a union set of one or more of the following):
a set of transmission resource pools used for sidelink communication and/or sidelink discovery based on network scheduling, e.g., a resource pool (or a set of resource pools) configured by the parameter sl-TxPoolScheduling.
a set of transmission resource pools used for sidelink discovery based on network scheduling, e.g., a resource pool (or a set of resource pools) configured by the parameter sl-DiscTxPoolScheduling.

As another example, for sidelink resource allocation mode 2, the set of resource pools

$${E}_{b}^{T X}$$

may comprise one or more of the following (e.g., the set

$${E}_{b}^{T X}$$

may be a union set of one or more of the following):
a set of transmission resource pools used for sidelink communication and/or sidelink discovery based on UE autonomous resource selection, e.g., a resource pool (or a set of resource pools) configured by the parameter sl-TxPoolSelectedNormal.
a set of transmission resource pools used for sidelink discovery based on UE autonomous resource selection, e.g., a resource pool (or a set of resource pools) configured by the parameter sl-DiscTxPoolSelected.
a set of transmission resource pools used for sidelink communication and/or sidelink discovery under exception conditions, e.g., a resource pool (or a set of resource pools) configured by the parameter sl-TxPoolExceptional.

A set consisting of all of the reception resource pools configured in the bandwidth part b may be denoted as

$${E}_{b}^{R X} ,$$

wherein the set

$${E}_{b}^{RX}$$

may be a subset of the set (e.g., denoted as

$${E}_{c}^{RX} )$$

consisting of all of transmission resource pools configured in the carrier c.

The set

$${E}_{b}^{RX}$$

may be related to the sidelink resource allocation mode used by the UE. For example, the set

$${E}_{b}^{RX}$$

may be determined differently in sidelink resource allocation mode 1 and in sidelink resource allocation mode 2. The set

$${E}_{b}^{RX}$$

may be related to the operation performed by the UE. For example, the set

$${E}_{b}^{RX}$$

may be determined differently in each of sidelink communication and in sidelink discovery.

Specifically, for example, for sidelink resource allocation mode 1, the set

$${E}_{b}^{RX}$$

may comprise one or more of the following (e.g., the set

$${E}_{b}^{RX}$$

may be a union set of one or more of
the following):
a set of reception resource pools used for sidelink communication and/or sidelink discovery, e.g., a resource pool (or a set of resource pools) configured by the parameter sl-RxPool.
a set of reception resource pools used for sidelink discovery, e.g., a resource pool (or a set of resource pools) configured by the parameter sl-DiscRxPool.

As another example, for sidelink resource allocation mode 2, the set

$${E}_{b}^{RX}$$

may comprise one or more of the following (e.g., the set

$${E}_{b}^{RX}$$

may be a union set of one or more of the following):
a set of reception resource pools used for sidelink communication and/or sidelink discovery, e.g., a resource pool (or a set of resource pools) configured by the parameter sl-RxPool.
a set of reception resource pools used for sidelink discovery, e.g., a resource pool (or a set of resource pools) configured by the parameter sl-DiscRxPool.

For the unlicensed spectrum, in order to ensure fair channel sharing between different communication nodes, a certain restriction may be imposed on the power spectral density (PSD) and/or occupied channel bandwidth (OCB) of signal transmission. For example, the maximum PSD cannot exceed 10 dBm/MHz. As another example, when a channel is used, the bandwidth containing 99% of the transmission power must be greater than or equal to a certain percentage (e.g., 80%) of the nominal channel bandwidth. The restriction (if any) may be made and enforced by regulatory authorities. The restrictions (if any) on the PSD and/or the OCB may be different in different countries and/or regions.

To meet the restriction on the OCB, one radio transmission may correspond to one or more “interlaces”. For example, M_{INT} (M_{INT}≥1) interlaces may be defined, and the corresponding set of interlaces is I_{ALL}={int₀, int₁, . . . , int_{M}_{_{INT}}₋₁}, wherein for m∈{0, 1, . . . , M_{INT}−1}, the interlace intₘ may correspond to the set of CRBs {m, M_{INT}+m, 2M_{INT}+m, 3M_{INT}+m, . . . }. M_{INT} may be a pre-defined or configured value, or may be determined according to one or more pre-defined or configured values.

The value of M_{INT} may be related to the subcarrier spacing configuration μ. For example, for μ=0, M_{INT}=10; as another example, for μ=1, M_{INT}=5.

For the same subcarrier spacing configuration μ, different interlaces may be defined for different purposes (e.g., different types of sidelink transmission). For example, for the same subcarrier spacing configuration μ, one value of M_{INT} is defined for S-SS/PSBCH transmission, and another value of M_{INT} is defined for PSCCH/PSSCH transmission and/or PSFCH (Physical Sidelink Feedback Channel) transmission. As another example, for the same subcarrier spacing configuration μ, one value of M_{INT} is defined for S-SS/PSBCH transmission, and no interlace is defined for PSCCH/PSSCH transmission and/or PSFCH transmission.

The definition of the interlace may apply only to some subcarrier spacing configurations but not to other subcarrier spacing configurations.

An RB in an interlace may be referred to as an IRB. For example, in bwpₖ, the IRB numberings in the interlace intₘ may be denoted as

$${N}_{m , 0}^{IRB} = 0 , {N}_{m , 1}^{IRB} = 1 … ,$$

respectively, in ascending order of frequency. The corresponding CRB numberings may be denoted as

$${N}_{m , 0}^{CRB} , {N}_{m , 1}^{CRB} , … ,$$

respectively. The corresponding PRB numberings may be denoted as

$${N}_{m , 0}^{PRB} , {N}_{m , 1}^{PRB} , … ,$$

respectively.

The relationship between the IRB numberings

$${N}_{m , z}^{IRB} ( z = 0 , 1 , … )$$

and the corresponding CRB numberings

$${N}_{m , z}^{CRB}$$

may be denoted as

$${N}_{m , z}^{CRB} = {f}_{IRB}^{CRB} ( m , {N}_{m , z}^{IRB} ) ,$$

wherein

$${f}_{IRB}^{CRB} ( m , {N}_{m , z}^{IRB} )$$

may be defined as:

$${f}_{IRB}^{CRB} ( m , {N}_{m , z}^{IRB} ) = {M}_{INT} \cdot {N}_{m , z}^{IRB} + {N}_{BWP}^{start} + ( ( m - {N}_{BWP}^{start} ) mod {M}_{INT} )$$

The relationship between the IRB numberings

$${N}_{m , z}^{IRB} ( z = 0 , 1 , … )$$

and the corresponding PRB numberings

$${N}_{m , z}^{PRB}$$

may be denoted as

$${N}_{m , z}^{PRB} = {f}_{IRB}^{PRB} ( m , {N}_{m , z}^{IRB} ) ,$$

wherein

$${f}_{IRB}^{PRB} ( m , {N}_{m , z}^{IRB} )$$

may be defined as:

$${f}_{IRB}^{PRB} ( m , {N}_{m , z}^{IRB} ) = {M}_{INT} \cdot {N}_{m , z}^{IRB} + ( ( m - {N}_{BWP}^{start} ) mod {M}_{INT} )$$

### Embodiment 1

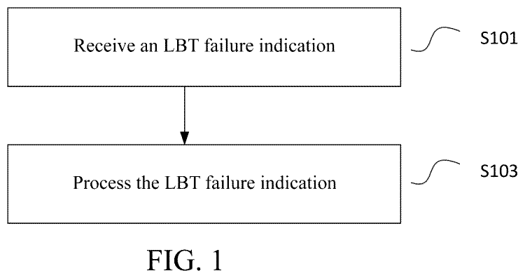

A method performed by a UE according to Embodiment 1 of the present invention will be described below with reference to FIG. 1.

FIG. 1 illustrates a flowchart corresponding to the method performed by a UE according to Embodiment 1 of the present invention.

As illustrated in FIG. 1, in Embodiment 1 of the present invention, the steps performed by the UE include: step S101 and step S103.

Specifically, in step S101, an LBT failure indication is received.

The LBT failure indication may be from (one or more) lower layer entities (e.g., a physical layer entity) of the UE. For example, the LBT failure indication may be generated according to the method described in Embodiment 2 of the present invention.

The LBT failure indication may carry one or more parameters, for example, including one or more of the following:
A set of resource pools (e.g., denoted as

$${E}_{f , i n} = \{ {e}_{0}^{f , i n} , {e}_{1}^{f , i n} , … , {e}_{{N}_{f , i n}^{E} - 1}^{f , i n} \} ,$$

wherein

$${N}_{f , i n}^{E}$$

may be an integer greater than or equal to 1). The bandwidth part where the resource pools

$${e}_{0}^{f , i n} , {e}_{1}^{f , i n} , … , and {e}_{{N}_{f , i n}^{E} - 1}^{f , i n}$$

are located may be the bandwidth part b in the carrier c. The

$${N}_{f , in}^{E}$$

may be a predefined value

$$( e . g . , {N}_{f , i n}^{E} = 1 ) ,$$

or may be determined according to the LBT failure indication, or determined by other means. The set E_{f,in} may correspond to the set

$${E}_{F}^{SL}$$

in Embodiment 2 of the present invention.
A set of channels (e.g., denoted as

$${CH}_{f , i n} = \{ {ch}_{0}^{f , i n} , {ch}_{1}^{f , i n} , … , {ch}_{{N}_{f , i n}^{CH} - 1}^{f , i n} \} ,$$

wherein

$${N}_{f , i n}^{CH}$$

may be an integer greater than or equal to 1). The bandwidth part where the channels

$${ch}_{0}^{f , in} , {ch}_{1}^{f , in} , … , and {ch}_{{N}_{f , in}^{CH} - 1}^{f , in}$$

are located may be the bandwidth part b in the carrier c. The

$${N}_{f , in}^{CH}$$

may be a predefined value (e.g.

$${N}_{f , in}^{CH} = 1 ) ,$$

or may be determined according to the LBT failure indication, or determined by other means. The set CH_{f,in} may correspond to the set

$${CH}_{F}^{SL}$$

in embodiment 2 of the present invention.
A set of RB sets (e.g., denoted as

$${RS}_{f , in} = \{ {rs}_{0}^{f , in} , {rs}_{1}^{f , in} , … , {rs}_{{N}_{f , in}^{RS} - 1}^{f , in} \} ,$$

wherein

$${N}_{f , in}^{RS}$$

may be an integer greater than or equal to 1). The bandwidth part where the RB sets

$${rs}_{0}^{f , in} , {rs}_{1}^{f , in} , … , and {rs}_{{N}_{f , in}^{RS} - 1}^{f , in}$$

are located may be the bandwidth part b in the carrier c. The

$${N}_{f , in}^{RS}$$

may be a redefined value (e.g.

$${N}_{f , in}^{RS} = 1 ) ,$$

or may be determined according to the LBT failure indication, or determined by other means. The set RS_{f,in} may correspond to the set

$${RS}_{F}^{SL}$$

in embodiment 2 of the present invention.
A set of slots (e.g., denoted as

$${T}_{f , in} = \{ {t}_{0}^{f , in} , {t}_{1}^{f , in} , … , {t}_{{N}_{f , in}^{T} - 1}^{f , in} \} ,$$

wherein

$${N}_{f , in}^{T}$$

may be an integer greater than or equal to 1). The set T_{f,in} may correspond to the slot

$${t}_{0}^{SL}$$

(correspondingly,

$${N}_{f , in}^{T} = 1 )$$

or the set of slots T_{SL} in Embodiment 2 of the present invention.

The LBT failure indication may be triggered for the resource pools in the set E_{f,in}.

The LBT failure indication may be triggered for the channels in the set CH_{f,in}.

The LBT failure indication may be triggered for the RB sets in the set RS_{f,in}.

The LBT failure indication may be triggered for slots in the set T_{f,in}.

The set E_{f,in} may be a subset of the set of resource pools E_{A}, wherein the set E_{A} may be defined as one of the following (or a subset thereof), or a union set of a plurality of the following (or a subset of the union set):
The set

$${E}_{b}^{TX} .$$

The set

$${E}_{c}^{TX} .$$

The set

$${E}_{b}^{RX} .$$

The set

$${E}_{c}^{RX} .$$

Further, in step S103, the LBT failure indication is processed.

For example, for each resource pool in the set of resource pools E_{f,op} (e.g., denoted as

$${E}_{f , op} = \{ {e}_{0}^{f , op} , {e}_{1}^{f , op} , … , {e}_{{N}_{f , op}^{E} - 1}^{f , op} \} ,$$

wherein

$${N}_{f , op}^{E}$$

may be an integer of greater than or equal to 1), the LBT failure indication is processed separately. Specifically, for example, if E_{f,op}=

$$\{ {e}_{{0}^{r}}^{f , op} , {e}_{1}^{f , op} \} ,$$

then the LBT failure indication is performed on the resource pool

$${e}_{0}^{f , op}$$

and the resource pool

$${e}_{1}^{f , op}$$

separately.

The set E_{f,op} may be the set E_{f,in}.

The set E_{f,op} may be a set of resource pools determined according to the set E_{f,in} (e.g., the set E_{f,op} may be a subset of the set E_{f,in}). Specifically, for example, if a resource pool

$${e}_{i}^{f , in} ( i ∈ \{ 0 , 1 , … , {N}_{f , in}^{E} - 1 \} )$$

in the set E_{f,in} is a transmission resource pool, then the resource pool

$${e}_{i}^{f , in}$$

belongs to the set E_{f,op}; as another example, if a resource pool

$${e}_{i}^{f , in} ( i ∈ \{ 0 , 1 , … , {N}_{f , in}^{E} - 1 \} )$$

in the set E_{f,in} is a reception resource pool then the resource pool

$${e}_{i}^{f , in}$$

does not belong to the set E_{f,op}; as another example, if a resource pool

$${e}_{i}^{f , in} ( i ϵ \{ 0 , 1 , … , {N}_{f , i n}^{E} - 1 \} )$$

in the set E_{f,in} is a reception resource pool, then the resource pool

$${e}_{i}^{f , in}$$

belongs to the set E_{f,op}; as another example, if a resource pool

$${e}_{i}^{f , in} ( i ∈ \{ 0 , 1 , … , {N}_{f , in}^{E} - 1 \} )$$

in the set E_{f,in} is a reception resource pool, then the transmission resource pool corresponding to the resource pool

$${e}_{i}^{f , in}$$

(e.g., a transmission resource pool configured with the same time and frequency resources as the reception resource pool

$${e}_{i}^{f , i n} )$$

belongs to the set E_{f,op}; as another example, if the resource pool

$${e}_{j}^{f , o p}$$

is a transmission resource pool used for sidelink communication and/or sidelink discovery under exception conditions (e.g., the resource pool is configured by the parameter sl-TxPoolExceptional), then the resource pool

$${e}_{i}^{f , in}$$

does not belong to the set E_{f,op}; and as another example, if the resource pool

$${e}_{j}^{f , o p}$$

is a transmission resource pool used for sidelink communication and/or sidelink discovery under exception conditions (e.g., the resource pool is configured by the parameter sl-TxPoolExceptional), then the resource pool

$${e}_{i}^{f , in}$$

belongs to the set E_{f,op}. An example of triggering an LBT failure for a reception resource pool may be: receiving PSCCH/PSSCH in the reception resource pool, and performing channel access in order to transmit the corresponding HARQ feedback-carrying PSFCH on a PSFCH resource which is in the reception resource pool and corresponds to the PSCCH/PSSCH, and if the channel access fails, indicating, by the physical layer entity, an LBT failure for the reception resource pool (or indicating, by the physical layer entity, an LBT failure for a transmission resource pool corresponding to the reception resource pool).

The set E_{f,op} may be a set of resource pools determined according to the set CH_{f,in}. For example, if the resource pool e comprises one or more channels in the set CH_{f,in}, then the resource pool e belongs to the set E_{f,op}; as another example, if the channels corresponding to one or more RB sets comprised in the resource pool e, respectively, are in the set CH_{f,in}, then the resource pool e belongs to the set E_{f,op}.

The set E_{f,op} may be a set of resource pools determined according to the set RS_{f,in}. For example, if the resource pool e comprises one or more RB sets in the set RS_{f,in}, then the resource pool e belongs to the set E_{f,op}.

The set E_{f,op} may be a set of resource pools determined according to the set T_{f,in}. For example, for

$${N}_{f , in}^{T} = 1 ,$$

the set E_{f,op} may be a set consisting of the resource pools where the (one or more) intended sidelink transmissions in the slot

$${t}_{0}^{f , in}$$

are located, respectively.

The set E_{f,op} may be a subset of the set E_{A}.

Step S103 may comprise sub-step

$${S}_{0}^{103} ,$$

sub-step

$${S}_{1}^{103} ,$$

sub-step

$${S}_{2}^{103} ,$$

and sub-step

$${S}_{3}^{103}$$

(the corresponding order of execution may be the order of their occurrences, or any other order).

Optionally, if the set E_{f,op} is an empt set, then the sub-step

$${S}_{0}^{103} ,$$

the sub-step

$${S}_{1}^{103} ,$$

the sub-step

$${S}_{2}^{103} ,$$

and the sub-step

$${S}_{3}^{103}$$

are not performed.

For a resource pool

$${e}_{j}^{f , o p} ( j ∈ \{ 0 , 1 , … , {N}_{f , op}^{E} - 1 \} )$$

the sub-step

$${S}_{0}^{103}$$

may comprise one or more type 1 LBT failure operations.

Optionally, for the resource pool

$${e}_{j}^{f , op} ,$$

when the type 1 LBT failure conditions are met, then the “one or more type 1 LBT failure operations” are not performed, wherein the type 1 LBT failure conditions may comprise one or more (e.g., any of the combinations made by way of “and” or “or”) of the following:
The resource pool

$${e}_{j}^{f , op}$$

is not a transmission resource pool.
The resource pool

$${e}_{j}^{f , op}$$

is a reception resource pool.
The resource pool

$${e}_{j}^{f , op}$$

is a transmission resource pool used for sidelink communication and/or sidelink discovery under exception conditions. For example, the resource pool is configured by the parameter sl-TxPoolExceptional.
The resource pool

$${e}_{j}^{f , op}$$

has been associated with a “consistent LBT failure”; that is, a consistent LBT failure has been triggered for the resource pool

$${e}_{j}^{f , op} ,$$

and the consistent LBT failure has not been canceled.

Optionally, for the resource pool

$${e}_{j}^{f , op} ,$$

when the type 2 LBT failure conditions are met, then the “one or more type 1 LBT failure operations” are performed, wherein the type 2 LBT failure conditions may include one or more (e.g., any of the combinations made by way of “and” or “or”) of the following:
The resource pool

$${e}_{j}^{f , op}$$

is a transmission resource pool.
The resource pool

$${e}_{j}^{f , op}$$

is not a reception resource pool.
The resource pool

$${e}_{j}^{f , op}$$

is not a transmission resource pool used for sidelink communication and/or sidelink discovery under exception conditions. For example, the resource pool

$${e}_{j}^{f , op}$$

is not a resource pool configured by the parameter sl-TxPoolExceptional.
The resource pool

$${e}_{j}^{f , o p}$$

is not associated with any consistent LBT failure (for example, a consistent LBT failure has never been triggered for the resource pool

$${e}_{j}^{f , o p} ;$$

as another example, the consistent LBT failure triggered for the resource pool

$${e}_{j}^{f , o p}$$

a most recent time has been canceled).

For the resource pool

$${e}_{j}^{f , o p} ,$$

the “one or more type 1 LBT failure operations” may include one or more of the following (the corresponding order of performance may be the order of their occurrences, or any other order):
Initiate (or re-initiate) an LBT failure detection timer (e.g., denoted as

$${timer}_{FD , {e}_{j}^{f , o p}}^{L B T} ) .$$

Increase an LBT failure indication counter (e.g., denoted as

$${counter}_{IND , {e}_{j}^{f , o p}}^{L B T} ) by {N}_{C , F}^{L B T} ,$$

wherein

$${N}_{C , F}^{L B T}$$

may be a pre-defined or configured value, or may be determined according to one or more pre-defined or configured values. For example,

$${N}_{C , F}^{L B T} = 1 .$$

If the type 1 consistent LBT failure conditions are met, then perform one or more type 1 consistent LBT failure operations.

For the resource pool

$${e}_{j}^{f , o p} ,$$

the type 1 consistent LBT failure conditions may include one or more (e.g., any of the combinations made by way of “and” or “or”) of the following:

$${counter}_{IND , {e}_{j}^{f , o p}}^{L B T} \geq {N}_{IND , MAX}^{L B T} ,$$

wherein

$${N}_{IND , MAX}^{L B T}$$

may be a pre-defined or configured value, or may be determined according to one or more pre-defined or configured values.

$${counter}_{IND , {e}_{j}^{f , o p}}^{L B T} > {N}_{IND , MAX}^{L B T} .$$

$${counter}_{IND , {e}_{j}^{f , o p}}^{L B T} > {N}_{IND , MAX}^{L B T} + 1.$$

$${counter}_{IND , {e}_{j}^{f , o p}}^{L B T} \geq {N}_{IND , MAX}^{L B T} + 1 .$$

For the resource pool

$${e}_{j}^{f , o p} ,$$

the “one or more type 1 consistent LBT failure operations” may include one or more of the following (the corresponding order of performance may be the order of their occurrences, or any other order):
Trigger a consistent LBT failure, e.g., denoted as

$${clf}_{{e}_{j}^{f , op}} .$$

Wherein,
   the consistent LBT failure

$${clf}_{{e}_{j}^{f , op}}$$

may be referred to as a” triggered and uncanceled consistent LBT failure” (or a “triggered consistent LBT failure”).
   The consistent LBT failure

$${clf}_{{e}_{j}^{f , op}}$$

may be considered as a consistent LBT failure triggered for the resource pool

$${e}_{j}^{f , o p} .$$

The consistent LBT failure

$${clf}_{{e}_{j}^{f , op}}$$

may be considered as a consistent LBT failure associated with the resource pool

$${e}_{j}^{f , o p} .$$

The number of resource pools associated with the consistent LBT failure in the set of resource pools E_{A} may be referred to as the number of consistent LBT failure associated in the set of resource pools E_{A}.
The number of resource pools associated with the consistent LBT failure in the bandwidth part b may be referred to as the number of consistent LBT failure associated in the bandwidth part b.
The number of resource pools associated with the consistent LBT failure in the carrier c may be referred to as the number of consistent LBT failure associated in the carrier c.
The consistent LBT failure

$${clf}_{{e}_{j}^{f , op}}$$

may be canceled. Optionally, after the consistent LBT failure

$${clf}_{{e}_{j}^{f , op}}$$

is canceled, the resource pool

$${e}_{j}^{f , o p}$$

is no longer associated with any consistent LBT failure (optionally, correspondingly, the number of the consistent LBT failure associated in the resource pool E_{A} and/or the bandwidth part b and/or the carrier c decreases by one) until another consistent LBT failure is triggered for the resource pool

$${e}_{j}^{f , o p} .$$

Perform one or more “type 1A consistent LBT failure operations”.
If the type 1A consistent LBT failure conditions are met, then perform the one or more “type 1A consistent LBT failure operations”.
Perform one or more “type 1B consistent LBT failure operations”.
If the type 1B consistent LBT failure conditions are met, then perform the one or more “type 1B consistent LBT failure operations”.

For the resource pool

$${e}_{j}^{f , o p} ,$$

the type 1A consistent LBT failure conditions may include one or more (e.g., any of the combinations made by way of “and” or “or”) of the following:
The UE is using sidelink resource allocation mode 1.
The resource pool

$${e}_{j}^{f , o p}$$

is not a transmission resource pool used for sidelink communication and/or sidelink discovery under exception conditions. For example, the resource pool

$${e}_{j}^{f , o p}$$

is not a resource pool configured by the parameter sl-TxPoolExceptional.

For the resource pool

$${e}_{j}^{f , o p} ,$$

the one or more type 1A consistent LBT failure operations may include one or more of the following (performed according to the order of their occurrences, or according to any other order):
Report the consistent LBT failure

$${clf}_{{e}_{j}^{f , op}}$$

to the base station.
Deactivate (or, release; or, suspend) all of the type 1 sidelink configured grants in the resource pool

$${e}_{j}^{f , o p} .$$

Deactivate (or, release; or, suspend) all of the type 2 sidelink configured grants in the resource pool

$${e}_{j}^{f , o p} .$$

Deactivate (or, release; or, suspend) all of the type 2 sidelink configured grants that have been activated in the resource pool

$${e}_{j}^{f , o p} .$$

For the resource pool

$${e}_{j}^{f , o p} ,$$

the conditions for type 1B consistent LBT failure may include one or more (e.g., any of the combinations made by way of “and” or “or”) of the following:
The UE is using sidelink resource allocation mode 2.
The resource pool

$${e}_{j}^{f , o p}$$

is not a transmission resource pool used for sidelink communication and/or sidelink discovery under exception conditions. For example, the resource pool

$${e}_{j}^{f , o p}$$

is not a resource pool configured by the parameter sl-TxPoolExceptional.

For the resource pool

$${e}_{j}^{f , o p} ,$$

the one or more type 1B consistent LBT failure operations may include one or more of the following (performed according to the order of their occurrences, or according to any other order):
Perform resource pool selection (or re-selection) for all of the sidelink grants associated with the resource pool

$${e}_{j}^{f , o p} ,$$

respectively.
Clear all of the sidelink grants in the resource pool

$${e}_{j}^{f , o p} .$$

Initiate (or re-initiate) a type 1 consistent LBT failure recovery timer (e.g., denoted as

$${timer}_{FR , {e}_{j}^{f , op} , 1}^{L B T} ) .$$

The sub-step

$${S}_{1}^{103}$$

may comprise: If type 1 complete LBT failure conditions are met, then perform one or more type 1 complete LBT failure operations.

The type 1 complete LBT failure conditions may include one or more (e.g., any of the combinations made by way of “and” or “or”) of the following:
All of the resource pools in the set of resource pools E_{A} are separately associated with a consistent LBT failure that has been triggered and has not been canceled. For example, there are two transmission resource pools (e.g., denoted as

$${e}_{0}^{A} and {e}_{1}^{A}$$

respectively) in the set of resource pools E_{A}; at time t₀, a consistent LBT failure is triggered for the resource pool

$${e}_{0}^{A} ;$$

at time t₁>t₀, a consistent LBT failure is triggered for the resource pool

$${e}_{1}^{A} ;$$

at time t≥t₁, if the consistent LBT failure triggered for the resource pool

$${e}_{0}^{A}$$

is not canceled, and the consistent LBT failure triggered for the resource pool

$${e}_{1}^{A}$$

is not canceled, then it can be considered that all of the resource pools in the set of resource pools E_{A} are separately associated with a consistent LBT failure that has been triggered and has not been canceled.
All of the transmission resource pools in the set of resource pools E_{A} are separately associated with a consistent LBT failure that has been triggered and has not been canceled.
All of the transmission resource pools in the bandwidth part b are separately associated with a consistent LBT failure that has been triggered and has not been canceled.
All of the resource pools in the bandwidth part b are separately associated with a consistent LBT failure that has been triggered and has not been canceled.
All of the transmission resource pools in the carrier c are separately associated with a consistent LBT failure that has been triggered and has not been canceled.
All of the resource pools in the carrier c are separately associated with a consistent LBT failure that has been triggered and has not been canceled.
The UE is using sidelink resource allocation mode 1, and all of the transmission resource pools in the bandwidth part b that are used for the sidelink resource allocation mode 1 are separately associated with a consistent LBT failure that has been triggered and has not been canceled.
The UE is using sidelink resource allocation mode 1, and all of the resource pools in the bandwidth part b that are used for the sidelink resource allocation mode 1 are separately associated with a consistent LBT failure that has been triggered and has not been canceled.
The UE is using sidelink resource allocation mode 2, and all of the transmission resource pools in the bandwidth part b that are used for the sidelink resource allocation mode 2 are separately associated with a consistent LBT failure that has been triggered and has not been canceled.
The UE is using sidelink resource allocation mode 2, and all of the resource pools in the bandwidth part b that are used for the sidelink resource allocation mode 2 are separately associated with a consistent LBT failure that has been triggered and has not been canceled.
The UE is using sidelink resource allocation mode 1, and all of the transmission resource pools in the carrier c that are used for the sidelink resource allocation mode 1 are separately associated with a consistent LBT failure that has been triggered and has not been canceled.
The UE is using sidelink resource allocation mode 1, and all of the resource pools in the carrier c that are used for the sidelink resource allocation mode 1 are separately associated with a consistent LBT failure that has been triggered and has not been canceled.
The UE is using sidelink resource allocation mode 2, and all of the transmission resource pools in the carrier c that are used for the sidelink resource allocation mode 2 are separately associated with a consistent LBT failure that has been triggered and has not been canceled.
The UE is using sidelink resource allocation mode 2, and all of the resource pools in the carrier c that are used for the sidelink resource allocation mode 2 are separately associated with a consistent LBT failure that has been triggered and has not been canceled.

The type 1 complete LBT failure operations may include one or more of the following (performed according to the order of their occurrences, or according to any other order):
Trigger a complete LBT failure for the set of resource pools E_{A}.
Trigger a complete LBT failure for the bandwidth part b.
Deactivate (or disable) the bandwidth part b.
Disable the sidelink communication and/or sidelink discovery in the bandwidth part b.
Disable the sidelink transmission and/or sidelink reception in the bandwidth part b.
Trigger a complete LBT failure for the carrier c.
Deactivate (or disable) the carrier c.
Disable the sidelink communication and/or sidelink discovery in the carrier c.
Disable the sidelink transmission and/or sidelink reception in the carrier c.
Report the complete LBT failure to a higher layer entity (e.g., an RRC layer entity).
Report the complete LBT failure to a base station.
Initiate (or re-initiate) a type 1 complete LBT failure recovery timer (e.g., denoted as

$${timer}_{FR , cmp , o p , 1}^{LBT} ) .$$

Cancel the

$${N}_{FR , cnc , 1}^{L B T}$$

earliest triggered consistent LBT failures in the set of resource pools E_{A}, wherein

$${N}_{FR , cnc , 1}^{L B T}$$

may be a pre-defined or configured value (e.g.,

$${N}_{FR , cnc , 1}^{L B T} = 1 ) .$$

Cancel the

$${N}_{FR , cnc , 2}^{L B T}$$

earliest triggered consistent LBT failures in the bandwidth part b, wherein

$${N}_{FR , cnc , 2}^{L B T}$$

may be a pre-defined or configured value (e.g.,

$${N}_{FR , cnc , 2}^{L B T} = 1 ) .$$

Cancel the

$${N}_{FR , cnc , 3}^{L B T}$$

earliest triggered consistent LBT failures in the carrier c, wherein

$${N}_{FR , cnc , 3}^{L B T}$$

may be a pre-defined or configured value (e.g.,

$${N}_{FR , cnc , 3}^{L B T} = 1 ) .$$

Cancel all of the consistent LBT failures in the set of resource pools E_{A}.
Cancel all of the consistent LBT failures in the bandwidth part b.
Cancel all of the consistent LBT failures in the carrier c.

The sub-step

$${S}_{2}^{103}$$

may comprise: If the type 1 LBT failure conditions are met, then perform one or more type 1 LBT failure reset operations.

For the resource pool

$${e}_{j}^{f , o p} ,$$

the type 1 LBT failure condition reset may include one or more (e.g., any of the combinations made by way of “and” or “or”) of the following:
The consistent LBT failure

$${clf}_{{e}_{j}^{f , op}}$$

is canceled.
The LBT failure detection timer

$${timer}_{FD , {e}_{j}^{f , op}}^{L B T}$$

times out.

For the resource pool

$${e}_{j}^{f , o p} ,$$

the one or more type 1 LBT failure reset operations may comprise: Set the LBT failure indication counter

$${counter}_{IND , {e}_{j}^{f , o p}}^{LBT} to 0.$$

The sub-step

$${S}_{3}^{103}$$

may comprise: For the resource pool

$${e}_{j}^{f , o p} ,$$

if the consistent LBT failure

$${clf}_{{e}_{j}^{f , o p}}$$

is canceled, then stop the type 1 consistent LBT failure recovery timer

$${timer}_{FR , {e}_{j}^{f , o p} , 1}^{LBT} .$$

The sub-step

$${S}_{3}^{103}$$

may comprise: If type 1 consistent LBT failure recovery conditions are met, then perform one or more type 1 consistent LBT failure recovery operations.

For the resource pool

$${e}_{j}^{f , o p} ,$$

the type 1 consistent LBT failure recovery conditions may comprise: The type 1 consistent LBT failure recovery timer

$${timer}_{FR , {e}_{j}^{f , o p} , 1}^{LBT}$$

times out.

For the resource pool

$${e}_{j}^{f , o p} ,$$

the one or more type 1 consistent LBT failure recovery operations may include one or more of the following (performed according to the order of their occurrences, or according to any other order):
Cancel the consistent LBT failure

$${clf}_{{e}_{j}^{f , o p}} .$$

Set the LBT failure indication counter

$${counter}_{IND , {e}_{j}^{f , o p}}^{LBT} to {N}_{R , C}^{LBT} ,$$

wherein

$${N}_{R , C}^{LBT}$$

may be a pre-defined or configured value, or may be determined according to one or more pre-defined or configured values. For example,

$${N}_{R , C}^{LBT} = 0.$$

The sub-step

$${S}_{3}^{103}$$

may comprise: If type 1 complete LBT failure recovery conditions are met, then perform one or more type 1 complete LBT failure recovery operations.

The type 1 complete LBT failure recovery conditions may comprise: The type 1 complete LBT failure recovery timer

$${timer}_{FR , cmp , op , 1}^{LBT}$$

times out.

The type 1 complete LBT failure recovery operations may include one or more of the following (performed according to the order of their occurrences, or according to any other order):
Cancel a complete LBT failure triggered for the set of resource pools E_{A}.
Cancel a complete LBT failure triggered for the bandwidth part b.
Activate (or re-activation) of the bandwidth part b.
Activate (or re-activation) of the carrier c.
Cancel the

$${N}_{FR , cnc , 1}^{LBT}$$

earliest triggered consistent LBT failures in the set of resource pools E_{A}.
Cancel the

$${N}_{FR , cnc , 2}^{LBT}$$

earliest triggered consistent LBT failures in the bandwidth part b.
Cancel the

$${N}_{FR , cnc , 3}^{LBT}$$

earliest triggered consistent LBT failures in the carrier c.
Cancel all of the consistent LBT failures in the set of resource pools E_{A}.
Cancel all of the consistent LBT failures in the bandwidth part b.
Cancel all of the consistent LBT failures in the carrier c.

Embodiment 1 of the present invention may be performed by the MAC layer entity of the UE.

One or more parameters in Embodiment 1 of the present invention may be parameter(s) specific to a certain resource pool. For example, the timer

$${timer}_{FD , {e}_{j}^{f , op}}^{LBT}$$

is a timer specific to the resource pool

$${e}_{j}^{f , op} ;$$

as another example, the LBT failure indication counter

$${counter}_{IND , {e}_{j}^{f , op}}^{LBT}$$

is a counter specific to the resource pool

$${e}_{j}^{f , op} .$$

One or more parameters in Embodiment 1 of the present invention may be parameter(s) specific to the bandwidth part b. For example, the type 1 complete LBT failure recovery timer

$$t i m e {r}_{FR , cmp , o p , 1}^{L B T}$$

is a timer specific to the bandwidth part b.

One or more parameters in Embodiment 1 of the present invention may be parameter(s) specific to the carrier c. For example, the type 1 complete LBT failure recovery timer

$$t i m e {r}_{FR , cmp , o p , 1}^{L B T}$$

is a timer specific to the carrier c.

Embodiment 1 of the present invention may correspond to part or all of a “consistent LBT failure recovery procedure” (also referred to as an “LBT failure detection and recovery procedure”, and also referred to as a “consistent LBT failure detection and recovery procedure”) used for a sidelink. The conditions for performing the consistent LBT failure recovery procedure may include:
The carrier c (or the bandwidth part b) is configured on a shared spectrum.
The carrier c (or the bandwidth part b) is configured with an intra-cell guard band.
The bandwidth part b is configured (or enabled) with the consistent LBT failure recovery procedure. For example, the bandwidth part b is configured with one or more parameters

$$( e . g . , the {N}_{IND , MAX}^{LBT} )$$

of the consistent LBT failure recovery procedure.

In Embodiment 1 of the present invention, for the resource pool

$${e}_{j}^{f , o p} ,$$

the initial value of the LBT failure indication counter

$${counter}_{IND , {e}_{j}^{f , op}}^{LBT}$$

may be 0.

Embodiment 1 of the present invention may be applicable to an operation with shared spectrum channel access.

Therefore, according to what has been described for Embodiment 1, the present invention provides a method whereby a corresponding recovery timer is set when a consistent LBT failure is triggered for a resource pool, and the consistent LBT failure is canceled after the recovery timer times out, such that a UE can recover from the consistent LBT failure without being connected to a base station.

### Embodiment 2

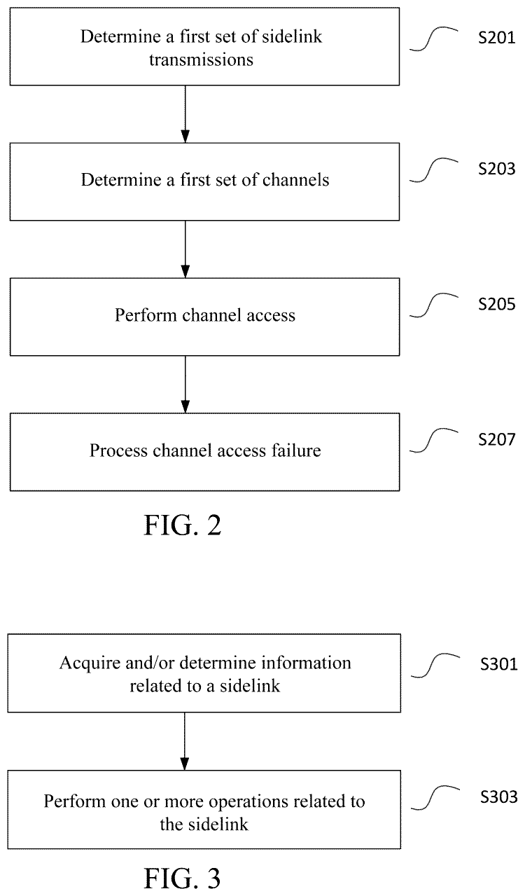

A method performed by a UE according to Embodiment 2 of the present invention will be described below with reference to FIG. 2.

FIG. 2 illustrates a flowchart corresponding to the method performed by a UE according to Embodiment 2 of the present invention.

As illustrated in FIG. 2, in Embodiment 2 of the present invention, the steps performed by the UE include: some or all of step S201, step S203, step S205 and step S207.

Specifically, in step S201, a first set of sidelink transmissions (e.g., denoted as

$${TR}_{a c c}^{S L} ;$$

correspondingly, the number of sidelink transmissions in the set

$${TR}_{a c c}^{S L}$$

may be denoted as

$${N}_{acc}^{TR , SL} ,$$

wherein

$${N}_{acc}^{TR , SL}$$

may be an integer greater than or equal to 1) is determined.

The set

$${TR}_{a c c}^{S L}$$

may be a subset of a set of sidelink transmissions

$$T {R}_{CO}^{S L} ,$$

wherein each sidelink transmission in the set

$$T {R}_{CO}^{S L}$$

may be an “intended sidelink transmission” that is scheduled, configured, or otherwise triggered before the step S201 is performed.

The set

$$T {R}_{CO}^{S L}$$

may be a set consisting of all of the intended sidelink transmissions having slot

$${t}_{0}^{S L}$$

as a starting slot, wherein each sidelink transmission in the set

$$T {R}_{CO}^{S L}$$

may be a “single-slot” sideliW transmission that occupies one or more symbols in the slot

$${t}_{0}^{S L} ,$$

or may be a “multi-slot” sidelink transmission that occupies one or more symbols in the slot

$${t}_{0}^{S L}$$

and one or more subsequent slots. For example, the set

$$T {R}_{CO}^{S L}$$

may comprise one or more of the following:
A PSCCH (e.g., denoted as

$$PSCC {H}_{0}^{T R} )$$

in the slot

$${t}_{0}^{S L}$$

(or having the slot

$${t}_{0}^{S L}$$

as the starting slot).
A PSSCH (e.g., denoted as

$${PSSCH}_{0}^{T R} )$$

in the slot

$${t}_{0}^{S L}$$

(or having the slot

$${t}_{0}^{S L}$$

as the starting slot), wherein the

$${PSSCH}_{0}^{T R}$$

may be the PSSCH associated with the

$${PSCCH}_{0}^{TR} .$$

A PSCCH/PSSCH (e.g., denoted as

$${PSCCH}_{0}^{TR} {\_PSSCH}_{0}^{TR} )$$

(corresponding to the

$${PSCCH}_{0}^{TR}$$

and the

$$PS {SCH}_{0}^{TR} .$$

$${N}_{0}^{TR , PSFCH}$$

PSFCHs (e.g., denoted as

$${PSFCH}_{0 , 0}^{TR} , {PSFCH}_{0 , 1}^{TR} , … , and {PSFCH}_{0 , {N}_{0}^{TR , PSFCH} - 1}^{TR} ,$$

respectively) in the slot

$${t}_{0}^{SL}$$

(or having the slot

$${t}_{0}^{SL}$$

as the starting slot), wherein

$${N}_{0}^{TR , PSFCH}$$

may be an integer greater than or equal to 1. The set consisting of the

$${N}_{0}^{TR , PSFCH}$$

PSFCHs may be denoted as

$${TR}_{CO , FC , 0}^{SL} = \{ {PSFCH}_{0 , 0}^{TR} , {PSFCH}_{0 , 1}^{TR} , … , {PSFCH}_{0 , {N}_{0}^{TR , PSFCH} - 1}^{TR} \} .$$

An S-SSB (e.g., denoted as

$${S\_SSB}_{0}^{TR} )$$

in the slot

$${t}_{0}^{SL}$$

(or having the slot

$${t}_{0}^{SL}$$

as the starting slot), wherein the S-SSB refers to an S-SS/PSBCH block (Sidelink Synchronization Signal/Physical Sidelink Broadcast Channel Block).

The slot

$${t}_{0}^{SL}$$

may be a future slot. For example,

$${t}_{0}^{SL} \geq {t}_{S 201} + {D}_{min}^{t , SL} , or {t}_{0}^{SL} > {t}_{S 201} + {D}_{min}^{t , SL} ,$$

wherein t_{S201} may be the slot at which the step S201 begins to be performed, and

$${D}_{min}^{t , SL}$$

may be a slot offset.

$${D}_{min}^{t , SL}$$

may be determined by one or more pre-defined or configured parameters, or may be determined by the UE autonomously. As another example,

$${t}_{0}^{SL} \leq {t}_{S 201} + {D}_{max}^{t , SL} , or {t}_{0}^{SL} < {t}_{S 201} + {D}_{max}^{t , SL} ,$$

wherein

$${D}_{max}^{t , SL}$$

may be a slot offset.

$${D}_{max}^{t , SL}$$

may be determined by one or more pre-defined or configured parameters, or may be determined autonomously.

The set

$${TR}_{CO}^{SL}$$

may be a set consisting of all of the intended sidelink transmissions having any slot in the set of slots

$${T}_{SL} = \{ {t}_{0}^{SL} , {t}_{1}^{SL} , … , {t}_{{N}_{SL}^{T} - 1}^{SL} \}$$

as a starting slot, wherein each sidelink transmission in the set

$${TR}_{CO}^{SL}$$

may be a “single-slot” sidelink transmission that occupies one or more symbols in the slot

$${t}_{i}^{S L} ( i ∈ \{ 0 , 1 , … , {N}_{S L}^{T} - 1 \} ) ,$$

or may be a “multi-slot” sidelink transmission that occupies one or more symbols in the slot

$${t}_{i}^{S L}$$

and one or more subsequent slots;

$${N}_{S L}^{T}$$

may be an integer greater than or equal to 1.

$$Δ ( {t}_{0}^{SL} , {t}_{{N}_{SL}^{T} - 1}^{SL} )$$

may satisfy

$$Δ ( {t}_{0}^{SL} , {t}_{{N}_{SL}^{T} - 1}^{SL} ) \leq {T}_{MCOT , 0}^{SL} , or Δ ( {t}_{0}^{SL} , {t}_{{N}_{SL}^{T} - 1}^{SL} ) < {T}_{MCOT , 0}^{SL} ,$$

wherein

$${T}_{MCOT , 0}^{SL}$$

### may be an MCOT, and

$${T}_{MCOT , 0}^{SL}$$

may be determined by one or more pre-defined or configured parameters, or may be determined by the UE autonomously. Specifically, for example, for any

$$i ∈ \{ 0 , 1 , … , {N}_{S L}^{T} - 1 \} ,$$

the set

$$T {R}_{CO}^{S L}$$

may comprise one or more of the following:
A PSCCH (e.g., denoted as

$$P S C C {H}_{i}^{T R} )$$

in the slot

$${t}_{i}^{S L}$$

(or having the slot

$${t}_{i}^{S L}$$

as a starting slot).
A PSSCH (e.g., denoted as

$$P S S C {H}_{i}^{T R} )$$

in the slot

$${t}_{i}^{S L}$$

(or having the slot

$${t}_{i}^{S L}$$

as a starting slot), wherein the

$$P S S C {H}_{i}^{T R}$$

may be the PSSCH associated with the

$$P S C C {H}_{i}^{T R} .$$

A PSCCH/PSSCH (e.g., denoted as

$$P S C C {H}_{i}^{T R} \_PSSC {H}_{i}^{T R} )$$

corresponding to the

$$P S C C {H}_{i}^{T R}$$

and the

$$PSSC {H}_{i}^{T R} .$$

$${N}_{i}^{TR , PSFCH}$$

PSFCHs (e.g., denoted as

$$PSFC {H}_{i , 0}^{T R} , PSFC {H}_{i , 1}^{T R} , … , and {PSFCH}_{i , {N}_{i}^{Tr , PSFCH} - 1}^{T R} ,$$

respectively) in the slot

$${t}_{i}^{S L}$$

(or having the slot

$${t}_{i}^{S L}$$

as a starting slot), wherein

$${N}_{i}^{TR , PSFCH}$$

may be an integer greater than or equal to 1. The set consisting of the

$${N}_{i}^{TR , PSFCH}$$

may be denoted as

$${TR}_{CO , FC , i}^{S L} = \{ PSFC {H}_{i , 0}^{T R} , PSFC {H}_{i , 1}^{T R} , … , {PSFCH}_{i , {N}_{i}^{TR , PSFCH} - 1}^{T R} \} .$$

An S-SSB (e.g., denoted as

$${S\_SSB}_{i}^{T R} )$$

in the slot

$${t}_{i}^{S L}$$

(or having the slot

$${t}_{i}^{S L}$$

as a starting slot).

Zero, one, or more (e.g. all) sidelink transmissions in the set

$$T {R}_{a c c}^{S L}$$

may use CPE, and accordingly, the actual start time of these sidelink transmissions (if any) may be earlier than the start time of the respective first symbols thereof. Optionally, if

$$T {R}_{a c c}^{S L} = \{ PSCC {H}_{0}^{T R} {\_PSSCH}_{0}^{T R} , {PSFCH}_{0 , 0}^{T R} , {PSFCH}_{0 , 1}^{T R} , … , {PSFCH}_{0 , {N}_{0}^{TR , PSFCH} - 1}^{T R} \} ,$$

and the

$$PSCC {H}_{0}^{T R} {\_PSSCH}_{0}^{T R}$$

uses CPE, then the

$$PSFC {H}_{0 , 0}^{T R} , the {PSFCH}_{0 , 1}^{T R} , … , {PSFCH}_{0 , {N}_{0}^{TR , PSFCH} - 1}^{T R}$$

and the

$${PSFCH}_{0 , {N}_{0}^{TR , PSFCH} - 1}^{T R}$$

### do not use CPE. Optionally, if

$${TR}_{a c c}^{S L} = \{ PSSC {H}_{0}^{T R} , P S F C {H}_{0 , 0}^{T R} , {PSFCH}_{0 , 1}^{T R} , … , {PSFCH}_{0 , {N}_{0}^{TR - PSFCH} - 1}^{T R} \} ,$$

$$and the {PSSCH}_{0}^{T R}$$

uses CPE, then

$$the {PSFCH}_{0 , 0}^{T R} , the {PSFCH}_{0 , 1}^{T R} , … , and the {PSFCH}_{0 , {N}_{0}^{T R , P S F C H} - 1}^{T R}$$

### do not use CPE. Optionally, the

$${PSFCH}_{0 , 0}^{T R} , the {PSFCH}_{{0}_{H} 1}^{T R} , … , and the {PSFCH}_{0 , {N}_{0}^{T R , P S F C H} - 1}^{T R}$$

always use the same CPE length (including the case where the CPE length is 0, that is, the case where CPE is not used).

In the set

$$T {R}_{a c c}^{S L} ,$$

there may be one or more (e.g., all) sidelink transmissions that have the same start time (or actual start time). For example, the

$$P S F C {H}_{0 , 0}^{T R} , the {PSFCH}_{0 , 1}^{T R} , … , and the {PSFCH}_{0 , {N}_{0}^{TR , PSFCH} - 1}^{T R}$$

may correspond to the same PSFCH occasion in the slot

$${t}_{0}^{S L} .$$

In the set

$$T {R}_{acc}^{S L} ,$$

there may be one or more (e.g., all) sidelink transmissions that have a start time (or actual start time) that is different from the start time (or actual start time) of other sidelink transmissions. For example,

$$T {R}_{a c c}^{S L} = \{ {PSCCH}_{0}^{T R} {\_PSSCH}_{0}^{T R} , {PSFCH}_{0 , 0}^{T R} , {PSFCH}_{0 , 1}^{T R} , … ,$$

$${PSFCH}_{0 , {N}_{0}^{T R , P S F C H} - 1}^{T R} \} , and the {PSCCH}_{0}^{T R} {\_PSSCH}_{0}^{T R}$$

starts from a symbol with a relatively small numbering in the slot

$${t}_{0}^{S L}$$

(e.g., symbol 1), whereas the (same) PSFCH occasion corresponding to the

$$PSFC {H}_{0 , 0}^{T R} , the {PSFCH}_{0 , 1}^{T R} , … , and the {PSFCH}_{0 , {N}_{0}^{TR , PSFCH} - 1}^{T R}$$

starts from a symbol with a relatively large numbering in the slot

$${t}_{0}^{S L}$$

(e.g., symbol 12); as another example,

$$T {R}_{a c c}^{S L} = \{ PSSC {H}_{0}^{T R} , PSFC {H}_{0 , 0}^{T R} , {PSFCH}_{0 , 1}^{T R} , … , {PSFCH}_{0 , {N}_{0}^{TR , PSFCH} - 1}^{T R} \} ,$$

and the

$${PSSCH}_{0}^{T R}$$

starts from a symbol with a relatively small numbering in the slot

$${t}_{0}^{S L}$$

(e.g., symbol 1), whereas the (same) PSFCH occasion corresponding to the

$$P S F C {H}_{0 , 0}^{T R} , the {PSFCH}_{0 , 1}^{T R} , … , and the {PSFCH}_{0 , {N}_{0}^{TR , PSFCH} - 1}^{T R} ,$$

starts from a symbol with a relatively large numbering in the slot

$${t}_{0}^{S L}$$

(e.g., symbol 12)

All of the sidelink transmissions in the set

$$T {R}_{CO}^{S L}$$

may be in the bandwidth part b, and the corresponding carrier is the carrier c.

The resources (e.g., time and frequency resources) corresponding to all of the sidelink transmissions in the set

$$T {R}_{CO}^{S L}$$

may e in the same resource pool (e.g., denoted as e_{acc}) in the bandwidth part b, and correspondingly, the slot

$${t}_{0}^{S L}$$

may be a slot in the resource pool e_{acc}. The resource pool e_{acc} may be a resource pool in the set of resource pools

$${E}_{A}^{a c c} ,$$

wherein the set

$${E}_{A}^{a c c}$$

may be a set consisting of one or more transmission resource pools and/or one or more reception resource pools. For example, the set

$${E}_{A}^{a c c}$$

may be the set of resource pools E_{A} defined in Embodiment 1 of the present invention; as another example, the set

$${E}_{A}^{a c c}$$

may be a set indicated or configured by (one or more) higher layer entities (e.g., the MAC layer entity) of the UE. A set consisting of all of the channels in the resource pool e_{acc} may be denoted as CH_{E}. A set consisting of all of the RB sets in the resource pool e_{acc} may be denoted as RS_{E}.

The resources (e.g., time and frequency resources) corresponding to zero, one, or more (e.g. all) sidelink transmissions in the set

$$T {R}_{CO}^{S L}$$

may be not in any resource pool.

The set

$$T {R}_{a c c}^{S L}$$

may by a subset of the set

$$T {R}_{CO}^{S L}$$

determine by the UE autonomously.

The set

$$T {R}_{a c c}^{S L}$$

may be determined in one or more of the following ways:

$$T {R}_{a c c}^{S L} = T {R}_{CO}^{S L} .$$

For example, if

$$T {R}_{CO}^{S L} = \{ P S C C {H}_{0}^{T R} {\_PSSCH}_{0}^{T R} \} , then$$

$${TR}_{a c c}^{S L} = \{ PSCC {H}_{0}^{T R} {\_PSSCH}_{0}^{T R} \} ;$$

for another example, if

$${TR}_{CO}^{S L} = \{ P S S C {H}_{0}^{T R} \} , then$$

$${TR}_{a c c}^{S L} = \{ PSS C {H}_{0}^{T R} \} ;$$

for another example, if

$$T {R}_{CO}^{S L} = \{ PSFC {H}_{0 , 0}^{T R} , {PSFCH}_{0 , 1}^{T R} , … , {PSFCH}_{0 , {N}_{0}^{TR , PSFCH} - 1}^{T R} \} ,$$

$$then {TR}_{a c c}^{S L} = \{ PSFC {H}_{0 , 0}^{T R} , {PSFCH}_{0 , 1}^{T R} , … , {PSFCH}_{0 , {N}_{0}^{TR , PSFCH} - 1}^{T R} \} ;$$

for another example, if

$${TR}_{OC}^{S L} = \{ {PSCCH}_{0}^{T R} {\_PSSCH}_{0}^{T R} , PSFC {H}_{0 , 0}^{T R} , {PSFCH}_{0 , 1}^{T R} , … , {PSFCH}_{0 , {N}_{0}^{TR , PSFCH} - 1}^{T R} \} ,$$

$${TR}_{acc}^{S L} = \{ {PSCCH}_{0}^{T R} {\_PSSCH}_{0}^{T R} , PSFC {H}_{0 , 0}^{T R} , {PSFCH}_{0 , 1}^{T R} , … , {PSFCH}_{0 , {N}_{0}^{TR , PSFCH} - 1}^{T R} \} ;$$

for another example, if

$$T {R}_{CO}^{S L} = \{ P S S C {H}_{0}^{T R} , PSFC {H}_{0 , 0}^{T R} , {PSFCH}_{0 , 1}^{T R} , … , {PSFCH}_{0 , {N}_{0}^{TR , PSFCH} - 1}^{T R} \} ,$$

$$then {TR}_{a c c}^{S L} = \{ P S S C {H}_{0}^{T R} , P S F C {H}_{0 , 0}^{T R} , {PSFCH}_{0 , 1}^{T R} , … , {PSFCH}_{0 , {N}_{0}^{TR , PSFCH} - 1}^{T R} \} ;$$

for another example, if

$$T {R}_{CO}^{S L} = \{ {S\_SSB}_{0}^{T R} \} , then {TR}_{a c c}^{S L} = \{ {S\_SSB}_{0}^{T R} \} ;$$

for another example, if

$$T {R}_{CO}^{S L} = \{ P S C C {H}_{0}^{T R} \} , then {TR}_{a c c}^{S L} = \{ P S C C {H}_{0}^{T R} \} .$$

If conditions for determining a set of type 1A sidelink transmissions are met, then

$$T {R}_{a c c}^{S L} = T {R}_{CO}^{S L} .$$

If conditions for determining a set of type 1B sidelink transmissions are met, then

$$T {R}_{a c c}^{S L} = \{ {PSCCH}_{0}^{T R} {\_PSSCH}_{0}^{T R} \} .$$

If conditions for determining a set of type 1C sidelink transmissions are met, then

$$T {R}_{a c c}^{S L} = \{ P S F C {H}_{0 , 0}^{T R} , {PSFCH}_{0 , 1}^{T R} , … , {PSFCH}_{0 , {N}_{0}^{T R , P S F C H} - 1}^{T R} \} .$$

If conditions for determining a set of type 1D sidelink transmissions are met, then

$$T {R}_{a c c}^{S L} = \{ P S S C {H}_{0}^{T R} \} .$$

If conditions for determining a set of type 1E sidelink transmissions are met, then

$$T {R}_{a c c}^{S L} = \{ P S F C {H}_{0 , 0}^{T R} , {PSFCH}_{0 , 1}^{T R} , … , {PSFCH}_{0 , {N}_{0}^{T R , P S F C H} - 1}^{T R} \} .$$

The conditions for determining a set of type 1A sidelink transmissions may include one or more (e.g., any of the combinations made by way of “and” or “or”) of the following:

$$T {R}_{C O}^{S L} = \{ P S C C {H}_{0}^{T R} \} .$$

$${TR}_{C O}^{S L} = \{ P S S C {H}_{0}^{T R} \} .$$

$${TR}_{C O}^{S L} = \{ {PSCCH}_{0}^{T R} {\_PSSCH}_{0}^{T R} \} .$$

$${TR}_{C O}^{S L} = \{ P S F C {H}_{0 , 0}^{T R} , {PSFCH}_{0 , 1}^{T R} , … , {PSFCH}_{0 , {N}_{0}^{TR , PSFCH} - 1}^{T R} \} .$$

$${TR}_{C O}^{S L} = \{ {S\_SSB}_{0}^{T R} \} .$$

$${TR}_{C O}^{S L} = \{ {PSCCH}_{0}^{T R} {\_PSSCH}_{0}^{T R} , PSFC {H}_{0 , 0}^{T R} , {PSFCH}_{0 , 1}^{T R} , … , {PSFCH}_{0 , {N}_{0}^{T R , P S F C H} - 1}^{T R} \} .$$

The number of channels where the resources corresponding to the

$$PSFC {H}_{0 , 0}^{T R} , the {PSFCH}_{0 , 1}^{T R} , … , and the {PSFCH}_{0 , {N}_{0}^{TR , PSFCH} - 1}^{T R}$$

are located is 1.
The number of channels where the resources corresponding to the

$${PSCCH}_{0}^{T R} {\_PSSCH}_{0}^{T R}$$

are located is 1.
The number of channels where the resources corresponding to the

$$P S S C {H}_{0}^{T R}$$

are located is 1.
The number of channels where the resources corresponding to the

$${S\_SSB}_{0}^{T R}$$

are located is 1.
A set consisting of (one or more) channels where the resources corresponding to the

$$PSCC {H}_{0}^{T R} {\_PSSCH}_{0}^{T R}$$

are located is equal to a set consisting of (one or more) channels where the resources corresponding to the

$$PSFC {H}_{0 , 0}^{T R} , {PSFCH}_{0 , 1}^{T R} , … , {PSFCH}_{0 , {N}_{0}^{TR , PSFCH} - 1}^{T R}$$

are located.
The number of RB sets where the resources corresponding to the

$$PSFC {H}_{0 , 0}^{T R} , the {PSFCH}_{0 , 1}^{T R} , … , and the {PSFCH}_{0 , {N}_{0}^{TR , PSFCH} - 1}^{T R}$$

are located is 1.
The number of RB sets where the resources corresponding to the

$$PSCC {H}_{0}^{T R} {\_PSSCH}_{0}^{T R}$$

are located is 1.
The number of RB sets where the resources corresponding to the

$${PSSCH}_{0}^{T R}$$

are located is 1.
The number of RB sets where the resources corresponding to the

$${S\_SSB}_{0}^{T R}$$

are located is 1.
A set consisting of (one or more) RB sets where the resources corresponding to the

$$PSCC {H}_{0}^{T R} {\_PSSCH}_{0}^{T R}$$

are located is equal to a set consisting of (one or more) RB sets where the resources corresponding to the

$$PSFC {H}_{0 , 0}^{T R} , {PSFCH}_{0 , 1}^{T R} , … , {PSFCH}_{0 , {N}_{0}^{TR , PSFCH} - 1}^{T R}$$

are located.
The CAPC determined for the

$$PSCC {H}_{0}^{T R} {\_PSSCH}_{0}^{T R}$$

is equal to the CAPC determined for the

$$PSFC {H}_{0 , 0}^{T R} , the {PSFCH}_{0 , 1}^{T R} , … , and the {PSFCH}_{0 , {N}_{0}^{TR , PSFCH} - 1}^{T R} .$$

$$T {R}_{CO}^{S L} = \{ PSSC {H}_{0}^{T R} , PSFC {H}_{0 , 0}^{T R} , {PSFCH}_{0 , 1}^{T R} , … , {PSFCH}_{0 , {N}_{0}^{TR - PSFCH} - 1}^{T R} \} .$$

A set consisting of (one or more) channels where the resources corresponding to the

$$P S S C {H}_{0}^{T R}$$

are located is equal to a set consisting of (one or more) channels where the resources corresponding to the

$$PSFC {H}_{0 , 0}^{T R} , {PSFCH}_{0 , 1}^{T R} , … , {PSFCH}_{0 , {N}_{0}^{TR , PSFCH} - 1}^{T R}$$

are located.
A set consisting of (one or more) RB sets where the resources corresponding to the

$${PSSCH}_{0}^{T R}$$

are located is equal to a set consisting of (one or more) RB sets where the resources corresponding to the

$$PSFC {H}_{0 , 0}^{T R} , {PSFCH}_{0 , 1}^{T R} , … , {PSFCH}_{0 , {N}_{0}^{TR , PSFCH} - 1}^{T R}$$

are located.
The CAPC determined for the

$${PSSCH}_{0}^{TR}$$

is equal to the CAPC determined for the

$${PSFCH}_{0 , 0}^{TR} , the {PSFCH}_{0 , 1}^{TR} , … , and the {PSFCH}_{0 , {N}_{0}^{TR , PSFCH} - 1}^{TR} .$$

The type of channel access procedure determined by the UE (e.g., the type of channel access procedure determined for the intended sidelink transmissions in the set

$${TR}_{CO}^{SL}$$

any subset of the set

$${TR}_{CO}^{SL} )$$

is a type 1 channel access procedure.

The conditions for determining a set of type 1B sidelink transmissions may include one or more (e.g., any of the combinations made by way of “and” or “or”) of the following:

$${TR}_{CO}^{SL} = \{ {PSCCH}_{0}^{TR} {\_PSSCH}_{0}^{TR} , {PSFCH}_{0 , 0}^{TR} , {PSFCH}_{0 , 1}^{TR} , … , {PSFCH}_{0 , {N}_{0}^{TR , PSFCH} - 1}^{TR} \} .$$

The number of channels where the resources corresponding to the

$${PSFCH}_{0 , 0}^{TR} , {PSFCH}_{0 , 1}^{TR} , … , {PSFCH}_{0 , {N}_{0}^{TR , PSFCH} - 1}^{TR}$$

are located is 1.
The number of channels where the resources corresponding to the

$${PSCCH}_{0}^{TR} {\_PSSCH}_{0}^{TR}$$

are located is 1.
A set consisting of (one or more) channels where the resources corresponding to the

$${PSFCH}_{0 , 0}^{TR} , {PSFCH}_{0 , 1}^{TR} , … , {PSFCH}_{0 , {N}_{0}^{TR , PSFCH} - 1}^{TR}$$

are located is a subset of a set consisting of (one or more) channels where the resources corresponding to the

$${PSCCH}_{0}^{TR} {\_PSSCH}_{0}^{TR}$$

are located.
A set consisting of (one or more channels where the resources corresponding to the

$${PSFCH}_{0 , 0}^{TR} , {PSFCH}_{0 , 1}^{TR} , … , {PSFCH}_{0 , {N}_{0}^{TR , PSFCH} - 1}^{TR}$$

are located is equal to a set consisting of (one or more) channels where the resources corresponding to the

$${PSCCH}_{0}^{TR} {\_PSSCH}_{0}^{TR}$$

are located.
The number of RB sets where the resources corresponding to the

$${PSFCH}_{0 , 0}^{TR} , {PSFCH}_{0 , 1}^{TR} , … , {PSFCH}_{0 , {N}_{0}^{TR , PSFCH} - 1}^{TR}$$

are located is 1.
The number of RB sets where the resources corresponding to the

$${PSCCH}_{0}^{TR} {\_PSSCH}_{0}^{TR}$$

are located is 1.
A set consisting of (one or more) RB sets where the resources corresponding to the

$${PSFCH}_{0 , 0}^{TR} , {PSFCH}_{0 , 1}^{TR} , … , {PSFCH}_{0 , {N}_{0}^{TR , PSFCH} - 1}^{TR}$$

are located is a subset of a set consisting of (one or more) RB sets where the resources corresponding to the

$${PSCCH}_{0}^{TR} {\_PSSCH}_{0}^{TR}$$

are located.
A set consisting of (one or more) RB sets where the resources corresponding to the

$$P S F C {H}_{0 , 0}^{T R} , {PSFCH}_{0 , 1}^{T R} , … , {PSFCH}_{0 , {N}_{0}^{TR , PSFCH} - 1}^{T R}$$

are located is equal to a set consisting of (one or more) RB sets where the resources corresponding to the

$$P S C C {H}_{0 -}^{T R} P S S C {H}_{0}^{T R}$$

are located.
The CAPC determined for the

$$P S C C {H}_{0 -}^{T R} P S S C {H}_{0}^{T R}$$

is smaller than (or smaller than or equal to) the CAPC determined for the

$$PSFC {H}_{0 , 0}^{T R} ,$$

$$the$$

$${PSFCH}_{0 , 1}^{T R} , … ,$$

$$and the$$

$${PSFCH}_{0 , {N}_{0}^{TR , PSFCH} - 1}^{T R} .$$

The type of channel access procedure determined by the UE (e.g., the type of channel access procedure determined for the intended sidelink transmissions in the set

$$T {R}_{CO}^{S L}$$

or any subset of the set

$${TR}_{CO}^{S L} )$$

is a type 1 channel access procedure.

The conditions for determining a set of type 1C sidelink transmissions may include one or more (e.g., any of the combinations made by way of “and” or “or”) of the following:

$$T {R}_{CO}^{S L} = \{ PSCC {H}_{0 -}^{T R} PSSC {H}_{0}^{T R} , PSFC {H}_{0 , 0}^{T R} , {PSFCH}_{0 , 1}^{T R} , … , {PSFCH}_{0 , {N}_{0}^{TR , PSFCH} - 1}^{T R} \} .$$

The number of channels where the resources corresponding to the

$${PSFCH}_{0 , 0}^{T R} , {PSFCH}_{0 , 1}^{T R} , … , {PSFCH}_{0 , {N}_{0}^{TR , PSFCH} - 1}^{T R}$$

are located is 1.
The number of channels where the resources corresponding to the

$$P S C C {H}_{0 -}^{T R} P S S C {H}_{0}^{T R}$$

are located is 1.
A set consisting of (one or more) channels where the resources corresponding to the

$$P S C C {H}_{0 -}^{T R} P S S C {H}_{0}^{T R}$$

are located is a subset of a set consisting of (one or more) channels where the resources corresponding to the

$${PSFCH}_{0 , 0}^{T R} , {PSFCH}_{0 , 1}^{T R} , … , {PSFCH}_{0 , {N}_{0}^{TR , PSFCH} - 1}^{T R}$$

are located.
A set consisting of (one or more) channels where the resources corresponding to the

$$P S C C {H}_{0 -}^{T R} P S S C {H}_{0}^{T R}$$

are located is equal to a set consisting of (one or more) channels where the resources corresponding to the

$${PSFCH}_{0 , 0}^{T R} , {PSFCH}_{0 , 1}^{T R} , … , {PSFCH}_{0 , {N}_{0}^{TR , PSFCH} - 1}^{T R}$$

are located.
The number of RB sets where the resources corresponding to the

$${PSFCH}_{0 , 0}^{T R} , {PSFCH}_{0 , 1}^{T R} , … , {PSFCH}_{0 , {N}_{0}^{TR , PSFCH} - 1}^{T R}$$

are located is 1.
The number of RB sets where the resources corresponding to the

$$P S C C {H}_{0 -}^{T R} P S S C {H}_{0}^{T R}$$

are located is 1.
A set consisting of (one or more) RB sets where the resources corresponding to the

$${PSCCH}_{0}^{T R} {\_PSSCH}_{0}^{T R}$$

are located is a subset of a set consisting of (one or more) RB sets where the resources corresponding to the

$$P S F C {H}_{0 , 0}^{T R} , {PSFCH}_{0 , 1}^{T R} , … , {PSFCH}_{0 , {N}_{0}^{TR , PSFCH} - 1}^{T R}$$

are located.
A set consisting of (one or more) RB sets where the resources corresponding to the

$${PSCCH}_{0}^{T R} {\_PSSCH}_{0}^{T R}$$

are located is equal to a set consisting of (one or more) RB sets where the resources corresponding to the

$$PSFC {H}_{0 , 0}^{T R} , {PSFCH}_{0 , 1}^{T R} , … , {PSFCH}_{0 , {N}_{0}^{TR , PSFCH} - 1}^{T R}$$

are located.
The CAPC determined for the

$${PSCCH}_{0}^{T R} {\_PSSCH}_{0}^{T R}$$

is higher than (or higher than or equal to) the CAPC determined for the

$$PSFC {H}_{0 , 0}^{T R} , the {PSFCH}_{0 , 1}^{T R} , … , and the {PSFCH}_{0 , {N}_{0}^{TR , PSFCH} - 1}^{T R} .$$

The type of channel access procedure determined by the UE (e.g., the type of channel access procedure determined for the intended sidelink transmissions in the set

$$T {R}_{CO}^{S L} )$$

any subset of the set

$$T {R}_{c o}^{S L} )$$

is a type 1 channel access procedure.

The conditions for determining a set of type 1D sidelink transmissions may include one or more (e.g., any of the combinations made by way of “and” or “or”) of the following:

$$T {R}_{CO}^{S L} = \{ P S S C {H}_{0}^{T R} , P S F C {H}_{0 , 0}^{T R} , {PSFCH}_{0 , 1}^{T R} , … , {PSFCH}_{0 , {N}_{0}^{TR , PSFCH} - 1}^{T R} \} .$$

The number of channels where the resources corresponding to the

$$PSFC {H}_{0 , 0}^{T R} , {PSFCH}_{0 , 1}^{T R} , … , {PSFCH}_{0 , {N}_{0}^{TR , PSFCH} - 1}^{T R}$$

are located is 1.
The number of channels where the resources corresponding to the

$$P S S C {H}_{0}^{T R}$$

are located is 1.
A set consisting of (one or more) channels where the resources corresponding to the

$$PSFC {H}_{0 , 0}^{T R} , {PSFCH}_{0 , 1}^{T R} , … , {PSFCH}_{0 , {N}_{0}^{TR , PSFCH} - 1}^{T R}$$

are located is a subset of a set consisting of (one or more) channels where the resources corresponding to the

$$P S S C {H}_{0}^{T R}$$

are located.
A set consisting of (one or more) channels where the resources corresponding to the

$$PSFC {H}_{0 , 0}^{T R} , {PSFCH}_{0 , 1}^{T R} , … , {PSFCH}_{0 , {N}_{0}^{TR , PSFCH} - 1}^{T R}$$

are located is equal to a set consisting of (one or more) channels where the resources corresponding to the

$$P S S C {H}_{0}^{T R}$$

are located.
The number of RB sets where the resources corresponding to the

$$PSFC {H}_{0 , 0}^{T R} , {PSFCH}_{0 , 1}^{T R} , … , {PSFCH}_{0 , {N}_{0}^{TR , PSFCH} - 1}^{T R}$$

are located is 1.
The number of RB sets where the resources corresponding to the

$${PSSCH}_{0}^{TR}$$

are located is 1.
A set consisting of (one or more) RB sets where the resources corresponding to the

$${PSFCH}_{0 , 0}^{TR} , {PSFCH}_{0 , 1}^{TR} , … , {PSFCH}_{0 , {N}_{0}^{TR , PSFCH} - 1}^{TR}$$

are located is a subset of a set consisting of (one or more) RB sets where the resources corresponding to the

$${PSSCH}_{0}^{TR}$$

are located.
A set consisting of (one or more) RB sets where the resources corresponding to the

$${PSFCH}_{0 , 0}^{TR} , {PSFCH}_{0 , 1}^{TR} , … , {PSFCH}_{0 , {N}_{0}^{TR , PSFCH} - 1}^{TR}$$

are located is equal to a set consisting of (one or more) RB sets where the resources corresponding to the

$${PSSCH}_{0}^{TR}$$

are located.
The CAPC determined for the

$${PSSCH}_{0}^{TR}$$

is lower than (or lower than or equal to) the CAPC determined for the

$${PSFCH}_{0 , 0}^{TR} , the {PSFCH}_{0 , 1}^{TR} , … , and the {PSFCH}_{0 , {N}_{0}^{TR , PSFCH} - 1}^{TR} .$$

The type of channel access procedure determined by the UE (e.g., the type of channel access procedure determined for the intended sidelink transmissions in the set

$${TR}_{CO}^{SL}$$

or any subset of the set

$${TR}_{CO}^{SL} )$$

a type 1 channel access procedure.

The conditions for determining a set of type 1E sidelink transmissions may include one or more (e.g., any of the combinations made by way of “and” or “or”) of the following:

$${TR}_{CO}^{SL} = \{ {PSSCH}_{0}^{TR} , {PSFCH}_{0 , 0}^{TR} , {PSFCH}_{0 , 1}^{TR} , … , {PSFCH}_{0 , {N}_{0}^{TR , PSFCH} - 1}^{TR} \} .$$

The number of channels where the resources corresponding to the

$${PSFCH}_{0 , 0}^{TR} , {PSFCH}_{0 , 1}^{TR} , … , {PSFCH}_{0 , {N}_{0}^{TR , PSFCH} - 1}^{TR}$$

are located is 1.
The number of channels where the resources corresponding to the

$${PSSCH}_{0}^{TR}$$

are located is 1.
A set consisting of (one or more) channels where the resources corresponding to the

$${PSSCH}_{0}^{TR}$$

are located is a subset of a set consisting of (one or more) channels where the resources corresponding to the

$${PSFCH}_{0 , 0}^{TR} , {PSFCH}_{0 , 1}^{TR} , … , {PSFCH}_{0 , {N}_{0}^{TR , PSFCH} - 1}^{TR}$$

are located.
A set consisting of (one or more) channels where the resources corresponding to the

$${PSSCH}_{0}^{TR}$$

are located is equal to a set consisting of (one or more) channels where the resources corresponding to the

$${PSFCH}_{0 , 0}^{TR} , {PSFCH}_{0 , 1}^{TR} , … , {PSFCH}_{0 , {N}_{0}^{TR , PSFCH} - 1}^{TR}$$

are located.
The number of RB sets where the resources corresponding to the

$${PSFCH}_{0 , 0}^{TR} , {PSFCH}_{0 , 1}^{TR} , … , {PSFCH}_{0 , {N}_{0}^{TR , PSFCH} - 1}^{TR}$$

are located is 1.
The number of RB sets where the resources corresponding to the

$${PSSCH}_{0}^{TR}$$

are located is 1.
A set consisting of (one or more) RB sets where the resources corresponding to the

$${PSSCH}_{0}^{TR}$$

are located is a subset of a set consisting of (one or more) RB sets where the resources corresponding to the

$${PSFCH}_{0 , 0}^{TR} , {PSFCH}_{0 , 1}^{TR} , … , {PSFCH}_{0 , {N}_{0}^{TR , PSFCH} - 1}^{TR}$$

are located.
A set consisting of (one or more) RB sets where the resources corresponding to the

$${PSSCH}_{0}^{TR}$$

are located is equal to a set consisting of (one or more) RB sets where the resources corresponding to the

$${PSFCH}_{0 , 0}^{TR} , {PSFCH}_{0 , 1}^{TR} , … , {PSFCH}_{0 , {N}_{0}^{TR , PSFCH} - 1}^{TR}$$

are located.
The CAPC determined for the

$${PSSCH}_{0}^{TR}$$

is higher than (or higher than or equal to) the CAPC determined for the

$${PSFCH}_{0 , 0}^{TR} , the {PSFCH}_{0 , 1}^{TR} , … , and the {PSFCH}_{0 , {N}_{0}^{TR , PSFCH} - 1}^{TR} .$$

The type of channel access procedure determined by the UE (e.g., the type of channel access procedure determined for the intended sidelink transmissions in the set

$$T {R}_{CO}^{S L}$$

or any subset of the set

$${TR}_{CO}^{SL} )$$

is a type 1 channel access procedure.

Further, in step S203, a set of first channels (e.g., denoted as

$${CH}_{acc}^{SL} = \{ {ch}_{0}^{SL , acc} , {ch}_{1}^{SL , acc} , … , {ch}_{{N}_{acc}^{CH , SL} - 1}^{SL , acc} \} ,$$

wherein

$${N}_{acc}^{CH , SL}$$

may be an integer greater than or equal to 1) is determined.

The set of RB sets corresponding to the set

$${CH}_{acc}^{SL}$$

may be denoted as

$${RS}_{acc}^{SL} = \{ {rs}_{0}^{SL , acc} , {rs}_{1}^{SL , acc} , … , {rs}_{{N}_{acc}^{RS , SL} - 1}^{SL , acc} \} ,$$

wherein

$${N}_{acc}^{RS , SL}$$

may be an integer greater than or equal to 1.

The

$${N}_{a c c}^{RS , SL}$$

may be equal to the

$${N}_{a c c}^{CH , SL} ,$$

and accordingly, the

$$r {s}_{0}^{S L , a c c}$$

may correspond to the

$$c {h}_{0}^{S L , a c c} , the {rs}_{1}^{S L , a c c}$$

may correspond to the

$$c {h}_{1}^{S L , a c c} , … , and the {rs}_{{N}_{acc}^{RS , SL} - 1}^{SL , acc}$$

may correspond to the

$${ch}_{{N}_{acc}^{CH , SL} - 1}^{SL , acc} .$$

The set

$$C {H}_{a c c}^{S L}$$

may be a set of channels for channel access determined for performing (one or more) sidelink transmissions in the set

$$T {R}_{a c c}^{S L} .$$

The channels in the set

$$C {H}_{a c c}^{S L}$$

may be contiguous channels. For example,

$$C {H}_{a c c}^{S L} = \{ c {h}_{0}^{S L , acc} , {ch}_{1}^{S L , acc} , {ch}_{2}^{S L , a c c} \} ,$$

wherein

$$c {h}_{0}^{S L , acc} , {ch}_{1}^{S L , acc} , and {ch}_{2}^{S L , a c c}$$

are ch₀, ch₁, and ch₂ in the set CH_{C}, respectively.

The RB sets in the set

$$R {S}_{a c c}^{S L}$$

may be contiguous RB sets. For example,

$$R {S}_{a c c}^{S L} = \{ {rs}_{0}^{SL , acc} , {rs}_{1}^{SL , acc} , {rs}_{2}^{SL , acc} \} ,$$

wherein

$${rs}_{0}^{SL , acc} , {rs}_{1}^{SL , acc} , and {rs}_{2}^{SL , acc}$$

are rs₀, rs₁, and rs₂ in the set RS_{C}, respectively.

The set

$$C {H}_{a c c}^{S L}$$

may be a subset of the set CH_{E}. The set

$$R {S}_{a c c}^{S L}$$

may be a subset of the set RS_{E}.

The set

$$C {H}_{a c c}^{S L}$$

may be a subset of the set CH_{B}. The set

$$R {S}_{a c c}^{S L}$$

may be a subset of the set RS_{B}.

The set

$$C {H}_{a c c}^{S L}$$

may be a subset of the set CH_{C}. The set

$$R {S}_{a c c}^{S L}$$

may be a subset of the set RS_{C}.

The set

$$C {H}_{a c c}^{S L}$$

may be a subset of set

$$C {H}_{0}^{SL} .$$

### The set

$$R {S}_{a c c}^{S L}$$

may be a subset of set

$$R {S}_{0}^{S L} .$$

The set

$$C {H}_{0}^{S L}$$

may be set

$$C {H}_{0}^{TR , ntd , SL} .$$

The set

$$C {H}_{0}^{TR , ntd , SL}$$

may be a set consisting of (one or more channels where the resources corresponding to all of the sidelink transmissions in the set

$$T {R}_{a c c}^{S L}$$

are located, and the number (e.g., denoted as

$${N}_{acc , 0}^{CH , TR , ntd , SL} )$$

of elements in the set

$$C {H}_{0}^{TR , ntd , SL}$$

may be an integer greater than or equal to 1. For example, if

$$\{ {PSCCH}_{0}^{TR} {\_PSSCH}_{0}^{TR} , {PSFCH}_{0 , 0}^{TR} , {PSFCH}_{0 , 1}^{TR} , … , {PSFCH}_{0 , {N}_{0}^{TR , PSFCH} - 1}^{TR} \}$$

wherein the channel where the resources corresponding to the

$${PSCCH}_{0}^{TR} {\_PSSCH}_{0}^{TR}$$

are located is ch₀, and the channel where the resources corresponding to the

$${PSFCH}_{0 , 0}^{TR} , the {PSFCH}_{0 , 1}^{TR} , … , and the {PSFCH}_{0 , {N}_{0}^{TR , PSFCH} - 1}^{TR}$$

are located is ch₁, then

$${CH}_{0}^{TR , ntd , SL} = \{ {ch}_{0} , {ch}_{1} \} .$$

As another example, if

$${TR}_{acc}^{SL} = \{ {PSSCH}_{0}^{TR} , {PSFCH}_{0 , 0}^{TR} , {PSFCH}_{0 , 1}^{TR} , … , {PSFCH}_{0 , {N}_{0}^{TR , PSFCH} - 1}^{TR} \} ,$$

wherein the channels where the resources corresponding to the

$${PSSCH}_{0}^{TR}$$

are located are ch₀ and ch₁, and the channels where the resources corresponding to the

$${PSFCH}_{0}^{TR} , the {PSFCH}_{0 , 1}^{TR} , … , and the {PSFCH}_{0 , {N}_{0}^{TR , PSFCH} - 1}^{TR}$$

are located are ch₁ and ch₂, then

$${CH}_{0}^{TR , ntd , SL} = \{ {ch}_{0} , {ch}_{1} , {ch}_{2} \} .$$

As another example, if

$$\{ {PSCCH}_{0}^{TR} {\_PSSCH}_{0}^{TR} , {PSFCH}_{0 , 0}^{TR} , {PSFCH}_{0 , 1}^{TR} , … , {PSFCH}_{0 , {N}_{0}^{TR , PSFCH} - 1}^{TR} \} ,$$

wherein the channel where the resources corresponding to the

$${PSCCH}_{0}^{TR} {\_PSSCH}_{0}^{TR}$$

are located is ch₀, and the channel where the resources corresponding to the

$${PSFCH}_{0}^{TR} , the {PSFCH}_{0 , 1}^{TR} , … , and the {PSFCH}_{0 , {N}_{0}^{TR , PSFCH} - 1}^{TR}$$

are located is ch₂, then

$${CH}_{0}^{TR , ntd , SL} = \{ {ch}_{0} , {ch}_{1} \} .$$

As another example, if

$${TR}_{acc}^{SL} = \{ {PSSCH}_{0}^{TR} , {PSFCH}_{0 , 0}^{TR} , {PSFCH}_{0 , 1}^{TR} , … , {PSFCH}_{0 , {N}_{0}^{TR , PSFCH} - 1}^{TR} \} ,$$

wherein the channels where the resources corresponding to the

$${PSSCH}_{0}^{TR}$$

are located are ch₀ and ch₁, and the channel where the resources corresponding to the

$${PSFCH}_{0 , 0}^{TR} , the {PSFCH}_{0 , 1}^{TR} , … , and the {PSFCH}_{0 , {N}_{0}^{TR , PSFCH} - 1}^{TR}$$

are located is ch₃, then

$${CH}_{0}^{TR , ntd , SL} = \{ {ch}_{0} , {ch}_{1} , {ch}_{3} \} .$$

The set

$${RS}_{0}^{SL}$$

may be set

$${RS}_{0}^{TR , ntd , SL} .$$

The set

$${RS}_{0}^{TR , ntd , SL}$$

may be a set consisting of (one or more) RB sets where the resources corresponding to all of the sidelink transmissions in the set

$${TR}_{acc}^{SL}$$

are located, and the number (e.g., denoted as

$${N}_{acc , 0}^{RS , TR , ntd , SL} )$$

of elements in the set

$${RS}_{0}^{TR , ntd , SL}$$

may be an integer greater than or equal to 1. For example, if

$${TR}_{acc}^{SL} = \{ {PSCCH}_{0}^{TR} {\_PSSCH}_{0}^{TR} , {PSFCH}_{0 , 0}^{TR} , {PSFCH}_{0 , 1}^{TR} , … , {PSFCH}_{0 , {N}_{0}^{TR , PSFCH} - 1}^{TR} \} ,$$

wherein the RB set where the resources corresponding to the

$${PSCCH}_{0}^{TR} {\_PSSCH}_{0}^{TR}$$

are located is rs₀, and the channel where the resources corresponding to the

$${PSFCH}_{0 , 0}^{TR} , the {PSFCH}_{0 , 1}^{TR} , … , and the {PSFCH}_{0 , {N}_{0}^{TR , PSFCH} - 1}^{TR}$$

are located is rs₁, then

$${RS}_{0}^{TR , ntd , SL} = \{ {rs}_{0} , {rs}_{1} \} .$$

As another example, if

$${TR}_{acc}^{SL} = \{ {PSSCH}_{0}^{TR} , {PSFCH}_{0 , 0}^{TR} , {PSFCH}_{0 , 1}^{TR} , … , {PSFCH}_{0 , {N}_{0}^{TR , PSFCH} - 1}^{TR} \} ,$$

wherein the RB sets where the resources corresponding to the

$${PSSCH}_{0}^{TR}$$

are located are rs₀ and rs₁, and the RB sets where the resources corresponding to the

$${PSFCH}_{0 , 0}^{TR} , the {PSFCH}_{0 , 1}^{TR} , … , and the {PSFCH}_{0 , {N}_{0}^{TR , PSFCH} - 1}^{TR}$$

are located are rs₁ and rs₂, then

$${RS}_{0}^{TR , ntd , SL} = \{ {rs}_{0} , {rs}_{1} , {rs}_{2} \} .$$

As another example, if

$$T {R}_{a c c}^{S L} = \{ PSCC {H}_{0 -}^{T R} P S S C {H}_{0}^{T R} , PSFC {H}_{0 , 0}^{TR} , PSFC {H}_{0 , 1}^{TR} , … , {PSFCH}_{0 , {N}_{0}^{T R , P S F C H} - 1}^{T R} \} ,$$

wherein the RB set where the resources corresponding to the

$$P S C C {H}_{0 -}^{T R} P S S C {H}_{0}^{T R}$$

are located is rs₀, and the RB set where the resources corresponding to the

$${PSFCH}_{0 , 0}^{TR} ,$$

$$the$$

$${PSFCH}_{0 , 1}^{TR} , … ,$$

$$and the$$

$${PSFCH}_{0 , {N}_{0}^{T R , P S F C H} - 1}^{T R}$$

are located is rs₂, then

$$R {S}_{0}^{TR , ntd , S L} = \{ r {s}_{0} , {rs}_{2} \} .$$

For example, if

$$T {R}_{a c c}^{S L} = \{ PSSC {H}_{0}^{T R} , PSFC {H}_{0 , 0}^{TR} , PSFC {H}_{0 , 1}^{TR} , … , {PSFCH}_{0 , {N}_{0}^{T R , P S F C H} - 1}^{T R} \} ,$$

wherein the RB sets where the resources corresponding to the

$$P S S C {H}_{0}^{T R}$$

are located are rs₀ and rs₁, and the RB set where the resources corresponding to the

$${PSFCH}_{0 , 0}^{TR} ,$$

$$the$$

$${PSFCH}_{0 , 1}^{TR} , … ,$$

$$and the$$

$${PSFCH}_{0 , {N}_{0}^{T R , P S F C H} - 1}^{T R}$$

are located is rs₃, then

$$R {S}_{0}^{TR , ntd , S L} = \{ r {s}_{0} , {rs}_{1} , {rs}_{3} \} .$$

The set

$$C {H}_{0}^{TR , ntd , SL}$$

may be a set of channels corresponding to the set

$$R {S}_{0}^{TR , ntd , SL} .$$

The set

$$R {S}_{0}^{TR , ntd , SL}$$

may be a set of RB sets corresponding to the set

$${CH}_{0}^{TR , ntd , SL} .$$

The set

$$C {H}_{0}^{S L}$$

may be set

$$C {H}_{0}^{TR , inc , SL} .$$

The set

$$C {H}_{0}^{TR , inc , SL}$$

may be a set consisting of a number of contiguous channels which comprise (one or more) channels where the resources (e.g., frequency resources) corresponding to all of the sidelink transmissions in the set

$$T {R}_{a c c}^{S L}$$

are located, and the number (e.g., denoted as

$${N}_{acc , 0}^{CH , TR , inc , SL} )$$

of elements in the set

$$C {H}_{0}^{TR , inc , SL}$$

may be an integer greater than or equal to 1. For example,

$$C {H}_{0}^{TR , inc , SL}$$

may be a set (e.g., denoted as

$$C {H}_{0}^{TR , inc , SL} = \{ {ch}_{{z}_{min}} , {ch}_{{z}_{min} + 1} , … , {ch}_{{z}_{max}} \} )$$

consisting of all of the contiguous channels from the channel ch_{z}_{ₘᵢₙ} to the channel ch_{z}_{ₘₐₓ}, wherein ch_{z}_{ₘᵢₙ} may be the channel with the lowest numbering (or the lowest frequency) in the set

$$C {H}_{0}^{TR , ntd , SL} ,$$

ch_{z}_{ₘₐₓ} may be the channel with the highest numbering (or the highest frequency) in the set

$$C {H}_{0}^{TR , ntd , SL} ,$$

and zₘᵢₙ and zₘₐₓ may satisfy

$$0 \leq {z}_{min} \leq {z}_{max} \leq {N}_{C}^{C H} - 1 .$$

For example, if

$$C {H}_{0}^{TR , ntd , SL} = \{ c {h}_{0} , {ch}_{2} \} ,$$

then zₘᵢₙ=0, zₘₐₓ=2 and

$$C {H}_{0}^{TR , inc , SL} = \{ {ch}_{0} , {ch}_{1} , {ch}_{2} \} .$$

The set

$$R {S}_{0}^{S L}$$

may be set

$$R {S}_{0}^{TR , inc , SL} .$$

The set

$$R {S}_{0}^{TR , inc , SL}$$

may be a set consisting of a number of contiguous RB sets which comprise (one or more) RB sets where the resources (e.g., frequency resources) corresponding to all of the sidelink transmissions in the set

$$T {R}_{a c c}^{S L}$$

are located, and the number (e.g., denoted as

$${N}_{a cc , 0}^{RS , TR , inc , SL} )$$

of elements in the set

$$R {S}_{0}^{TR , inc , SL}$$

may be an integer greater than or equal to 1. For example,

$$R {S}_{0}^{TR , inc , SL}$$

may be set (e.g., denoted as

$$R {S}_{0}^{TR , inc , SL} = \{ {rs}_{{y}_{min}} , {rs}_{{y}_{min} + 1} , … , {rs}_{{y}_{max}} \} )$$

consisting of all of the contiguous RB sets from the RB set rs_{y}_{ₘᵢₙ} to the RB set rs_{y}_{ₘₐₓ}, wherein rs_{y}_{ₘᵢₙ} may be the RB set with the lowest numbering (or the lowest frequency) in the set

$${RS}_{0}^{TR , ntd , SL} ,$$

rs_{y}_{ₘₐₓ} may be the RB set with the highest numbering (or the highest frequency) in the set

$${RS}_{0}^{TR , ntd , SL} ,$$

and rs_{y}_{ₘᵢₙ} and rs_{y}_{ₘₐₓ} may satisfy

$$0 \leq r {s}_{{y}_{min}} \leq r {s}_{{y}_{max}} \leq {N}_{C}^{R S} - 1 .$$

For example, if

$${RS}_{0}^{TR , ntd , SL} = \{ {rs}_{0} , {rs}_{2} \} ,$$

then yₘᵢₙ=0, yₘₐₓ=2, and

$$R {S}_{0}^{TR , inc , SL} = \{ {rs}_{0} , {rs}_{1} , {rs}_{2} \} .$$

The set

$$C {H}_{0}^{TR , inc , SL}$$

may be a set of channels corresponding to the set

$$R {S}_{0}^{TR , inc , SL} .$$

The set

$$R {S}_{0}^{TR , inc , SL}$$

may be a set of RB sets corresponding to the set

$$C {H}_{0}^{TR , inc , SL} .$$

The set

$$C {H}_{a c c}^{S L}$$

may be related to the configuration of an intra-cell guard band.

The set

$$C {H}_{a c c}^{S L}$$

may be related to the set

$$T {R}_{ref , 0}^{S L} ,$$

wherein the set

$$T {R}_{ref , 0}^{S L}$$

may be defined as the set

$$T {R}_{acc}^{S L} ,$$

or defined as the set

$$T {R}_{CO}^{S L} .$$

For example, for different values of the set

$$T {R}_{ref , 0}^{S L} ,$$

the ways in which the set

$$C {H}_{a c c}^{S L}$$

is determined may be different.

The set

$$C {H}_{a c c}^{S L}$$

may be determined in one or more of the following ways:

$$C {H}_{a c c}^{S L} = C {H}_{0}^{S L} .$$

If one or more (e.g., any of the combinations made by way of “and” or “or”) of the following is/are met, then

$$C {H}_{a c c}^{S L} = C {H}_{0}^{S L} :$$

type 1A channel-set-determination conditions.
type 1B channel-set-determination conditions.
type 1C channel-set-determination conditions.
type 1D channel-set-determination conditions.
type 1E channel-set-determination conditions.
type 1F channel-set-determination conditions.
type 1G channel-set-determination conditions.
type 1H channel-set-determination conditions.

$$C {H}_{a c c}^{S L} = C {H}_{E} .$$

If one or more (e.g., any of the combinations made by way of “and” or “or”) of the following is/are met, then

$$C {H}_{a c c}^{S L} = C {H}_{E} :$$

type 1A channel-set-determination conditions.
type 1B channel-set-determination conditions.
type 1C channel-set-determination conditions.
type 1D channel-set-determination conditions.
type 1E channel-set-determination conditions.
type 1F channel-set-determination conditions.
type 1G channel-set-determination conditions.
type 1H channel-set-determination conditions.

$$C {H}_{a c c}^{S L} = C {H}_{B} .$$

If one or more (e.g., any of the combinations made by way of “and” or “or”) of the following is/are met, then

$$C {H}_{a c c}^{S L} = C {H}_{B} :$$

type 1A channel-set-determination conditions.
type 1B channel-set-determination conditions.
type 1C channel-set-determination conditions.
type 1D channel-set-determination conditions.
type 1E channel-set-determination conditions.
type 1F channel-set-determination conditions.
type 1G channel-set-determination conditions.
type 1H channel-set-determination conditions.

$$C {H}_{a c c}^{S L} = C {H}_{C} .$$

If one or more (e.g., any of the combinations made by way of “and” or “or”) of the following is/are met, then

$$C {H}_{a c c}^{S L} = C {H}_{C} :$$

type 1A channel-set-determination conditions.
type 1B channel-set-determination conditions.
type 1C channel-set-determination conditions.
type 1D channel-set-determination conditions.
type 1E channel-set-determination conditions.
type 1F channel-set-determination conditions.
type 1G channel-set-determination conditions.
type 1H channel-set-determination conditions.

The type 1A channel-set-determination conditions may be related to the set

$$T {R}_{ref , 0}^{S L} .$$

For example, for different values of the set

$$T {R}_{ref , 0}^{S L} ,$$

the type TA channel-set-determination conditions may be different; as another example, the type 1A channel-set-determination conditions may only be applicable to a specific value of the set

$$T {R}_{ref , 0}^{S L} .$$

The type 1A channel-set-determination conditions may include one or more (e.g., any of the combinations made by way of “and” or “or”) of the following:
An intra-cell guard band has been configured.

$${N}_{acc , 0}^{CH , TR , ntd , SL} = 1.$$

$${N}_{acc , 0}^{CH , TR , inc , SL} = 1 .$$

All of the sidelink transmissions in the set

$$T {R}_{CO}^{S L}$$

are in the resource pool e_{acc}.
All of the sidelink transmissions in the set

$$T {R}_{a c c}^{S L}$$

are in the resource pool e_{acc}.

$$T {R}_{C O}^{S L} = \{ P S C C {H}_{0}^{T R} \} .$$

$${TR}_{C O}^{S L} = \{ P S S C {H}_{0}^{T R} \} .$$

$${TR}_{C O}^{S L} = \{ P S C C {H}_{0}^{T R} {\_PSSCH}_{0}^{T R} \} .$$

$${TR}_{C O}^{S L} = \{ P S F C {H}_{0 , 0}^{T R} , {PSFCH}_{0 , 1}^{T R} , … , {PSFCH}_{0 , {N}_{0}^{TR , PSFCH} - 1}^{T R} \} .$$

$${TR}_{C O}^{S L} = \{ P S C C {H}_{0}^{T R} {\_PSSCH}_{0}^{T R} , PSFC {H}_{0 , 0}^{T R} , {PSFCH}_{0 , 1}^{T R} , … , {PSFCH}_{0 , {N}_{0}^{T R , P S F C H} - 1}^{T R} \} .$$

$${TR}_{C O}^{S L} = \{ P S S C {H}_{0}^{T R} , PSFC {H}_{0 , 0}^{T R} , {PSFCH}_{0 , 1}^{T R} , … , {PSFCH}_{0 , {N}_{0}^{TR , PSFCH} - 1}^{T R} \} .$$

$${TR}_{C O}^{S L} = \{ {S\_SSB}_{0}^{T R} \} .$$

$${TR}_{a c c}^{S L} = \{ P S C C {H}_{0}^{T R} \} .$$

$${TR}_{a c c}^{S L} = \{ P S S C {H}_{0}^{T R} \} .$$

$${TR}_{a c c}^{S L} = \{ P S C C {H}_{0}^{T R} {\_PSSCH}_{0}^{T R} \} .$$

$${TR}_{a c c}^{S L} = \{ P S F C {H}_{0 , 0}^{T R} , {PSFCH}_{0 , 1}^{T R} , … , {PSFCH}_{0 , {N}_{0}^{T R , P S F C H} - 1}^{T R} \} .$$

$${TR}_{a c c}^{S L} = \{ P S C C {H}_{0}^{T R} {\_PSSCH}_{0}^{T R} , PSFC {H}_{0 , 0}^{T R} , {PSFCH}_{0 , 1}^{T R} , … , {PSFCH}_{0 , {N}_{0}^{TR , PSFCH} - 1}^{T R} \} .$$

$${TR}_{a c c}^{S L} = \{ P S S C {H}_{0}^{T R} , PSFC {H}_{0 , 0}^{T R} , {PSFCH}_{0 , 1}^{T R} , … , {PSFCH}_{0 , {N}_{0}^{TR , PSFCH} - 1}^{T R} \} .$$

$${TR}_{a c c}^{S L} = \{ {S\_SSB}_{0}^{T R} \} .$$

The type 1B channel-set-determination conditions may be related to the set

$$T {R}_{ref , 0}^{S L} .$$

For example, for different values of the set

$${TR}_{r e f , 0}^{S L} ,$$

the type 1B channel-set-determination conditions may be different; as another example, the type 1B channel-set-determination conditions may only be applicable a specific value of the set

$$T {R}_{ref , 0}^{S L} .$$

The type 1B channel-set-determination conditions may include one or more (e.g., any of the combinations made by way of “and” or “or”) of the following:
An intra-cell guard band has been configured.

$${N}_{acc , 0}^{CH , TR , ntd , SL} > 1.$$

$${N}_{acc , 0}^{CH , TR , inc , SL} > 1.$$

All of the sidelink transmissions in the set

$$T {R}_{CO}^{S L}$$

are in the resource pool e_{acc}.
All of the sidelink transmissions in the set

$$T {R}_{a c c}^{S L}$$

are in the resource pool e_{acc}.

$$T {R}_{C O}^{S L} = \{ P S C C {H}_{0}^{T R} \} .$$

$${TR}_{C O}^{S L} = \{ P S S C {H}_{0}^{T R} \} .$$

$${TR}_{C O}^{S L} = \{ P S C C {H}_{0}^{T R} {\_PSSCH}_{0}^{T R} \} .$$

$${TR}_{C O}^{S L} = \{ P S F C {H}_{0 , 0}^{T R} , {PSFCH}_{0 , 1}^{T R} , … , {PSFCH}_{0 , {N}_{0}^{TR , PSFCH} - 1}^{T R} \} .$$

$${TR}_{C O}^{S L} = \{ P S C C {H}_{0}^{T R} {\_PSSCH}_{0}^{T R} , PSFC {H}_{0 , 0}^{T R} , {PSFCH}_{0 , 1}^{T R} , … , {PSFCH}_{0 , {N}_{0}^{T R , P S F C H} - 1}^{T R} \} .$$

$${TR}_{C O}^{S L} = \{ P S S C {H}_{0}^{T R} , PSFC {H}_{0 , 0}^{T R} , {PSFCH}_{0 , 1}^{T R} , … , {PSFCH}_{0 , {N}_{0}^{TR , PSFCH} - 1}^{T R} \} .$$

$${TR}_{C O}^{S L} = \{ {S\_SSB}_{0}^{T R} \} .$$

$${TR}_{a c c}^{S L} = \{ P S C C {H}_{0}^{T R} \} .$$

$${TR}_{a c c}^{S L} = \{ P S S C {H}_{0}^{T R} \} .$$

$${TR}_{a c c}^{S L} = \{ P S C C {H}_{0}^{T R} {\_PSSCH}_{0}^{T R} \} .$$

$${TR}_{a c c}^{S L} = \{ P S F C {H}_{0 , 0}^{T R} , {PSFCH}_{0 , 1}^{T R} , … , {PSFCH}_{0 , {N}_{0}^{T R , P S F C H} - 1}^{T R} \} .$$

$${TR}_{a c c}^{S L} = \{ P S C C {H}_{0}^{T R} {\_PSSCH}_{0}^{T R} , PSFC {H}_{0 , 0}^{T R} , {PSFCH}_{0 , 1}^{T R} , … , {PSFCH}_{0 , {N}_{0}^{TR , PSFCH} - 1}^{T R} \} .$$

$${TR}_{a c c}^{S L} = \{ P S S C {H}_{0}^{T R} , PSFC {H}_{0 , 0}^{T R} , {PSFCH}_{0 , 1}^{T R} , … , {PSFCH}_{0 , {N}_{0}^{TR , PSFCH} - 1}^{T R} \} .$$

$${TR}_{a c c}^{S L} = \{ {S\_SSB}_{0}^{T R} \} .$$

The type 1C channel-set-determination conditions may be related to the set

$$T {R}_{r e f , 0}^{S L} .$$

For example, for different values of the set

$$T {R}_{ref , 0}^{S L} ,$$

the type 1C channel-set-determination conditions may be different; as another example, the type 1C channel-set-determination conditions may only be applicable a specific value of the set

$${TR}_{ref , 0}^{SL} .$$

The type 1C channel-set-determination conditions may include one or more (e.g., any of the combinations made by way of “and” or “or”) of the following:
An intra-cell guard band has not been configured.

$${N}_{acc , 0}^{CH , TR , ntd , SL} = 1.$$

$${N}_{acc , 0}^{CH , TR , inc , SL} = 1.$$

All of the sidelink transmissions in the set

$${TR}_{CO}^{SL}$$

are in the resource pool e_{acc}.
All of the sidelink transmissions in the set

$${TR}_{acc}^{SL}$$

are in the resource pool e_{acc}.

$${TR}_{CO}^{SL} = \{ {PSCCH}_{0}^{TR} \} .$$

$${TR}_{CO}^{SL} = \{ {PSSCH}_{0}^{TR} \} .$$

$${TR}_{CO}^{SL} = \{ {PSCCH}_{0}^{TR} {\_PSSCH}_{0}^{TR} \} .$$

$${TR}_{CO}^{SL} = \{ {PSFCH}_{0 , 0}^{TR} , {PSFCH}_{0 , 1}^{TR} , … , {PSFCH}_{0 , {N}_{0}^{TR , PSFCH} - 1}^{TR} \} .$$

$${TR}_{CO}^{SL} = \{ {PSCCH}_{0}^{TR} {\_PSSCH}_{0}^{TR} , {PSFCH}_{0 , 0}^{TR} , {PSFCH}_{0 , 1}^{TR} , … , {PSFCH}_{0 , {N}_{0}^{TR , PSFCH} - 1}^{TR} \} .$$

$${TR}_{CO}^{SL} = \{ {PSSCH}_{0}^{TR} , {PSFCH}_{0 , 0}^{TR} , {PSFCH}_{0 , 1}^{TR} , … , {PSFCH}_{0 , {N}_{0}^{TR , PSFCH} - 1}^{TR} \} .$$

$${TR}_{CO}^{SL} = \{ {S\_SSB}_{0}^{TR} \} .$$

$${TR}_{acc}^{SL} = \{ {PSCCH}_{0}^{TR} \} .$$

$${TR}_{acc}^{SL} = \{ {PSSCH}_{0}^{TR} \} .$$

$${TR}_{acc}^{SL} = \{ {PSCCH}_{0}^{TR} {\_PSSCH}_{0}^{TR} \} .$$

$${TR}_{acc}^{SL} = \{ {PSFCH}_{0 , 0}^{TR} , {PSFCH}_{0 , 1}^{TR} , … , {PSFCH}_{0 , {N}_{0}^{TR , PSFCH} - 1}^{TR} \} .$$

$${TR}_{acc}^{SL} = \{ {PSCCH}_{0}^{TR} {\_PSSCH}_{0}^{TR} , {PSFCH}_{0 , 0}^{TR} , {PSFCH}_{0 , 1}^{TR} , … , {PSFCH}_{0 , {N}_{0}^{TR , PSFCH} - 1}^{TR} \} .$$

$${TR}_{acc}^{SL} = \{ {PSSCH}_{0}^{TR} , {PSFCH}_{0 , 0}^{TR} , {PSFCH}_{0 , 1}^{TR} , … , {PSFCH}_{0 , {N}_{0}^{TR , PSFCH} - 1}^{TR} \} .$$

$${TR}_{acc}^{SL} = \{ {S\_SSB}_{0}^{TR} \} .$$

The type 1D channel-set-determination conditions may be related to the set

$${TR}_{ref , 0}^{SL} .$$

For example, for different values of the set

$${TR}_{ref , 0}^{SL} ,$$

the type 1D channel-set-determination conditions may be different; as another example, the type 1D channel-set-determination conditions may only be applicable a specific value of the set

$${TR}_{ref , 0}^{SL} .$$

The type 1D channel-set-determination conditions may include one or more (e.g., any of the combinations made by way of “and” or “or”) of the following:
An intra-cell guard band has not been configured.

$${N}_{acc , 0}^{CH , TR , ntd , SL} > 1.$$

$${N}_{acc , 0}^{CH , TR , inc , SL} > 1.$$

All of the sidelink transmissions in the set

$${TR}_{CO}^{SL}$$

are in the resource pool e_{acc}.
All of the sidelink transmissions in the set

$${TR}_{acc}^{SL}$$

are in the resource pool e_{acc}.

$${TR}_{CO}^{SL} = \{ {PSCCH}_{0}^{TR} \} .$$

$${TR}_{CO}^{SL} = \{ {PSSCH}_{0}^{TR} \} .$$

$${TR}_{CO}^{SL} = \{ {PSCCH}_{0}^{TR} {\_PSSCH}_{0}^{TR} \} .$$

$${TR}_{CO}^{SL} = \{ {PSFCH}_{0 , 0}^{TR} , {PSFCH}_{0 , 1}^{TR} , … , {PSFCH}_{0 , {N}_{0}^{TR , PSFCH} - 1}^{TR} \} .$$

$${TR}_{CO}^{SL} = \{ {PSCCH}_{0}^{TR} {\_PSSCH}_{0}^{TR} , {PSFCH}_{0 , 0}^{TR} , {PSFCH}_{0 , 1}^{TR} , … , {PSFCH}_{0 , {N}_{0}^{TR , PSFCH} - 1}^{TR} \} .$$

$${TR}_{CO}^{SL} = \{ {PSSCH}_{0}^{TR} , {PSFCH}_{0 , 0}^{TR} , {PSFCH}_{0 , 1}^{TR} , … , {PSFCH}_{0 , {N}_{0}^{TR , PSFCH} - 1}^{TR} \} .$$

$${TR}_{CO}^{SL} = \{ {S\_SSB}_{0}^{TR} \} .$$

$${TR}_{acc}^{SL} = \{ {PSCCH}_{0}^{TR} \} .$$

$${TR}_{acc}^{SL} = \{ {PSSCH}_{0}^{TR} \} .$$

$${TR}_{acc}^{SL} = \{ {PSCCH}_{0}^{TR} {\_PSSCH}_{0}^{TR} \} .$$

$${TR}_{acc}^{SL} = \{ {PSFCH}_{0 , 0}^{TR} , {PSFCH}_{0 , 1}^{TR} , … , {PSFCH}_{0 , {N}_{0}^{TR , PSFCH} - 1}^{TR} \} .$$

$${TR}_{acc}^{SL} = \{ {PSCCH}_{0}^{TR} {\_PSSCH}_{0}^{TR} , {PSFCH}_{0 , 0}^{TR} , {PSFCH}_{0 , 1}^{TR} , … , {PSFCH}_{0 , {N}_{0}^{TR , PSFCH} - 1}^{TR} \} .$$

$${TR}_{acc}^{SL} = \{ {PSSCH}_{0}^{TR} , {PSFCH}_{0 , 0}^{TR} , {PSFCH}_{0 , 1}^{TR} , … , {PSFCH}_{0 , {N}_{0}^{TR , PSFCH} - 1}^{TR} \} .$$

$${TR}_{acc}^{SL} = \{ {S\_SSB}_{0}^{TR} \} .$$

The type 1E channel-set-determination conditions may include one or more (e.g., any of the combinations made by way of “and” or “or”) of the following:
An intra-cell guard band has been configured.

$${N}_{acc , 0}^{CH , TR , ntd , SL} = 1.$$

$${N}_{acc , 0}^{CH , TR , inc , SL} = 1.$$

None of the sidelink transmissions in the set

$${TR}_{CO}^{SL}$$

is in any resource pool.
None of the sidelink transmissions in the set

$${TR}_{acc}^{SL}$$

is in any resource pool.

$${TR}_{CO}^{SL} = \{ {S\_SSB}_{0}^{TR} \} .$$

The type 1F channel-set-determination conditions may include one or more (e.g., any of the combinations made by way of “and” or “or”) of the following:
An intra-cell guard band has been configured.

$${N}_{acc , 0}^{CH , TR , ntd , SL} > 1.$$

$${N}_{acc , 0}^{CH , TR , inc , SL} > 1.$$

None of the sidelink transmissions in the set

$${TR}_{CO}^{SL}$$

is in any resource pool.
None of the sidelink transmissions in the set

$${TR}_{acc}^{SL}$$

is in any resource pool.

$${TR}_{CO}^{SL} = \{ {S\_SSB}_{0}^{TR} \} .$$

The type 1G channel-set-determination conditions may include one or more (e.g., any of the combinations made by way of “and” or “or”) of the following:
An intra-cell guard band has not been configured.

$${N}_{acc , 0}^{CH , TR , ntd , SL} = 1.$$

$${N}_{acc , 0}^{CH , TR , inc , SL} = 1.$$

None of the sidelink transmissions in the set

$${TR}_{CO}^{SL}$$

is in any resource pool.
None of the sidelink transmissions in the set

$${TR}_{acc}^{SL}$$

in any resource pool.

$${TR}_{CO}^{SL} = \{ {S\_SSB}_{0}^{TR} \} .$$

The type 1H channel-set-determination conditions may include one or more (e.g., any of the combinations made by way of “and” or “or”) of the following:
An intra-cell guard band has not been configured.

$${N}_{acc , 0}^{CH , TR , ntd , SL} > 1.$$

$${N}_{acc , 0}^{CH , TR , inc , SL} > 1.$$

None of the sidelink transmissions in the set

$${TR}_{CO}^{SL}$$

is in any resource pool.
None of the sidelink transmissions in the set

$$T {R}_{a c c}^{S L}$$

is in any resource pool.

$${TR}_{CO}^{SL} = \{ {S\_SSB}_{0}^{TR} \} .$$

Further, in step S205, channel access is performed.

For example, channel access is performed on (one or more) channels in the set

$${CH}_{acc}^{SL} .$$

Specifically, for example, if type 1A single-channel access conditions are met, the channel access corresponds to a single-channel access procedure; as another example, if type 1A multi-channel access conditions are met, the channel access corresponds to a multi-channel access procedure.

The type 1A single-channel access conditions may be related to the set

$$T {R}_{ref , 0}^{S L} .$$

For example, for different values of the set

$$T {R}_{ref , 0}^{S L} ,$$

the type 1A single-channel access conditions may be different; as another example, the type 1A single-channel access conditions may only be applicable to a specific value of the set

$$T {R}_{ref , 0}^{S L} .$$

The type 1A single-channel access conditions may include one or more (e.g., any of the combinations made by way of “and” or “or”) of the following:

$${N}_{a c c}^{CH , SL} = 1.$$

$${N}_{acc , 0}^{CH , TR , ntd , SL} = 1.$$

$${N}_{acc , 0}^{CH , TR , inc , SL} = 1.$$

$${TR}_{ref , 0}^{S L} = \{ P S C C {H}_{0}^{T R} \} .$$

$${TR}_{ref , 0}^{S L} = \{ P S S C {H}_{0}^{T R} \} .$$

$${TR}_{ref , 0}^{S L} = \{ P S C C {H}_{0}^{T R} {\_PSSCH}_{0}^{T R} \} .$$

$${TR}_{ref , 0}^{S L} = \{ {PSFCH}_{0 , 0}^{T R} , {PSFCH}_{0 , 1}^{T R} , … , {PSFCH}_{0 , {N}_{0}^{TR , PSFCH} - 1}^{T R} \} .$$

$${TR}_{ref , 0}^{S L} = \{ P S C C {H}_{0}^{T R} {\_PSSCH}_{0}^{T R} , PSFC {H}_{0 , 0}^{T R} , {PSFCH}_{0 , 1}^{T R} , … , {PSFCH}_{0 , {N}_{0}^{T R , P S F C H} - 1}^{T R} \} .$$

$${TR}_{ref , 0}^{S L} = \{ P S S C {H}_{0}^{T R} , PSFC {H}_{0 , 0}^{T R} , {PSFCH}_{0 , 1}^{T R} , … , {PSFCH}_{0 , {N}_{0}^{TR , PSFCH} - 1}^{T R} \} .$$

$${TR}_{ref , 0}^{S L} = \{ {S\_SSB}_{0}^{T R} \} .$$

The type 1A multi-channel access conditions may be related to the set

$$T {R}_{ref , 0}^{S L} .$$

For example, for different values of the set

$$T {R}_{ref , 0}^{S L} ,$$

the type 1A multi-channel access conditions may be different; as another example, the type 1A multi-channel access conditions may only be applicable to a specific value of the set

$$T {R}_{ref , 0}^{S L} .$$

The type 1A multi-channel access conditions may include one or more (e.g., any of the combinations made by way of “and” or “or”) of the following:

$${N}_{a c c}^{CH , SL} > 1.$$

$${N}_{acc , 0}^{CH , TR , ntd , SL} > 1.$$

$${N}_{acc , 0}^{CH , TR , inc , SL} > 1.$$

$${TR}_{ref , 0}^{S L} = \{ P S C C {H}_{0}^{T R} \} .$$

$${TR}_{ref , 0}^{S L} = \{ P S S C {H}_{0}^{T R} \} .$$

$${TR}_{ref , 0}^{S L} = \{ P S C C {H}_{0}^{T R} {\_PSSCH}_{0}^{T R} \} .$$

$${TR}_{ref , 0}^{S L} = \{ P S F C {H}_{0 , 0}^{T R} , {PSFCH}_{0 , 1}^{T R} , … , {PSFCH}_{0 , {N}_{0}^{TR , PSFCH} - 1}^{T R} \} .$$

$${TR}_{ref , 0}^{S L} = \{ P S C C {H}_{0}^{T R} {\_PSSCH}_{0}^{T R} , P S F C {H}_{0 , 0}^{T R} , {PSFCH}_{0 , 1}^{T R} , … , {PSFCH}_{0 , {N}_{0}^{T R , P S F C H} - 1}^{T R} \} .$$

$${TR}_{ref , 0}^{S L} = \{ P S S C {H}_{0}^{T R} , P S F C {H}_{0 , 0}^{T R} , {PSFCH}_{0 , 1}^{T R} , … , {PSFCH}_{0 , {N}_{0}^{TR , PSFCH} - 1}^{T R} \} .$$

$${TR}_{ref , 0}^{S L} = \{ {S\_SSB}_{0}^{T R} \} .$$

The channel access may be referred to as channel access performed for (one or more) sidelink transmissions in the set

$$T {R}_{a c c}^{S L} .$$

The CAPC corresponding to the channel access may be a function of (one or more) CAPCs determined for the (one or more) sidelink transmissions in the set

$$T {R}_{ref , 0}^{S L}$$

(e.g., the minimum of the one or more CAPCs; or the maximum of the one or more CAPCs). For example, if

$$T {R}_{ref , 0}^{S L} = \{ P S C C {H}_{0}^{T R} {\_PSSCH}_{0}^{T R} , {PSFCH}_{0 , 0}^{T R} , {PSFCH}_{0 , 1}^{T R} , {PSFCH}_{0 , 2}^{T R} \} ,$$

and the CAPC determined for the

$$P S C C {H}_{0}^{T R} {\_PSSCH}_{0}^{T R}$$

is 3 and the CAPC determined for the

$${PSFCH}_{0 , 0}^{T R} , the {PSFCH}_{0 , 1}^{T R} , and the {PSFCH}_{0 , 2}^{T R}$$

is 1, then the CPAC corresponding to the channel access is min(3, 1)=1. As another example, if

$$T {R}_{ref , 0}^{S L} = \{ {PSSCH}_{0}^{T R} , {PSFCH}_{0 , 0}^{T R} , {PSFCH}_{0 , 1}^{T R} , {PSFCH}_{0 , 2}^{T R} \} ,$$

and the CAPC determined for the

$$P S S C {H}_{0}^{T R}$$

is 2 and the CAPC determined for the

$${PSFCH}_{0 , 0}^{TR} , the {PSFCH}_{0 , 1}^{T R} , and the {PSFCH}_{0 , 2}^{T R}$$

is 1, then the CPAC corresponding to the channel access is min(2, 1)=1.

The channel access result may be related to the set

$$C {H}_{acc , S}^{S L}$$

and/or the set

$$C {H}_{acc , F}^{S L}$$

and/or the set

$$C {H}_{a c c , F , inc}^{S L} ,$$

wherein the set

$$C {H}_{acc , S}^{S L}$$

is a set consisting of (one or more) channels having a corresponding channel access result of “LBT success” in the set

$$C {H}_{acc}^{S L} ,$$

the set

$$C {H}_{acc , F}^{S L}$$

is a set consisting of (one or more) channels havin a corresponding channel access result of “LBT failure” in the set

$$C {H}_{acc}^{S L} ,$$

and the set

$$C {H}_{acc , F , inc}^{S L}$$

is a set (e.g., denoted as

$$C {H}_{acc , F , inc}^{S L} = \{ c {h}_{{x}_{min}} , {ch}_{{x}_{min} + 1} , … , {ch}_{{x}_{max}} \} )$$

consisting of all of the contiguous channels from the channel chₓ_{ₘᵢₙ} to the channel chₓ_{ₘₐₓ}, wherein chₓ_{ₘᵢₙ} may be the channel with the lowest numbering (or the lowest frequency) in the set

$$C {H}_{acc , F}^{S L} ,$$

chₓ_{ₘₐₓ} may be the channel with the highest numbering (or the highest frequency) in the set

$$C {H}_{acc , F}^{S L} ,$$

and xₘᵢₙ and xₘₐₓ may satisfy

$$0 \leq {x}_{min} \leq {x}_{max} \leq {N}_{C}^{C H} - 1.$$

For example, if

$$C {H}_{acc , F}^{S L} = \{ c {h}_{0} , {ch}_{2} \} ,$$

then xₘᵢₙ=0, xₘₐₓ=2 and

$$C {H}_{acc , F , inc}^{S L} = \{ c {h}_{0} , {ch}_{1} , c {h}_{2} \} .$$

The number (e.g., denoted as

$${N}_{acc , S}^{CH , SL} )$$

of elements in the set

$$C {H}_{acc , S}^{S L}$$

may be an integer greater than or equal to 0.

The number (e.g., denoted as

$${N}_{acc , F}^{CH , SL} )$$

of elements in the set

$$C {H}_{acc , F}^{S L}$$

may be an integer greater than or equal to 0.

The number (e.g., denoted as

$${N}_{acc , F , inc}^{CH , SL} )$$

of elements in the set

$$C {H}_{acc , F , inc}^{S L}$$

may be an integer greater than or equal to 0.

A union set of the set

$$C {H}_{acc , S}^{S L}$$

and the set

$$C {H}_{acc , F}^{S L}$$

may be the set

$$C {H}_{a c c}^{S L} .$$

An intersection set of the set

$$C {H}_{a c c , S}^{S L}$$

and the set

$$C {H}_{acc , F}^{S L}$$

may be an empty set.

The sets of RB sets corresponding to the set

$$C {H}_{acc , S}^{S L} ,$$

the set

$$C {H}_{acc , F}^{S L} ,$$

and the set

$$C {H}_{acc , F , inc}^{S L}$$

may be denoted as

$$R {S}_{acc , S}^{S L} , R {S}_{acc , F}^{S L} , and {RS}_{acc , F , inc}^{S L} ,$$

respectively. The number of elements in the sets

$$R {S}_{acc , S}^{S L} , R {S}_{acc , F}^{S L} , and {RS}_{acc , F , inc}^{S L}$$

may be denoted as

$${N}_{acc , S}^{RS , SL} , {N}_{acc , F}^{RS , SL} , and {N}_{acc , F , inc}^{RS , SL} ,$$

respectively. The

$${N}_{acc , S}^{RS , SL}$$

may be equal to the

$${N}_{acc , S}^{CH , SL} , the {N}_{acc , F}^{RS , SL}$$

may be equal to the

$${N}_{acc , F}^{CH , SL} , and the {N}_{acc , F , inc}^{RS , SL}$$

may be equal to the

$${N}_{acc , F , inc}^{CH , SL} .$$

The channel access result may be related to the

$${N}_{a c c}^{CH , SL} .$$

For example, for

$${N}_{a c c}^{CH , SL} = 1 ,$$

the channel access result may be the result of the corresponding single-channel access procedure i.e. the channel access result corresponding to the channel

$$c {h}_{0}^{S L , a c c} ) .$$

As another example, for

$${N}_{a c c}^{CH . SL} > 1 ,$$

the channel access result may be the result of the corresponding multi-channel access procedure; specifically, for example, for

$${N}_{a c c}^{CH . SL} > 1 ,$$

if type 1A multi-channel access result conditions are met, and/or type 1B multi-channel access result conditions are met, then the “channel access” result is “success”, otherwise the “channel access” result is “failure”.

The type 1A multi-channel access result conditions and/or type 1B multi-channel access result conditions may be related to the set

$$C {H}_{ref , 0}^{S L} ,$$

wherein the set

$$C {H}_{ref , 0}^{S L}$$

may be defined as the set

$$C {H}_{0}^{TR . ntd . SL} ,$$

or defined as the set

$${CH}_{ref , 0}^{SL} ,$$

or defined as the set

$${CH}_{0}^{SL} .$$

A set of RB sets corresponding to the set

$$C {H}_{ref , 0}^{S L}$$

may be denoted as

$$R {S}_{r e f , 0}^{S L} .$$

The type 1A multi-channel access result conditions may include one or more (e.g., any of the combinations made by way of “and” or “or”) of the following:
The corresponding result of each channel in the set

$$C {H}_{a c c}^{S L}$$

is “success”.
The corresponding result of each channel that is in the set

$$C {H}_{a c c}^{S L}$$

and belongs to the set

$$C {H}_{ref , 0}^{S L}$$

is “success”.
The corresponding result of at least one channel in the set

$$C {H}_{a c c}^{S L}$$

is “success” (e.g., this may correspond to the case that

$$C {H}_{acc , S}^{S L}$$

is not equal to an empty set).
The corresponding result of at least one channel that is in the set

$$C {H}_{a c c}^{S L}$$

and belongs to the set

$$C {H}_{ref , 0}^{S L}$$

is “success”.
An intra-cell guard b nna been configured.

The type 1B multi-channel access result conditions may include one or more (e.g., any of the combinations made by way of “and” or “or”) of the following:
The corresponding result of each channel in the set

$$C {H}_{a c c}^{S L}$$

is “success”.
The corresponding result of each channel that is in the set

$$C {H}_{a c c}^{S L}$$

and belongs to the set

$$C {H}_{ref , 0}^{S L}$$

is “success”.
An intra-ce guar and has not been configured.

After the channel access is performed, zero, one, or more sidelink transmissions that can be performed can be determined out of all of the sidelink transmissions in the set

$$T {R}_{a c c}^{S L}$$

(for example, the corresponding set of sidelink transmissions is denoted as

$$T {R}_{p r m}^{S L} ,$$

and the number of elements in the set

$$T {R}_{p r m}^{S L}$$

is denoted as

$${N}_{p r m}^{TR , SL} ,$$

herein the

$${N}_{p r m}^{TR , SL}$$

may be an integer greater than or equal to 0).

The set

$$T {R}_{p r m}^{SL}$$

may be determined in one or more of the following ways:
If the conditions tor determining a set of type 2A sidelink transmissions are met, then

$$T {R}_{p r m}^{S L} = T {R}_{a c c}^{S L} .$$

If the conditions for determining a set of type 2B sidelink transmissions are met, then

$$T {R}_{p r m}^{S L} = ∅$$

(i.e. the set

$$T {R}_{p r m}^{S L}$$

is an empty set).
If the conditions for determining a set of type 2C sidelink transmissions are met, then the set

$$T {R}_{p r m}^{S L}$$

comprises the

$${PSCCH}_{0}^{T R} {\_PPSSCH}_{0}^{T R} .$$

If the conditions for determining a set of type 2D sidelink transmissions are met, then the set

$$T {R}_{p r m}^{S L}$$

comprises the

$$PSSC {H}_{0}^{T R} .$$

If the conditions for determining a set of type 2E sidelink transmissions are met, then the set

$$T {R}_{p r m}^{S L}$$

comprises all of the elements in the set

$$T {R}_{CO , 0}^{SL , FC} .$$

The conditions for determining a set of type 2A sidelink transmissions may be related to the set

$$T {R}_{ref , 0}^{S L} .$$

For example, for different values of the set

$$T {R}_{ref , 0}^{S L} ,$$

the conditions for determining a set of type 2A sidelink transmissions may be different; as another example, the conditions for determining a set of type 2A sidelink transmissions may only be applicable to a specific value of the set

$$T {R}_{ref , 0}^{S L} .$$

The conditions for determining a set of type 2A sidelink transmissions may include one or more (e.g., any of the combinations made by way of “and” or “or”) of the following:
The channel access result is “success”.
The corresponding result of each channel in the set

$$C {H}_{a c c}^{S L}$$

is “success”.
The corresponding result of each channel that is in the set

$$C {H}_{a c c}^{S L}$$

and belongs to the set

$$C {H}_{ref , 0}^{S L} is “ success ” .$$

$$T {R}_{ref , 0}^{S L} = \{ PSCC {H}_{0}^{T R} \} .$$

$${TR}_{ref , 0}^{S L} = \{ PSSC {H}_{0}^{T R} \} .$$

$${TR}_{ref , 0}^{S L} = \{ PSCC {H}_{0}^{T R} {\_PSSCH}_{0}^{T R} \} .$$

$${TR}_{ref , 0}^{S L} = \{ PSFC {H}_{0 , 0}^{T R} , {PSFCH}_{0 , 1}^{T R} , … , {PSFCH}_{0 , {N}_{0}^{TR , PSFCH} - 1}^{T R} \} .$$

$${TR}_{ref , 0}^{S L} = \{ PSCC {H}_{0}^{T R} {\_PSSCH}_{0}^{T R} , {PSFCH}_{0 , 0}^{T R} , {PSFCH}_{0 , 1}^{T R} , {PSFCH}_{0 , {N}_{0}^{TR , PSFCH} - 1}^{T R} \} .$$

$${TR}_{ref , 0}^{S L} = \{ PSSC {H}_{0}^{T R} , {PSFCH}_{0 , 0}^{T R} , {PSFCH}_{0 , 1}^{T R} , {PSFCH}_{0 , {N}_{0}^{TR , PSFCH} - 1}^{T R} \} .$$

$${TR}_{ref , 0}^{S L} = \{ {S\_SSB}_{0}^{T R} \} .$$

The conditions for determining a set of type 2B sidelink transmissions may be related to the set

$${TR}_{ref , 0}^{SL} .$$

For example, for different values of the set

$${TR}_{ref , 0}^{SL} ,$$

the conditions for determining a set of type 2B s transmissions may be different; as another example, the conditions for determining a set of type 2B sidelink transmissions may only be applicable to a specific value of the set

$${TR}_{ref , 0}^{SL} .$$

The conditions for determining a set of type 2B sidelink transmissions may include one or more (e.g., any of the combinations made by way of “and” or “or”) of the following:
The channel access result is “failure”.
The corresponding result of each channel in the set

$${CH}_{acc}^{SL}$$

is “failure”.
The corresponding result of each channel that is in the set

$${CH}_{acc}^{SL}$$

and belongs to the set

$${CH}_{ref , 0}^{SL}$$

is “failure”.
The corresponding result of at least one channel in the set

$${CH}_{acc}^{SL}$$

is “failure” (e.g., this may correspond to the case that

$${CH}_{acc , F}^{SL}$$

is not equal to an empty set).
The corresponding result of at least one channel that is in the set

$${CH}_{acc}^{SL}$$

and belongs to the set

$${CH}_{ref , 0}^{SL}$$

is “failure”.

$${TR}_{ref , 0}^{SL} = \{ {PSCCH}_{0}^{TR} \} .$$

$${TR}_{ref , 0}^{SL} = \{ {PSSCH}_{0}^{TR} \} .$$

$${TR}_{ref , 0}^{SL} = \{ {PSCCH}_{0}^{TR} {\_PSSCH}_{0}^{TR} \} .$$

$${TR}_{ref , 0}^{SL} = \{ {PSFCH}_{0 , 0}^{TR} , {PSFCH}_{0 , 1}^{TR} , … , {PSFCH}_{0 , {N}_{0}^{TR , PSFCH} - 1}^{TR} \} .$$

$${TR}_{ref , 0}^{SL} = \{ {PSCCH}_{0}^{TR} {\_PSSCH}_{0}^{TR} , {PSFCH}_{0 , 0}^{TR} , {PSFCH}_{0 , 1}^{TR} , … , {PSFCH}_{0 , {N}_{0}^{TR , PSFCH} - 1}^{TR} \} .$$

$${TR}_{ref , 0}^{SL} = \{ {PSSCH}_{0}^{TR} , {PSFCH}_{0 , 0}^{TR} , {PSFCH}_{0 , 1}^{TR} , … , {PSFCH}_{0 , {N}_{0}^{TR , PSFCH} - 1}^{TR} \} .$$

$${TR}_{ref , 0}^{SL} = \{ {S\_SSB}_{0}^{TR} \} .$$

The conditions for determining a set of type 2C sidelink transmissions may include one or more (e.g., any of the combinations made by way of “and” or “or”) of the following:

$${TR}_{ref , 0}^{SL} = \{ {PSCCH}_{0}^{TR} {\_PSSCH}_{0}^{TR} , {PSFCH}_{0 , 0}^{TR} , {PSFCH}_{0 , 1}^{TR} , … , {PSFCH}_{0 , {N}_{0}^{TR , PSFCH} - 1}^{TR} \} .$$

The set

$${TR}_{ref , 0}^{SL}$$

comprises

$$P S C C {H}_{0}^{T R} {\_PSSCH}_{0}^{T R} .$$

A set consisting of one or more) channels where the resources corresponding to the

$$P S C C {H}_{0}^{T R} {\_PSSCH}_{0}^{T R}$$

are located is a subset of the set

$$C {H}_{acc , S}^{S L} .$$

The (one or more) channels where the resources corresponding to the

$$P S C C {H}_{0}^{T R} {\_PSSCH}_{0}^{T R}$$

are all in the set

$$C {H}_{acc , S}^{S L} .$$

An intra-cell guard band has been configured.

The conditions for determining a set of type 2D sidelink transmissions may include one or more (e.g., any of the combinations made by way of “and” or “or”) of the following:

$${TR}_{ref , 0}^{SL} = \{ {PSSCH}_{0}^{TR} , {PSFCH}_{0 , 0}^{TR} , {PSFCH}_{0 , 1}^{TR} , … , {PSFCH}_{0 , {N}_{0}^{TR , PSFCH} - 1}^{TR} \} .$$

The set

$${TR}_{ref , 0}^{S L}$$

comprises

$${PSSCH}_{0}^{T R} .$$

A set consisting of (one or more) channels where the resources corresponding to the

$${PSSCH}_{0}^{T R}$$

are located is a subset of the set

$$C {H}_{acc , S}^{S L} .$$

The (one or more) channels where the resources corresponding to the

$$P S S C {H}_{0}^{T R}$$

are all in the set

$$C {H}_{a c c , S}^{S L} .$$

An intra-cell guard band has been configured.

The conditions for determining a set of type 2E sidelink transmissions may include one or more (e.g., any of the combinations made by way of “and” or “or”) of the following:

$${TR}_{ref , 0}^{SL} = \{ {PSSCH}_{0}^{TR} , {PSFCH}_{0 , 0}^{TR} , {PSFCH}_{0 , 1}^{TR} , … , {PSFCH}_{0 , {N}_{0}^{TR , PSFCH} - 1}^{TR} \} .$$

$${TR}_{ref , 0}^{SL} = \{ {PSCCH}_{0}^{TR} {\_PSSCH}_{0}^{TR} , {PSFCH}_{0 , 0}^{TR} , {PSFCH}_{0 , 1}^{TR} , … , {PSFCH}_{0 , {N}_{0}^{TR , PSFCH} - 1}^{TR} \} .$$

The set

$$T {R}_{ref , 0}^{S L}$$

comprises the

$$P S F C {H}_{0 , 0}^{T R} , the {PSFCH}_{0 , 1}^{T R} , … , and the {PSFCH}_{0 , {N}_{0}^{TR , PSFCH} - 1}^{T R} .$$

A channel where the resources corresponding to at least one of the

$$PSFC {H}_{0 , 0}^{T R} , the {PSFCH}_{0 , 1}^{T R} , … , and the {PSFCH}_{0 , {N}_{0}^{TR , PSFCH} - 1}^{T R}$$

are located is in the set

$$C {H}_{acc , S}^{S L} .$$

For example,

$${N}_{0}^{TR , PSFCH} = 3 ,$$

and the channels where the resources corresponding to

$${PSFCH}_{0 , 0}^{TR} , {PSFCH}_{0 , 1}^{TR} , and {PSFCH}_{0 , 2}^{TR}$$

are ch₀, ch₀, and ch₁, respectively, and

$$C {H}_{acc , S}^{S L} = \{ {ch}_{0} , {ch}_{2} \} ,$$

then the channel where the resources corresponding to

$${PSFCH}_{0 , 0}^{TR}$$

are located is in the set

$$C {H}_{acc , S}^{S L} ,$$

and the channel where the resources corresponding to

$${PSFCH}_{0 , 1}^{TR}$$

is in the set

$$C {H}_{acc , S}^{S L} ,$$

and the channel where the resources corresponding to

$${PSFCH}_{0 , 2}^{TR}$$

are located is not in the set

$$C {H}_{acc , S}^{S L} .$$

An intra-cell guard and has been configured.

The set

$$T {R}_{CO , 0}^{SL , FC}$$

be a subset of the set

$$T {R}_{CO , FC , 0}^{SL} .$$

For example, the set

$$T {R}_{CO , 0}^{SL , FC}$$

may be a set consisting of all of the PSFCHs which are in the set

$$T {R}_{CO , FC , 0}^{S L}$$

and whose channels where the corresponding resources are located are in the set

$$C {H}_{acc , S}^{S L} .$$

For example, if

$${N}_{0}^{T R , PSFCH} = 3 ,$$

and the channels where the resources corresponding to

$${PSFCH}_{0 , 0}^{TR} , {PSFCH}_{0 , 1}^{TR} ,$$

and

$${PSFCH}_{0 , 2}^{TR}$$

are ch₀, ch₀, and ch₁, respectively, and

$$C {H}_{acc , S}^{SL} = \{ {ch}_{0} , {ch}_{2} \} , then {TR}_{CO , 0}^{SL , FC} = \{ {PSFCH}_{0 , 0}^{TR} , {PSFCH}_{0 , 1}^{TR} \} .$$

Further, in step S207, channel access failure is processed.

For example, if type 1 channel access failure conditions are met, then indicate (or notify, or report)

$${N}_{F}^{IND , SL}$$

channel access failures (also referred to as “LBT failures”) to one or more higher layer entities (e.g., the MAC layer entity) of the UE, wherein

$${N}_{F}^{IND , SL}$$

may be an integer greater than or equal to 1.

The type 1 channel access failure conditions and/or the indication of

$${N}_{F}^{IND , SL}$$

channel access failures may be related to a “set of channels related to access failure” (e.g., denoted as

$$C {H}_{F}^{SL} )$$

and/or a “set of RB sets related to access failure” (e.g., denoted as

$$R {S}_{F}^{SL} )$$

and/or a “set of resource pools related to access failure” (e.g., denoted as

$${E}_{F}^{SL} ) .$$

The number of elements in the set

$$C {H}_{F}^{SL}$$

may be denoted as

$${N}_{F}^{CH , SL} ,$$

wherein the

$${N}_{F}^{CH , SL}$$

may be an integer greater than or equal to 0, or an integer greater than or equal to 1.

$${N}_{F}^{CH , SL} = 0$$

may correspond to

$$C {H}_{F}^{SL} = ∅ ; for {N}_{F}^{CH , SL} \geq 1 ,$$

the set

$$C {H}_{F}^{SL}$$

may be denoted as

$$C {H}_{F}^{S L} = \{ {ch}_{0}^{SL , F} , {ch}_{1}^{SL , F} , … , {ch}_{{N}_{F}^{CH , SL} - 1}^{SL , F} \} .$$

The number of elements in the set

$$R {S}_{F}^{S L}$$

may be denoted as

$${N}_{F}^{RS , SL} ,$$

wherein the

$${N}_{F}^{RS , SL}$$

may be an integer greater than or equal to 0, or an integer greater than or equal to 1.

$${N}_{F}^{RS , SL} = 0$$

may correspond to

$${RS}_{F}^{SL} = ∅ ; for {N}_{F}^{RS , SL} \geq 1 ,$$

the set

$$R {S}_{F}^{S L}$$

may be denoted as

$$R {S}_{F}^{S L} = \{ {rs}_{0}^{S L , F} , {rs}_{1}^{SL , F} , … , {rs}_{{N}_{F}^{RS , SL} - 1}^{SL , F} \} .$$

The

$${N}_{F}^{RS , SL}$$

may be equal to the

$${N}_{F}^{CH , SL} .$$

The set

$$R {S}_{F}^{S L}$$

may be a set of RB sets corresponding to the set

$$C {H}_{F}^{S L} .$$

The set

$$C {H}_{F}^{S L}$$

may be a set of channels corresponding to the set

$$R {S}_{F}^{S L} .$$

The set

$$C {H}_{F}^{S L}$$

may be rated to the set

$${CH}_{ref , 1}^{SL} ,$$

wherein the set

$${CH}_{ref , 1}^{SL}$$

may be defined as the set

$$C {H}_{acc , F}^{SL} ,$$

or defined as the set

$$C {H}_{acc , F , inc}^{SL} ,$$

or defined as the set

$$C {H}_{0}^{TR , ntd , SL} ,$$

or defined as the set

$$C {H}_{0}^{TR , inc , SL} ,$$

or defined as the set

$$C {H}_{0}^{S L} ,$$

or defined as the set

$${CH}_{acc}^{S L} .$$

The set

$$R {S}_{F}^{S L}$$

may be related to the set

$$R {S}_{ref , 1}^{S L} ,$$

wherein the set

$$R {S}_{ref , 1}^{S L}$$

is a set of RB sets corresponding to the set

$$C {H}_{ref , 1}^{S L} .$$

The set

$$C {H}_{F}^{S L}$$

may be related to the set

$$C {H}_{ref , 2}^{S L} ,$$

wherein the set

$$C {H}_{ref , 2}^{S L}$$

may be defined as the set

$${CH}_{acc , f}^{SL} ,$$

or defined as the set

$${CH}_{acc , f , inc}^{SL} ,$$

or defined as the set

$${CH}_{0}^{TR , ntd , SL} ,$$

or defined as the set

$${CH}_{0}^{TR , inc , SL} ,$$

or defined as the set

$${CH}_{0}^{SL} ,$$

or defined as the set

$${CH}_{acc}^{SL} ,$$

or defined as the set CH_{E}, or defined as the set CH_{B}, or defined as the set CH_{C}. A set of RB sets corresponding to the set

$${CH}_{ref , 2}^{SL}$$

may be denoted as

$${RS}_{ref , 2}^{SL} .$$

The set

$${RS}_{F}^{SL}$$

may be related to the set

$${RS}_{ref , 2}^{SL} ,$$

wherein the set

$${RS}_{ref , 2}^{SL} ,$$

of RB sets corresponding to the set

$${CH}_{ref , 2}^{SL} .$$

The set

$${CH}_{F}^{SL}$$

may be related to the configuration of an intra-cell guard band.

The set

$${CH}_{F}^{SL}$$

may be related to the set

$${TR}_{ref , 0}^{SL} .$$

For example, for different values of the set

$$T {R}_{ref , 0}^{S L} ,$$

the set

$$C {H}_{F}^{S L}$$

may be determined differently.

For example, the set

$$C {H}_{F}^{S L}$$

may determined according to one or more of the following:

$$C {H}_{F}^{S L} = C {H}_{ref , 1}^{S L} .$$

If one or more (e.g., any of the combinations made by way of “and” or “or”) of the following is/are met, then

$$C {H}_{F}^{S L} = C {H}_{ref , 1}^{S L}$$

An intra-cell guard band has been configured.

$${N}_{acc , F}^{CH , SL} \geq {N}_{acc , F , th}^{CH , SL} .$$

### Wherein, the

$${N}_{acc , F , th}^{CH , SL}$$

may be a pre-defined or configured value

$$( e . g . {N}_{acc , F , th}^{CH , SL} = 1 ) ; the {N}_{acc , F , th ,}^{CH , SL}$$

may be related to the set

$$T {R}_{ref , 0}^{S L} .$$

$${N}_{acc , F}^{CH , SL} > {N}_{acc , F , th}^{CH , SL} .$$

$${N}_{acc , F , inc}^{CH , SL} \geq {N}_{acc , F , inc , th}^{CH , SL} .$$

### Wherein, the

$${N}_{acc , F , inc , th}^{CH , SL}$$

may be a pe-defined or configured value

$$( e . g . {N}_{acc , F , i n c , t h}^{CH , SL} = 1 ) ; the {N}_{acc , F , inc , t h}^{CH , SL}$$

may be related to the set

$$T {R}_{ref , 0}^{S L} .$$

$${N}_{acc , F , inc}^{CH , SL} > {N}_{acc , F , inc , th}^{CH , SL} .$$

$${N}_{p r m}^{TR , SL} = 0 .$$

$${N}_{prm}^{TR , SL} \leq {N}_{prm , F , th}^{TR , SL} .$$

### Wherein, the

$${N}_{prm , F , th}^{TR , SL}$$

may be a pre-defined or configured value

$$( e . g . {N}_{prm , F , th}^{TR , SL} = 1 ) ; the {N}_{prm , F , th}^{TR , SL}$$

may be related to the set

$$T {R}_{r e f , 0}^{S L} .$$

$${N}_{p r m}^{TR , SL} < {N}_{prm , F , th}^{TR , SL} .$$

$${TR}_{ref , 0}^{SL} = \{ {PSCCH}_{0}^{T R} \} .$$

$${TR}_{ref , 0}^{SL} , = \{ P S S C {H}_{0}^{T R} \} .$$

$${TR}_{ref , 0}^{SL} = \{ P S C C {H}_{0}^{T R} {\_PSSCH}_{0}^{T R} \} .$$

$${TR}_{ref , 0}^{SL} = \{ P S F C {H}_{0 , 0}^{T R} , {PSFCH}_{0 , 1}^{T R} , … , {PSFCH}_{0 , {N}_{0}^{TR , PSFCH} - 1}^{T R} \} .$$

$${TR}_{ref , 0}^{SL} = \{ P S C C {H}_{0}^{T R} {\_PSSCH}_{0}^{T R} , {PSFCH}_{0 , 0}^{TR} , {PSFCH}_{0 , 1}^{T R} , … , {PSFCH}_{0 , {N}_{0}^{TR , PSFCH} - 1}^{T R} \} .$$

$${TR}_{ref , 0}^{SL} = \{ {PSSCH}_{0}^{T R} , {PSFCH}_{0 , 0}^{T R} , {PSFCH}_{0 , 1}^{T R} , … , {PSFCH}_{0 , {N}_{0}^{T R , PSFCH} - 1}^{T R} \} .$$

$${TR}_{ref , 0}^{S L} = \{ {S\_SSB}_{0}^{T R} \} .$$

$${CH}_{F}^{S L} = C {H}_{ref , 2}^{S L} .$$

If one or more (e.g., any of the combinations made by way of “and” or “or”) of the following is/are met, then

$$C {H}_{F}^{S L} = C {H}_{ref , 2}^{S L} :$$

An intra-cell guard band has not been configured.

$${N}_{acc , F}^{CH , SL} \geq {N}_{acc , F , th}^{CH , SL} .$$

$${N}_{acc , F}^{CH , SL} > {N}_{acc , F , th}^{CH , SL} .$$

$${N}_{acc , F , inc}^{CH , SL} \geq {N}_{acc , F , inc , th}^{CH , SL} .$$

$${N}_{acc , F , inc}^{CH , SL} > {N}_{acc , F , inc , th}^{CH , SL} .$$

$${N}_{p r m}^{TR , SL} = 0.$$

$${N}_{p r m}^{TR , SL} \leq {N}_{prm , F , th}^{TR , SL} .$$

$${N}_{p r m}^{TR , SL} < {N}_{prm , F , th}^{TR , SL} .$$

$${TR}_{ref , 0}^{S L} = \{ P S C C {H}_{0}^{T R} \} .$$

$${TR}_{ref , 0}^{S L} = \{ P S S C {H}_{0}^{T R} \} .$$

$${TR}_{ref , 0}^{S L} = \{ P S C C {H}_{0}^{T R} {\_PSSCH}_{0}^{T R} \} .$$

$${TR}_{ref , 0}^{S L} = \{ P S F C {H}_{0 , 0}^{T R} , {PSFCH}_{0 , 1}^{T R} , … , {PSFCH}_{0 , {N}_{0}^{TR , PSFCH} - 1}^{T R} \} .$$

$${TR}_{ref , 0}^{S L} = \{ {PSCCH}_{0}^{TR} {\_PSSCH}_{0}^{T R} , {PSFCH}_{0 , 0}^{T R} , {PSFCH}_{0 , 1}^{TR} , … , {PSFCH}_{0 , {N}_{0}^{TR , PSFCH} - 1}^{T R} \} .$$

$${TR}_{ref , 0}^{S L} = \{ {PSSCH}_{0}^{T R} , {PSFCH}_{0 , 0}^{T R} , {PSFCH}_{0 , 1}^{T R} , … , {PSFCH}_{0 , {N}_{0}^{T R , P S F C H} - 1}^{T R} \} .$$

$${TR}_{ref , 0}^{S L} = \{ {S\_SSB}_{0}^{T R} \} .$$

The set

$$R {S}_{F}^{S L}$$

may be related to the configuration of an intra-cell guard band.

The set

$$R {S}_{F}^{S L}$$

may be related to the set

$$T {R}_{ref , 0}^{S L} .$$

For example, for different values of the set

$${TR}_{ref , 0}^{SL} ,$$

the set

$$R {S}_{F}^{S L}$$

may be determined differently.

For example, the set

$$R {S}_{F}^{S L}$$

may determined according to one or more of the following:

$$R {S}_{F}^{S L} = R {S}_{ref , 1}^{S L} .$$

If one or more (e.g., any of the combinations made by way of “and” or “or”) of the following is/are met, then

$$R {S}_{F}^{S L} = R {S}_{ref , 1}^{S L} :$$

An intra-cell guard band has been configured.

$${N}_{acc , F}^{RS , SL} \geq {N}_{acc , F , th}^{RS , SL} .$$

### Wherein, the

$${N}_{acc , F , th}^{RS , SL}$$

may be a pre-defined or configured value

$$( e . g . {N}_{acc , F , th}^{RS , SL} = 1 ) ; the {N}_{acc , F , th}^{RS , SL}$$

may be related to the set

$$T {R}_{ref , 0}^{S L} .$$

$${N}_{acc , F}^{RS , SL} > {N}_{acc , F , th}^{RS , SL} .$$

$${N}_{acc , F , inc}^{RS , SL} \geq {N}_{acc , F , inc , th}^{RS , SL} .$$

### Wherein, the

$${N}_{acc , F , inc , th}^{RS , SL}$$

may be a pre-defined or configured value

$$( e . g . {N}_{acc , F , inc , th}^{RS , SL} = 1 ) ; the {N}_{acc , F , inc , th}^{RS , SL}$$

may be related to the set

$$T {R}_{ref , 0}^{S L} .$$

$${N}_{acc , F , inc}^{RS , SL} > {N}_{acc , F , inc , th}^{RS , SL} .$$

$${N}_{p r m}^{TR , SL} = 0.$$

$${N}_{p r m}^{TR , SL} \leq {N}_{prm , F , th}^{TR , SL} .$$

$${N}_{p r m}^{TR , SL} < {N}_{prm , F , th}^{TR , SL} .$$

$${TR}_{ref , 0}^{S L} = \{ {PSCCH}_{0}^{T R} \} .$$

$${TR}_{ref , 0}^{SL} = \{ {PSSCH}_{0}^{T R} \} .$$

$${TR}_{ref , 0}^{S L} = \{ {PSCCH}_{0}^{TR} {\_PSSCH}_{0}^{T R} \} .$$

$${TR}_{ref , 0}^{S L} = \{ {PSFCH}_{0 , 0}^{T R} , {PSFCH}_{0 , 1}^{T R} , … , {PSFCH}_{0 , {N}_{0}^{TR , PSFCH} - 1}^{T R} \} .$$

$${TR}_{ref , 0}^{SL} = \{ {PSCCH}_{0}^{TR} {\_PSSCH}_{0}^{TR} , {PSFCH}_{0 , 0}^{TR} , {PSFCH}_{0 , 1}^{TR} , … , {PSFCH}_{0 , {N}_{0}^{TR , PSFCH} - 1}^{TR} \} .$$

$${TR}_{ref , 0}^{SL} = \{ {PSSCH}_{0}^{TR} , {PSFCH}_{0 , 0}^{TR} , {PSFCH}_{0 , 1}^{TR} , … , {PSFCH}_{0 , {N}_{0}^{TR , PSFCH} - 1}^{TR} \} .$$

$${TR}_{ref , 0}^{SL} = \{ {S\_SSB}_{0}^{TR} \} .$$

$${RS}_{F}^{S L} = R {S}_{ref , 2}^{S L} .$$

If one or more (e.g., any of the combinations made by way of “and” or “or”) of the following is/are met, then

$$R {S}_{F}^{S L} = R {S}_{ref , 2}^{S L} :$$

An intra-cell guard band has not been configured.

$${N}_{acc , F}^{RS , SL} \geq {N}_{acc , F , th}^{RS , SL} .$$

$${N}_{acc , F}^{RS , SL} > {N}_{acc , F , th}^{RS , SL} .$$

$${N}_{acc , F , inc}^{RS , SL} \geq {N}_{acc , F , inc , th}^{RS , SL} .$$

$${N}_{acc , F , inc}^{RS , SL} > {N}_{acc , F , inc , th}^{RS , SL} .$$

$${N}_{p r m}^{TR , SL} = 0.$$

$${N}_{p r m}^{TR , SL} \leq {N}_{prm , F , th}^{TR , SL} .$$

$${N}_{p r m}^{TR , SL} < {N}_{prm , F , th}^{TR , SL} .$$

$${TR}_{ref}^{SL} = \{ {PSCCH}_{0}^{TR} \} .$$

$${TR}_{ref , 0}^{SL} = \{ {PSSCH}_{0}^{TR} \} .$$

$${TR}_{ref , 0}^{SL} = \{ {PSCCH}_{0}^{TR} {\_PSSCH}_{0}^{TR} \} .$$

$${TR}_{ref , 0}^{SL} = \{ {PSFCH}_{0 , 0}^{TR} , {PSFCH}_{0 , 1}^{TR} , … , {PSFCH}_{0 , {N}_{0}^{TR , PSFCH} - 1}^{TR} \} .$$

$${TR}_{ref , 0}^{SL} = \{ {PSCCH}_{0}^{TR} {\_PSSCH}_{0}^{TR} , {PSFCH}_{0 , 0}^{TR} , {PSFCH}_{0 , 1}^{TR} , … , {PSFCH}_{0 , {N}_{0}^{TR , PSFCH} - 1}^{TR} \} .$$

$${TR}_{ref , 0}^{SL} = \{ {PSSCH}_{0}^{T R} , {PSFCH}_{0 , 0}^{T R} , {PSFCH}_{0 , 1}^{T R} , … , {PSFCH}_{0 , {N}_{0}^{TR , PSFCH} - 1}^{T R} \} .$$

$${TR}_{ref , 0}^{S L} = \{ {S\_SSB}_{0}^{T R} \} .$$

The number of elements in the set

$${E}_{F}^{S L}$$

may be denoted as

$${N}_{F}^{E , SL} ,$$

wherein the

$${N}_{F}^{E , SL}$$

may be an integer greater than or equal to 0, or an integer greater than or equal to 1.

$${N}_{F}^{E , SL} = 0$$

may correspond to

$${E}_{F}^{SL} = ∅ ; for {N}_{F}^{E , SL} \geq 1 ,$$

the set

$${E}_{F}^{SL}$$

may be denoted as

$${E}_{F}^{SL} = \{ {e}_{0}^{SL , F} , {e}_{1}^{SL , F} , … , {e}_{{N}_{F}^{E , SL} - 1}^{SL , F} \} .$$

The set

$${E}_{F}^{S L}$$

may be related to the set

$$C {H}_{F}^{S L} .$$

For example, the set

$${E}_{F}^{S L}$$

may be determined according to the set

$$C {H}_{F}^{S L} .$$

The set

$${E}_{F}^{S L}$$

may be related to the set

$$R {S}_{F}^{S L} .$$

For example, the set

$${E}_{F}^{S L}$$

may be determined according to the set

$$R {S}_{F}^{S L} .$$

The set

$${E}_{F}^{S L}$$

may be related to the set

$$T {R}_{ref , 0}^{S L} .$$

For example, for different values of the set

$$T {R}_{ref , 0}^{S L} ,$$

the set

$${E}_{F}^{SL}$$

may be determined differently.

For example, the set

$${E}_{F}^{SL}$$

may be determined according to one or more of the following:
The set

$${E}_{F}^{SL}$$

only comprises the resource pool e_{acc}

$$( i . e . , {E}_{F}^{SL} = \{ {e}_{acc} \} ) .$$

If type 1A resource pool access failure conditions are met, then the set

$${E}_{F}^{SL}$$

only comprises the resource pool e_{acc}

$$( i . e . , {E}_{F}^{SL} = \{ {e}_{acc} \} ) .$$

$${E}_{F}^{SL} = {E}_{A}^{acc} .$$

If type 1B resource pool access failure conditions are met, then

$${E}_{F}^{SL} = {E}_{A}^{acc} .$$

$${E}_{F}^{SL} = {E}_{F , 0}^{SL} .$$

If type 1C resource pool access failure conditions are met, then

$${E}_{F}^{SL} = {E}_{F , 0}^{SL} .$$

$${E}_{F}^{SL} = {E}_{F , 1}^{SL} .$$

If type 1D resource pool access failure conditions are met, then

$${E}_{F}^{SL} = {E}_{F , 1}^{SL} .$$

The type 1A resource pool access failure conditions may be related to the set

$${TR}_{ref , 0}^{SL} .$$

For example, for different values of the set

$${TR}_{ref , 0}^{SL} ,$$

the type 1A resource pool access failure conditions may be different; as another example, the type 1A resource pool access failure conditions may only be applicable to a specific value of the set

$${TR}_{ref , 0}^{SL} .$$

The type 1A resource pool access failure conditions may include one or more (e.g., any of the combinations made by way of “and” or “or”) of the following:
The resources corresponding to all of the sidelink transmissions in the set

$${TR}_{ref , 0}^{SL}$$

are all in the resource pool e_{acc}.
An intra-cell guard band has been configured.

$${TR}_{ref , 0}^{SL} = \{ {PSCCH}_{0}^{TR} \} .$$

$${TR}_{ref , 0}^{SL} = \{ {PSSCH}_{0}^{TR} \} .$$

$${TR}_{ref , 0}^{SL} = \{ {PSCCH}_{0}^{TR} {\_PSSCH}_{0}^{TR} \} .$$

$${TR}_{ref , 0}^{SL} = \{ {PSFCH}_{0 , 0}^{TR} , {PSFCH}_{0 , 1}^{TR} , … , {PSFCH}_{0 , {N}_{0}^{TR , PSFCH} - 1}^{TR} \} .$$

$${TR}_{ref , 0}^{SL} = \{ {PSCCH}_{0}^{TR} {\_PSSCH}_{0}^{TR} , {PSFCH}_{0 , 0}^{TR} , {PSFCH}_{0 , 1}^{TR} , … , {PSFCH}_{0 , {N}_{0}^{TR , PSFCH} - 1}^{TR} \} .$$

$${TR}_{ref , 0}^{SL} = \{ {PSSCH}_{0}^{TR} , {PSFCH}_{0 , 0}^{TR} , {PSFCH}_{0 , 1}^{TR} , … , {PSFCH}_{0 , {N}_{0}^{TR , PSFCH} - 1}^{TR} \} .$$

$${TR}_{ref , 0}^{SL} = \{ {S\_SSB}_{0}^{TR} \} .$$

The type 1B resource pool access failure conditions may be related to the set

$${TR}_{ref , 0}^{SL} .$$

For example, for different values of the set

$${TR}_{ref , 0}^{SL} ,$$

the type 1B resource pool access failure conditions may be different; as another example, the type 1B resource pool access failure conditions may only be applicable to a specific value of the set

$${TR}_{ref , 0}^{SL} .$$

The type 1B resource pool access failure conditions may include one or more (e.g., any of the combinations made by way of “and” or “or”) of the following:
The resources corresponding to all of the sidelink transmissions in the set

$${TR}_{ref , 0}^{SL}$$

are all in the resource pool e_{acc}.
None of the resources corresponding to all of the sidelink transmissions in the set

$${TR}_{ref , 0}^{SL}$$

is in the resource pool.
An intra-cell guard band has not been configured.

$${TR}_{ref , 0}^{SL} = \{ {PSCCH}_{0}^{TR} \} .$$

$${TR}_{ref , 0}^{SL} = \{ {PSSCH}_{0}^{TR} \} .$$

$${TR}_{ref , 0}^{SL} = \{ {PSCCH}_{0}^{TR} {\_PSSCH}_{0}^{TR} \} .$$

$${TR}_{ref , 0}^{SL} = \{ {PSFCH}_{0 , 0}^{TR} , {PSFCH}_{0 , 1}^{TR} , … , {PSFCH}_{0 , {N}_{0}^{TR , PSFCH} - 1}^{TR} \} .$$

$${TR}_{ref , 0}^{SL} = \{ {PSCCH}_{0}^{TR} {\_PSSCH}_{0}^{TR} , {PSFCH}_{0 , 0}^{TR} , {PSFCH}_{0 , 1}^{TR} , … , {PSFCH}_{0 , {N}_{0}^{TR , PSFCH} - 1}^{TR} \} .$$

$${TR}_{ref , 0}^{SL} = \{ {PSSCH}_{0}^{TR} , {PSFCH}_{0 , 0}^{TR} , {PSFCH}_{0 , 1}^{TR} , … , {PSFCH}_{0 , {N}_{0}^{TR , PSFCH} - 1}^{TR} \} .$$

$${TR}_{ref , 0}^{SL} = \{ {S\_SSB}_{0}^{TR} \} .$$

The type 1C resource pool access failure conditions may be related to the set

$${TR}_{ref , 0}^{SL} .$$

For example, for different values of the set

$${TR}_{ref , 0}^{SL} ,$$

the type 1C resource pool access failure conditions may be different; as another example, the type 1C resource pool access failure conditions may only be applicable to a specific value of the set

$${TR}_{ref , 0}^{SL} .$$

The type 1C resource pool access failure conditions may include one or more (e.g., any of the combinations made by way of “and” or “or”) of the following:
The resources corresponding to all of the sidelink transmissions in the set

$${TR}_{ref , 0}^{SL}$$

are all in the resource pool e_{acc}.
An intra-cell guard band has been configured.

$${TR}_{ref , 0}^{SL} = \{ {PSCCH}_{0}^{TR} \} .$$

$${TR}_{ref , 0}^{SL} = \{ {PSSCH}_{0}^{TR} \} .$$

$${TR}_{ref , 0}^{SL} = \{ {PSCCH}_{0}^{TR} {\_PSSCH}_{0}^{TR} \} .$$

$${TR}_{ref , 0}^{SL} = \{ {PSFCH}_{0 , 0}^{TR} , {PSFCH}_{0 , 1}^{TR} , … , {PSFCH}_{0 , {N}_{0}^{TR , PSFCH} - 1}^{TR} \} .$$

$${TR}_{ref , 0}^{SL} = \{ {PSCCH}_{0}^{TR} {\_PSSCH}_{0}^{TR} , {PSFCH}_{0 , 0}^{TR} , {PSFCH}_{0 , 1}^{TR} , … , {PSFCH}_{0 , {N}_{0}^{TR , PSFCH} - 1}^{TR} \} .$$

$${TR}_{ref , 0}^{SL} = \{ {PSSCH}_{0}^{TR} , {PSFCH}_{0 , 0}^{TR} , {PSFCH}_{0 , 1}^{TR} , … , {PSFCH}_{0 , {N}_{0}^{TR , PSFCH} - 1}^{TR} \} .$$

$${TR}_{ref , 0}^{SL} = \{ {S\_SSB}_{0}^{TR} \} .$$

The type 1D resource pool access failure conditions may be related to the set

$${TR}_{ref , 0}^{SL} .$$

For example, for different values of the set

$${TR}_{ref , 0}^{SL} ,$$

the type 1D resource pool access failure conditions may be different; as another example, the type 1D resource pool access failure conditions may only be applicable to a specific value of the set

$${TR}_{ref , 0}^{SL} .$$

The type 1D resource pool access failure conditions may include one or more (e.g., any of the combinations made by way of “and” or “or”) of the following:
The resources corresponding to all of the sidelink transmissions in the set

$${TR}_{ref , 0}^{SL}$$

are all in the resource pool e_{acc}.
An intra-cell guard band has been configured.

$${TR}_{ref , 0}^{SL} = \{ {PSCCH}_{0}^{TR} \} .$$

$${TR}_{ref , 0}^{SL} = \{ {PSSCH}_{0}^{TR} \} .$$

$${TR}_{ref , 0}^{SL} = \{ {PSCCH}_{0}^{TR} {\_PSSCH}_{0}^{TR} \} .$$

$${TR}_{ref , 0}^{SL} = \{ {PSFCH}_{0 , 0}^{TR} , {PSFCH}_{0 , 1}^{TR} , … , {PSFCH}_{0 , {N}_{0}^{TR , PSFCH} - 1}^{TR} \} .$$

$${TR}_{ref , 0}^{SL} = \{ {PSCCH}_{0}^{TR} {\_PSSCH}_{0}^{TR} , {PSFCH}_{0 , 0}^{TR} , {PSFCH}_{0 , 1}^{TR} , … , {PSFCH}_{0 , {N}_{0}^{TR , PSFCH} - 1}^{TR} \} .$$

$${TR}_{ref , 0}^{SL} = \{ {PSSCH}_{0}^{TR} , {PSFCH}_{0 , 0}^{TR} , {PSFCH}_{0 , 1}^{TR} , … , {PSFCH}_{0 , {N}_{0}^{TR , PSFCH} - 1}^{TR} \} .$$

$${T R}_{ref , 0}^{SL} = \{ {S\_SSB}_{0}^{TR} \} .$$

The

$${E}_{F , 0}^{SL}$$

may be defined as a set consisting of all of the resource pools that satisfy type 1E resource pool access failure conditions, wherein for resource pool e, the type 1E resource pool access failure conditions may include one or more (e.g., any of the combinations made by way of “and” or “or”) of the following:
The resource pool e is in the set

$${E}_{A}^{acc} .$$

The resource pool e is a transmission resource pool.
The resource pool e is the resource pool e_{acc}.
The resource pool e is a transmission resource pool, and its corresponding reception resource pool (e.g., denoted as e′) satisfies other conditions comprised in the type 1E resource pool access failure conditions.
Out of all of the channels in the set

$${CH}_{F}^{SL} ,$$

at least

$${N}_{F , 0 , 0}^{CH , acc}$$

channels are in the resource pool e, wherein

$${N}_{F , 0 , 0}^{CH , acc}$$

may be a pre-defined or configured value, or may be determined according to one or more pre-defined or configured values

$$( e . g . , {N}_{F , 0 , 0}^{CH , acc} = 1 ) .$$

Out of all of the channels in the set

$${CH}_{F}^{SL} ,$$

at least

$${P}_{F , 0 , 0}^{CH , acc}$$

percent of the channels are in the resource pool e, wherein

$${P}_{F , 0 , 0}^{CH , acc}$$

may be a pre-defined or configured value, or may be determined according to one or more pre-defined or configured values (e.g.,

$${P}_{F , 0 , 0}^{CH , acc} = 50 ) .$$

Out of all of the channels in the resource pool e, at least

$${N}_{F , 0 , 1}^{CH , acc}$$

channels are in the set

$${CH}_{F}^{SL} ,$$

wherein

$${N}_{F , 0 , 1}^{CH , acc}$$

may be a pre-defined or configured value, or may be determined according to one or more pre-defined or configured values

$$( e . g . , {N}_{F , 0 , 1}^{CH , acc} = 1 ) .$$

Out of all of the channels in the resource pool e, at least

$${P}_{F , 0 , 1}^{CH , acc}$$

percent of the channels are in the set

$${CH}_{F}^{SL} ,$$

wherein

$${P}_{F , 0 , 1}^{CH , acc}$$

may be a pre-defined or configured value, or may be determined according to one or more pre-defined or configured values

$$( e . g . , {P}_{F , 0 , 1}^{CH , acc} = 50 ) .$$

Out of all of the RB sets in the set

$${RS}_{F}^{SL} ,$$

at least

$${N}_{F , 0 , 0}^{RS , acc}$$

RB sets are in the resource pool e, wherein

$${N}_{F , 0 , 0}^{RS , acc}$$

may be a pre-defined or configured value, or may be determined according to one or more pre-defined or configured values

$$( e . g . , {N}_{F , 0 , 0}^{RS , acc} = 1 ) .$$

Out of all of the RB sets in the set

$${RS}_{F}^{SL} ,$$

at least

$${P}_{F , 0 , 0}^{RS , acc}$$

percent of the RB sets are in the resource pool e, wherein

$${P}_{F , 0 , 0}^{RS , acc}$$

may be a pre-defined or configured value, or may be determined according to one or more pre-defined or configured values

$$( e . g . , {P}_{F , 0 , 0}^{RS , acc} = 50 ) .$$

Out of all of the RB sets in the resource pool e, at least

$${N}_{F , 0 , 1}^{RS , acc}$$

RB sets are in the set

$${RS}_{F}^{SL} ,$$

wherein

$${N}_{F , 0 , 1}^{RB , acc}$$

may be a pre-defined or configured value, or ma be determined according to one or more pre-defined or configured values

$$( e . g . , {N}_{F , 0 , 1}^{RB , acc} = 1 ) .$$

Out of all of the RB sets in the resource pool e, at least

$${P}_{F , 0 , 1}^{RS , acc}$$

percent of the RB sets, are in the set

$${RS}_{F}^{SL} ,$$

wherein

$${P}_{F , 0 , 1}^{RS , acc}$$

may be a pre-defined or configured value, or may be determined according to one or more pre-defined or configured values (e.g.,

$${P}_{F , 0 , 1}^{RS , acc} = 50 ) .$$

$${TR}_{ref , 0}^{SL} = \{ {PSCCH}_{0}^{TR} \} .$$

$${TR}_{ref , 0}^{SL} = \{ {PSSCH}_{0}^{TR} \} .$$

$${TR}_{ref , 0}^{SL} = \{ {PSCCH}_{0}^{TR} {\_PSSCH}_{0}^{TR} \} .$$

$${TR}_{ref , 0}^{SL} = \{ {PSFCH}_{0 , 0}^{TR} , {PSFCH}_{0 , 1}^{TR} , … , {PSFCH}_{0 , {N}_{0}^{TR , PSFCH} - 1}^{TR} \} .$$

$${TR}_{ref , 0}^{SL} = \{ {PSCCH}_{0}^{TR} {\_PSSCH}_{0}^{TR} , {PSFCH}_{0 , 0}^{TR} , {PSFCH}_{0 , 1}^{TR} , … , {PSFCH}_{0 , {N}_{0}^{TR , PSFCH} - 1}^{TR} \} .$$

$${TR}_{ref , 0}^{SL} = \{ {PSSCH}_{0}^{TR} , {PSFCH}_{0 , 0}^{TR} , {PSFCH}_{0 , 1}^{TR} , … , {PSFCH}_{0 , {N}_{0}^{TR , PSFCH} - 1}^{TR} \} .$$

$${TR}_{ref , 0}^{SL} = \{ {S\_SSB}_{0}^{TR} \} .$$

The resource pool e is the resource pool where PSCCH/PSSCH corresponding to the

$${PSFCH}_{0 , 0}^{TR} , the {PSFCH}_{0 , 1}^{TR} , … , and the {PSFCH}_{0 , {N}_{0}^{TR , PSFCH} - 1}^{T R}$$

is located.
The resource pool e is a transmission resource pool corresponding to the resource pool

$${e}_{acc} ( e . g . , the {TR}_{ref , 0}^{SL} = \{ {PSFCH}_{0 , 0}^{TR} , {PSFCH}_{0 , 1}^{TR} , … , {PSFCH}_{0 , {N}_{0}^{TR , PSFCH} - 1}^{TR} \} ,$$

and the resource pool e_{acc} is a reception resource pool that triggers the

$${PSFCH}_{0 , 0}^{TR} , the {PSFCH}_{0 , 1}^{TR} , … , and the {PSFCH}_{0 , {N}_{0}^{TR , PSFCH} - 1}^{TR} ,$$

and thus the resource pool e is a transmission resource pool corresponding to the resource pool e_{acc}).

The

$${E}_{F , 1}^{SL}$$

may be defined as a set consisting of all of the resource pools that satisfy type 1F resource pool access failure conditions, wherein for resource pool e, the type 1F resource pool access failure conditions may include one or more (e.g., any of the combinations made by way of “and” or “or”) of the following:
The resource pool e is in the set

$${E}_{A}^{acc} .$$

The resource pool e is a reception resource pool.
Out of all of the channels in the set

$${CH}_{F}^{SL} ,$$

at least

$${N}_{F , 1 , 0}^{CH , acc}$$

channels are in the resource pool e, wherein

$${N}_{F , 1 , 0}^{CH , acc}$$

may be a pre-defined or configured value, or may be determined according to one or more pre-defined or configured values

$$( e . g . , {N}_{F , 1 , 0}^{CH , acc} = 1 ) .$$

Out of all of the channels in the set

$${CH}_{F}^{SL} ,$$

at least

$${P}_{F , 1 , 0}^{CH , acc}$$

percent of the channels are in the resource pool e, wherein

$${P}_{F , 1 , 0}^{CH , acc}$$

may be a pre-defined or configured value, or may be determined according to one or more pre-defined or configured values

$$( e . g . , {P}_{F , 1 , 0}^{CH , acc} = 50 ) .$$

Out of all of the channels in the resource pool e, at least

$${N}_{F , 1 , 1}^{CH , acc}$$

channels are in the set

$${CH}_{F}^{SL} ,$$

wherein

$${N}_{F , 1 , 1}^{CH , acc}$$

may be a pre-defined or configured value, or may be determined according to one or more pre-defined or configured values

$$( e . g . , {N}_{F , 1 , 1}^{CH , acc} = 1 ) .$$

Out of all of the channels in the resource pool e, at least

$${P}_{F , 1 , 1}^{CH , acc}$$

percent of the channels are in the set

$${CH}_{F}^{SL} ,$$

wherein

$${P}_{F , 1 , 1}^{CH , acc}$$

may be a pre-defined or configured value, or may be determined according to one or more pre-defined or configured values

$$( e . g . , {P}_{F , 1 , 1}^{CH , acc} = 50 ) .$$

Out of all of the RB sets in the set

$${RS}_{F}^{SL} ,$$

at least

$${N}_{F , 1 , 0}^{RS , acc}$$

RB sets are in the resource pool e, wherein

$${N}_{F , 1 , 0}^{RS , acc}$$

may be a pre-defined or configured value, or may be determined according to one or more pre-defined or configured values

$$( e . g . , {N}_{F , 1 , 0}^{R S ,} = 1 ) .$$

Out of all of the RB sets in the set

$$R {S}_{F}^{S L} ,$$

at least

$${P}_{F , 1 , 0}^{R S , a c c}$$

percent of the RB sets are in the resource pool e, wherein

$${P}_{F , 1 , 0}^{RS , acc}$$

may be a pre-defined or configured value, or may be determined according to one or more pre-defined or configured values

$$( e . g . , {P}_{F , 1 , 0}^{RS , acc} = 50 ) .$$

Out of all of the RB sets in the resource pool e, at least

$${N}_{F , 1 , 1}^{RS , acc}$$

RB sets are in the set

$$R {S}_{F}^{S L} ,$$

wherein

$${N}_{F , 1 , 1}^{RS , acc}$$

may be a pre-defined or configured value, or may be determined according to one or more pre-defined or configured values

$$( e . g . , {N}_{F , 1 , 1}^{RS , acc} = 1 ) .$$

Out of all of the RB sets in the resource pool e, at least

$${P}_{F , 1 , 1}^{R S ,}$$

percent of the RB sets are in the set

$$R {S}_{F}^{S L} ,$$

wherein

$${P}_{F , 1 , 1 ,}^{RS , acc}$$

may be a pre-defined or configured value, or may be determined according to one or more pre-defined or configured values

$$( e . g . , {P}_{F , 1 , 1}^{RS , acc} = 50 ) .$$

$${TR}_{ref , 0}^{S L} = \{ {PSFCH}_{0 , 0}^{T R} , {PSFCH}_{0 , 1}^{T R} , … , {PSFCH}_{0 , {N}_{0}^{TR , PSFCH} - 1}^{T R} \} .$$

The channel access failure conditions may be related to the set

$$T {R}_{ref , 0}^{S L} .$$

For example, for different values of the set

$$T {R}_{ref , 0}^{S L} ,$$

the channel access failure conditions may be different; as another example, the channel access failure conditions may only be applicable to a specific value of the set

$$T {R}_{ref , 0}^{S L} .$$

The channel access failure conditions may include one or more (e.g., any of the combinations made by way of “and” or “or”) of the following:
Type 1A channel access failure conditions.
Type 1B channel access failure conditions.
Type 1C channel access failure conditions.
Type 1D channel access failure conditions.
Type 1E channel access failure conditions.
Type 1F channel access failure conditions.

The type 1A channel access failure conditions may include one or more (e.g., any of the combinations made by way of “and” or “or”) of the following:

$${N}_{F}^{CH , SL} \geq 1.$$

$${N}_{F}^{CH , SL} > 1.$$

$${N}_{F}^{RS , SL} \geq 1.$$

$${N}_{F}^{RS , SL} > 1.$$

$${N}_{F}^{E , SL} \geq 1.$$

$${N}_{F}^{E , SL} > 1.$$

$${N}_{p r m}^{TR , SL} = 0.$$

$${N}_{acc , F}^{CH , SL} \geq {N}_{acc , F , th}^{CH , SL} .$$

$${N}_{acc , F}^{CH , SL} > {N}_{acc , F , t h}^{CH , SL} .$$

$${N}_{acc , F , i n c}^{CH , SL} \geq {N}_{acc , F , inc , th}^{CH , SL} .$$

$${N}_{acc , F}^{CH , SL} > {N}_{acc , F , inc , th}^{CH , SL} .$$

$${N}_{acc , F}^{RS , SL} \geq {N}_{acc , F , th}^{RS , SL} .$$

$${N}_{acc , F}^{RS , SL} > {N}_{acc , F , t h}^{RS , SL} .$$

$${N}_{acc , F , i n c}^{RS , SL} \geq {N}_{acc , F , inc , th}^{RS , SL} .$$

$${N}_{acc , F , inc}^{RS , SL} > {N}_{acc , F , inc , th}^{RS , SL} .$$

$${N}_{p r m}^{TR , SL} \leq {N}_{prm , F , th}^{TR , SL} .$$

$${N}_{p r m}^{TR , SL} < {N}_{prm , F , th}^{TR , SL} .$$

The type 1A channel access failure conditions may be related to the set

$$T {R}_{ref , 0}^{S L} .$$

For example, for different values of the set

$$T {R}_{ref , 0}^{S L} ,$$

the type 1A channel access failure conditions may be different; as another example, the type 1A channel access failure conditions may only be applicable to a specific value of the set

$$T {R}_{ref , 0}^{S L} .$$

Specifically for example, if

$${TR}_{ref , 0}^{SL} = \{ {PSCCH}_{0}^{TR} {\_PSSCH}_{0}^{T R} \} ( or , {TR}_{r e f , 0}^{S L} = \{ {PSSCH}_{0}^{T R} \} ) ,$$

then the type 1A channel access failure conditions do not comprise

$${N}_{prm}^{TR , SL} = 0 ( or , {N}_{prm}^{TR , SL} \leq {N}_{prm , F , th}^{TR , SL} ) ;$$

as another example, if

$${TR}_{ref , 0}^{SL} = \{ {PSFCH}_{0 , 0}^{T R} , {PSFCH}_{0 , 1}^{TR} , … , {PSFCH}_{0 , {N}_{0}^{TR , PSFCH} - 1}^{TR} \} ,$$

then the type 1A channel access failure conditions comprise

$${N}_{p r m}^{TR , SL} = 0 ( or , {N}_{p r m}^{TR , SL} \leq {N}_{prm , F , th}^{TR , SL} ) .$$

The type 1B channel access failure conditions may include one or more (e.g., any of the combinations made by way of “and” or “or”) of the following:

$$T {R}_{ref , 0}^{SL} = \{ {PSCCH}_{0}^{T R} \} .$$

$${TR}_{ref , 0}^{S L} = \{ {PSSCH}_{0}^{T R} \} .$$

$${TR}_{ref , 0}^{S L} = \{ {PSCCH}_{0}^{T R} {\_PSSCH}_{0}^{T R} \} .$$

$${TR}_{ref , 0}^{S L} = \{ {PSFCH}_{0 , 0}^{T R} , {PSFCH}_{0 , 1}^{T R} , … , {PSFCH}_{0 , {N}_{0}^{TR , PSFCH} - 1}^{T R} \} .$$

$${TR}_{ref , 0}^{S L} = \{ {PSCCH}_{0}^{T R} {\_PSSCH}_{0}^{T R} , {PSFCH}_{0 , 0}^{T R} , {PSFCH}_{0 , 1}^{TR} , … , {PSFCH}_{0 , {N}_{0}^{TR , PSFCH} - 1}^{TR} \} .$$

$${TR}_{ref , 0}^{S L} = \{ P S S C {H}_{0}^{T R} , PSFC {H}_{0 , 0}^{T R} , {PSFCH}_{0 , 1}^{TR} , … , {PSFCH}_{0 , {N}_{0}^{TR , PSFCH} - 1}^{TR} \} .$$

$${TR}_{ref , 0}^{S L} = \{ {S\_SSB}_{0}^{T R} \} .$$

The type 1B channel access failure conditions may be related to the set

$${TR}_{ref , 0}^{S L} .$$

For example, for different values of the set

$${TR}_{ref , 0}^{S L} ,$$

the type 1B channel access failure conditions may be different; as another example, the type 1B channel access failure conditions may only be applicable to a specific value of the set

$${TR}_{ref , 0}^{S L} .$$

The type 1C channel access failure conditions may include one or more (e.g., any of the combinations made by way of “and” or “or”) of the following:
The channel access result is “failure”.
The corresponding result of each channel in the set

$${CH}_{a c c}^{S L}$$

is “failure”.
The corresponding result of each channel that is in the set

$$C {H}_{a c c}^{S L}$$

and belongs to the set

$$C {H}_{ref , 0}^{S L}$$

is “failure”.
The corresponding result of at least one channel in the set

$$C {H}_{a c c}^{S L}$$

is “failure”.
The corresponding result of at least one channel that is in the set

$$C {H}_{a c c}^{S L}$$

and belongs to the set

$$C {H}_{ref , 0}^{S L}$$

is “failure”.
The corresponding result of the respective channel corresponding to each RB set in the set

$$R {S}_{a c c}^{S L}$$

is “failure”.
The corresponding result of the respective channel corresponding to each RB set that is in the set

$$R {S}_{a c c}^{S L}$$

and belongs to the set

$$R {S}_{ref , 0}^{S L}$$

is “failure”.
The corresponding result of the respective channel corresponding to at least one RB set in the set

$$R {S}_{a c c}^{S L}$$

is “failure”.
The corresponding result of the respective channel corresponding to at least one RB set that is in the set

$$R {S}_{a c c}^{S L}$$

and belongs to the set

$$R {S}_{ref , 0}^{SL}$$

is “failure”.

The type 1C channel access failure conditions may be related to the set

$${TR}_{ref , 0}^{S L} .$$

For example, for different values of the set

$$T {R}_{ref , 0}^{S L} ,$$

the type 1C channel access failure conditions may be different; as another example, the type 1C channel access failure conditions may only be applicable to a specific value of the set

$$T {R}_{ref , 0}^{S L} .$$

The type 1D channel access failure conditions may include one or more (e.g., any of the combinations made by way of “and” or “or”) of the following:
The resources corresponding to all of the sidelink transmissions in the set

$$T {R}_{ref , 0}^{SL}$$

are all in the resource pool e_{acc}.
The resource pool e_{acc} is in the set

$${E}_{A}^{A C C} .$$

The resource pool e_{acc} is a transmission resource pool.
The resource pool e_{acc} is not a reception resource pool.
The resource pool e_{acc} is not a transmission resource pool used for sidelink communication and/or sidelink discovery under exception conditions. For example, the resource pool e_{acc} is a resource pool configured by the parameter sl-TxPoolScheduling (or the parameter sl-DiscTxPoolScheduling, or the parameter sl-TxPoolSelectedNormal, or the parameter sl-DiscTxPoolSelected); as another example, the resource pool e_{acc} is not a resource pool configured by the parameter sl-TxPoolExceptional.

The type 1D channel access failure conditions may be related to the set

$${TR}_{ref , 0}^{SL} .$$

For example, for different values of the set

$${TR}_{ref , 0}^{SL} ,$$

the type 1D channel access failure conditions may be different; as another example, the type 1D channel access failure conditions may only be applicable to a specific value of the set

$${TR}_{ref , 0}^{SL} .$$

The type 1E channel access failure conditions may include one or more (e.g., any of the combinations made by way of “and” or “or”) of the following:
The resources corresponding to all of the sidelink transmissions in the set

$${TR}_{ref , 0}^{SL}$$

are all in the resource pool e_{acc}.
The resource pool e_{acc} is in the set

$${E}_{A}^{A C C} .$$

The resource pool e_{acc} is a reception resource pool.
The resource pool e_{acc} is not a transmission resource pool.

The type 1E channel access failure conditions may be related to the set

$${TR}_{ref , 0}^{SL} .$$

For example, for different values of the set

$${TR}_{ref , 0}^{SL} ,$$

the type 1E channel access failure conditions may be different; as another example, the type 1E channel access failure conditions may only be applicable to a specific value of the set

$${TR}_{ref , 0}^{SL} .$$

The type 1F channel access failure conditions may include one or more (e.g., any of the combinations made by way of “and” or “or”) of the following:
None of the resources corresponding to all of the sidelink transmissions in the set

$${TR}_{ref , 0}^{SL}$$

is in the resource pool.

$${TR}_{ref , 0}^{SL} = \{ {S\_SSB}_{0}^{T R} \} .$$

The

$${N}_{F}^{IND , SL}$$

may be related to the set

$$C {H}_{F}^{S L}$$

and/or the set

$$R {S}_{F}^{S L}$$

and/or the set

$${E}_{F}^{S L} .$$

For example, the

$${N}_{F}^{IND , SL}$$

may be determined according to one of the following:

$${N}_{F}^{IND , SL}$$

is a pre-defined or configured value

$$( e . g . , {N}_{F}^{IND , SL} = 1 ) .$$

$${N}_{F}^{IND , SL}$$

is equal to the number of elements in the set

$$C {H}_{F}^{S L} ,$$

that is,

$${N}_{F}^{IND , SL} = {N}_{F}^{CH , SL}$$

e.g., an indication of channel access failure can be triggered for each channel in the set

$$C {H}_{F}^{S L}$$

respectively).

$${N}_{F}^{IND , SL}$$

is equal to the number of elements in the set

$$R {S}_{F}^{S L} ,$$

that is,

$${N}_{F}^{IND , SL} = {N}_{F}^{RS , SL}$$

(e.g., an indication of channel access failure can be triggered for each RB set in the set

$$R {S}_{F}^{S L}$$

respectively).

$${N}_{F}^{IND , SL}$$

is equal to the number of elements in the set

$${E}_{F}^{S L} ,$$

that is,

$${N}_{F}^{IND , SL} = {N}_{F}^{E , SL}$$

(e.g., an indication of channel access failure can be triggered for each resource pool in the set

$${E}_{F}^{S L}$$

respectively).

The type 1F channel access failure conditions may be related to the set

$$T {R}_{ref , 0}^{S L} .$$

For example, for different values of the set

$$T {R}_{ref , 0}^{S L} ,$$

the type channel access failure conditions may be different; as another example, the type 1F channel access failure conditions may only be applicable to a specific value of the set

$$T {R}_{ref , 0}^{S L} .$$

Each indication of channel access failure may carry zero, one, or more parameters. For example, the parameter(s) carried in each indication of channel access failure may include one or more of the following:
The set

$$C {H}_{F}^{S L} .$$

Channel access type used respectively for each channel in the set

$$C {H}_{F}^{S L}$$

(e.g., type 1 channel access; or, type 2 channel access).
The set

$$R {S}_{F}^{S L} .$$

Channel access type used respectively for the respective channel corresponding to each RB sets in the set

$$R {S}_{F}^{S L}$$

(e.g., type 1 channel access; or, type 2 channel access).
The set

$${E}_{F}^{S L} .$$

The type of resource pool corresponding to each resource pool in the set

$${E}_{F}^{S L}$$

(e.g., a transmission resource pool; or, a reception resource pool).
The set

$$T {R}_{ref , 0}^{S L} .$$

The type of physical channel corresponding to each sidelink transmission in the set

$$T {R}_{ref , 0}^{S L}$$

### (e.g., S-SSB; or, PSCCH/PSSCH; or, PSFCH).

The channel for which the indication of channel access failure is triggered, and/or the corresponding type of channel access (for example, when an indication of channel access failure is triggered respectively for each channel in the set

$$C {H}_{F}^{S L} ,$$

each indication of channel access failure carries the index of the channel for which the indication of channel access failure is triggered and/or the corresponding type of channel access).
The RB set for which the indication of channel access failure is triggered, and/or the type of channel access of the corresponding channel (for example, when an indication of channel access failure is triggered respectively for each RB set in the set

$$R {S}_{F}^{S L} ,$$

each indication of channel access failure carries the index of the RB set for which the indication of channel access failure is triggered and/or the type of channel access of the corresponding channel).
The resource pool for which the indication of channel access failure is triggered, and/or the corresponding type of resource pool (for example, when an indication of channel access failure is triggered respectively for each resource pool in the set

$${E}_{F}^{S L} ,$$

each indication of channel access failure carries the index of the resource pool for which the indication of channel access failure is triggered).
The slot

$${t}_{0}^{S L} .$$

The set of slots

$${T}_{S L} = \{ {t}_{0}^{S L} , {t}_{1}^{S L} , … , {t}_{{N}_{S L}^{T} - 1}^{S L} \} .$$

Embodiment 2 of the present invention may be performed by a physical layer entity of the UE.

Embodiment 2 of the present invention may be performed when the UE decides to use type 1 channel access.

Embodiment 2 of the present invention may be performed when the UE decides to use type 2 channel access.

Embodiment 2 of the present invention may be performed when the UE decides to initiate a COT.

Embodiment 2 of the present invention may be performed when the UE decides to use a shared COT.

In Embodiment 2 of the present invention, the “intra-cell guard band” may refer to an intra-cell guard band having a size that is not equal to zero.

In Embodiment 2 of the present invention, the “an intra-cell guard band has been configured” may refer to an intra-cell guard band having been configured in the bandwidth part b.

In Embodiment 2 of the present invention, the “an intra-cell guard band has been configured” may refer to an intra-cell guard band having been configured in the carrier c.

In Embodiment 2 of the present invention, the “an intra-cell guard band has not been configured” may refer to an intra-cell guard band not having been configured in the bandwidth part b.

In Embodiment 2 of the present invention, the “an intra-cell guard band has not been configured” may refer to an intra-cell guard band not having been configured in the carrier c.

In Embodiment 2 of the present invention, the “CAPC determined for the

$${PSFCH}_{0 , 0}^{TR} , the {PSFCH}_{0 , 1}^{TR} , … , and the {PSFCH}_{0 , {N}_{0}^{TR , PSFCH} - 1}^{TR} ”$$

may be a pre-defined or configured integer (e.g., 1; or, 2; or, 3; or, 4), or determined by the UE autonomously, or determined by other means.

In Embodiment 2 of the present invention, the “CAPC determined for the

$${PSFCH}_{0 , 0}^{TR} , the {PSFCH}_{0 , 1}^{TR} , … , and the {PSFCH}_{0 , {N}_{0}^{TR , PSFCH} - 1}^{TR} ”$$

may be a function of

$${N}_{0}^{TR , PSFCH}$$

CAPC values determined by the

$${PSFCH}_{0 , 0}^{TR} , the {PSFCH}_{0 , 1}^{TR} , … , and the {PSFCH}_{0 , {N}_{0}^{TR , PSFCH} - 1}^{TR} ,$$

respectively (e.g., denoted as

$${capc}_{0 , 0}^{PSFCH} , {capc}_{0 , 1}^{PSFCH} , … , {capc}_{0 , {N}_{0}^{TR , PSFCH} - 1}^{PSFCH} ,$$

respectively), e.g., min

$$( {capc}_{0 , 0}^{PSFCH} , {capc}_{0 , 1}^{PSFCH} , {capc}_{0 , {N}_{0}^{TR , PSFCH} - 1}^{PSFCH} ) ;$$

as another example, max

$$( {capc}_{0 , 0}^{PSFCH} , {capc}_{0 , 1}^{PSFCH} , {capc}_{0 , {N}_{0}^{TR , PSFCH} - 1}^{PSFCH} ) .$$

### For k

$$∈ \{ 0 , 1 , … , {N}_{0}^{TR , PSFCH} - 1 \} , {capc}_{0 , k}^{PSFCH}$$

may be determined by the CAPC corresponding to the PSCCH/PSSCH transmission that triggers the

$${PSFCH}_{0 , k}^{TR} ,$$

or is a pre-defined or configured integer (e.g., 1; or, 2; or, 3; or, 4), or determined by the UE autonomously, or determined by other means.

Embodiment 2 of the present invention may be applicable to an operation with shared spectrum channel access.

Therefore, according to what has been described for Embodiment 2, the present invention provides a method whereby, in the event of partial or complete failure of channel access, whether there is a need to indicate LBT failure, the content of the indication of LBT failure, etc. are determined according to the type of channel access, the result of channel access, the configuration of intra-cell guard band, the type of the corresponding sidelink transmission, etc., so as to improve flexibility in error processing in an operation with shared spectrum channel access.

### Embodiment 3

A method performed by a UE according to Embodiment 3 of the present invention will be described below with reference to FIG. 3.

FIG. 3 illustrates a flowchart corresponding to the method performed by the UE according to Embodiment 3 of the present invention.

As illustrated in FIG. 3, in Embodiment 3 of the present invention, the steps performed by the UE include: step S301 and step S303.

Specifically, in step S301, information (e.g., configuration information, and/or control information, and/or indication information) related to a sidelink is acquired and/or determined. The information may be denoted as

$${inf}_{0}^{SL} .$$

Part or all of the

$${inf}_{0}^{SL}$$

may be indicated by DCI (e.g., denoted as

$${DCI}_{0}^{SL} ) ,$$

wherein the

$${DCI}_{0}^{SL}$$

may be carried by a PDCCH (physical downlink control channel), and the PDCCH may be transmitted by a base station to the UE. DCI refers to downlink control information.

Part or all of the

$${inf}_{0}^{SL}$$

may be configured and/or indicated in a higher layer protocol (e.g., configured and/or indicated at a PC5-RRC layer; as another example, configured and/or indicated at an RRC layer; as another example, configured and/or indicated at an MAC layer), and the corresponding configuration and/or indication information may be from one or more higher layer entities of the UE, and/or from the PC5-RRC signaling received by the UE and transmitted by another UE and/or the RRC signaling and/or MAC signaling transmitted by the base station to the UE.

Part or all of the

$${inf}_{0}^{SL}$$

may be related to a sidelink grant (e.g., denoted as

$${grant}_{0}^{S L} )$$

For example, part or all of the

$${inf}_{0}^{S L}$$

may correspond to part or all of the parameters of the

$${grant}_{0}^{S L}$$

and/or one or more operations related to the

$${grant}_{0}^{S L} .$$

The

$${grant}_{0}^{S L}$$

may be one of the following:
The

$${grant}_{0}^{S L}$$

is a sidelink dynamic grant dynamically provided by the

$${DCI}_{0}^{S L} .$$

The

$${grant}_{0}^{S L}$$

may be one of the one or more type 2 sidelink configured grants configured for the UE (e.g., configured at the RRC layer); parameters such as period of the

$${grant}_{0}^{S L}$$

may be configured at the RRC layer; the

$${DCI}_{0}^{S L}$$

may be used to activate (or, deactivate; or, release) the

$${grant}_{0}^{S L} ;$$

the “configuration index” corresponding to the

$${grant}_{0}^{S L}$$

may be indicated in the

$${DCI}_{0}^{S L} .$$

The

$${grant}_{0}^{S L}$$

is a type 1 sidelink configured grant; parameters such as period, time resource, and frequency resource of the

$${grant}_{0}^{S L}$$

may be configured at the RRC layer.

The

$${DCI}_{0}^{SL}$$

may correspond to a DCI format for sidelink scheduling, e.g., DCI format 3_0.

The CRC (cyclic redundancy check) of the

$${DCI}_{0}^{SL}$$

may be scrambled by using an RNTI (radio network temporary identifier), e.g., an SL-RNTI (sidelink RNTI), or an SLCS-RNTI (also referred to as an “SL-CS-RNTI”, sidelink configured scheduling RNTI). Specifically, for example, if the CRC of the

$${DCI}_{0}^{SL}$$

is scrambled by using the SL-RNTI, then the

$${grant}_{0}^{SL}$$

is a sidelink dynamic grant provided by the

$${DCI}_{0}^{SL} ;$$

as another example, if the CRC of the

$${DCI}_{0}^{SL}$$

is scrambled by using the SLCS-RNTI, then the

$${grant}_{0}^{SL}$$

is a type 2 sidelink configured grant indicated by the “configuration index” field in the

$${DCI}_{0}^{SL} ;$$

as another example, if the CRC of the

$${DCI}_{0}^{SL}$$

is scrambled by using the SLCS-RNTI, and the value of the NDI (New Data Indicator) field of the

$${DCI}_{0}^{SL}$$

is 1, then the

$${grant}_{0}^{SL}$$

is a sidelink dynamic grant provided by the

$${DCI}_{0}^{SL} ;$$

as another example, if the CRC of the

$${DCI}_{0}^{SL}$$

is scrambled by using the SLCS-RNTI, and the value of the NDI field of the

$${DCI}_{0}^{SL}$$

is 0 then the

$${grant}_{0}^{SL}$$

is a type 2 sidelink configured grant indicated by the “configuration index” field in the

$${DCI}_{0}^{SL} .$$

The

$${inf}_{0}^{SL}$$

may comprise configuration and/or indication information about a resource pool (e.g., denoted as

$${e}_{0}^{SL , inf} )$$

in the bandwidth part b of the carrier c, wherein the resource pool

$${e}_{0}^{SL , inf}$$

may be identified by a resource pool index comprised in the

$${inf}_{0}^{SL} .$$

The resource pool

$${e}_{0}^{SL , inf}$$

may be a transmission resource pool.

The

$${inf}_{0}^{SL}$$

may comprise configuration and/or indication information about the bandwidth part b, wherein the bandwidth part b may be identified by a bandwidth part index.

The

$${inf}_{0}^{SL}$$

may comprise configuration and/or indication information about the carrier c, wherein the carrier c may be identified by a carrier index.

The

$${inf}_{0}^{SL}$$

may comprise configuration and/or indication information about a set of resource pools

$${E}_{cnc , 0}^{SL , inf} ,$$

wherein each resource pool in the set

$${E}_{cnc , 0}^{SL , inf}$$

may be identified by a resource pool index.

The

$${grant}_{0}^{SL}$$

may correspond to one or more resources in the resource pool

$${e}_{0}^{SL , inf} ,$$

wherein each of the resources may be used for a PSCCH/PSSCH transmission (or a PSCCH transmission, or a PSSCH transmission), and the corresponding set of sidelink transmissions may be denoted as

$${TR}_{g 0}^{SL} = \{ t {r}_{0}^{SL , g 0} , t {r}_{1}^{SL , g 0} , … , t {r}_{{N}_{g 0}^{SL , TR} - 1}^{{SL}_{,} g 0} \} ,$$

wherein

$${N}_{g 0}^{SL , TR}$$

may be an integer greater than or equal to 1. The resources corresponding to some or all of the sidelink transmissions in the set

$$T {R}_{g 0}^{S L}$$

may be indicated in the

$${DCI}_{0}^{S L} ,$$

or determined according to the higher layer configuration and/or indication information. Some or all of the sidelink transmissions in the set

$$T {R}_{g 0}^{S L}$$

may be intended sidelink transmissions.

The

$$i n {f}_{0}^{S L}$$

may comprise indication information about “cancellation of consistent LBT failure”. For example, if the value of a “cancellation of persistent LBT failure” field in the

$$i n {f}_{0}^{S L}$$

is 1, this means that the

$$i n {f}_{0}^{S L}$$

indicates “cancellation of consistent LBT failure”; as another example, if the

$$i n {f}_{0}^{S L}$$

does not comprise the “cancellation of consistent LBT failure” field (or, if the value of the “cancellation of persistent LBT failure” field is 0), this means that the

$$i n {f}_{0}^{S L}$$

does not indicate “cancellation of consistent LBT failure”. The “cancellation of consistent LBT failure” may be applicable to a resource pool (e.g., the resource pool

$${e}_{0}^{SL , inf} ,$$

or a resource pool indicated in the

$$i n {f}_{0}^{S L} ) ,$$

or applicable to a bandwidth part (e.g., the bandwidth part b, or a bandwidth part indicated in the

$$i n {f}_{0}^{S L} ) ,$$

or applicable to a carrier (e.g., the carrier c, or a carrier indicated in the

$$i n {f}_{0}^{S L} ) .$$

Further, in step S303, one or more operations related to sidelink are performed.

For example, the “one or more operations related to sidelink” may include one or more of the following:
If type 1 sidelink information conditions are met, then perform one or more type 1 sidelink information operations.
Perform one or more type 1 sidelink information operations.
For sidelink transmission

$$t {r}_{i}^{SL , g 0} ( i ∈ \{ 0 , 1 , … , {N}_{g 0}^{S L , T R} - 1 \} ) ,$$

if type 2 sidelink information conditions are met, then perform one or more type 2 sidelink information operations.
For sidelink transmission

$$t {r}_{i}^{SL , g 0} ( i ∈ \{ 0 , 1 , … , {N}_{g 0}^{S L , T R} - 1 \} ) ,$$

perform one or more type 2 sidelink information operations.

The type 1 sidelink information conditions may be related to the content of the

$$i n {f}_{0}^{S L} .$$

For example, in the two cases of “the

$${inf}_{0}^{SL}$$

comprises information related to the

$${grant}_{0}^{SL} ”$$

and “the

$${inf}_{0}^{SL}$$

comprise information related to the

$${grant}_{0}^{SL} ” ,$$

the type 1 sidelink information conditions may be different. As another example, in the two cases of “the

$${inf}_{0}^{SL}$$

comprises information indicated by the

$${DCI}_{0}^{SL} ”$$

and “the

$${inf}_{0}^{SL}$$

does not comprise information indicated by the

$${DCI}_{0}^{SL} ” ,$$

the type 1 sidelink information conditions may be different.

The type 1 sidelink information conditions may be related to the type of the

$${grant}_{0}^{SL} .$$

For example, in the two cases of “the

$${grant}_{0}^{SL}$$

is a sidelink dynamic grant” and “the

$${grant}_{0}^{SL}$$

is a type 1 sidelink configured grant”, the type 1 sidelink information conditions may be different; as another example, in the two cases of “the

$${grant}_{0}^{SL}$$

is a sidelink dynamic grant” and “the

$${grant}_{0}^{SL}$$

is a type 2 sidelink configured grant”, the type 1 sidelink information conditions may be different; as another example, in the two cases of “the

$${grant}_{0}^{SL}$$

is a type 1 sidelink configured grant” and “the

$${grant}_{0}^{SL}$$

is a type 2 sidelink configured grant”, the type 1 sidelink information conditions may be different.

The type 1 sidelink information conditions may include one or more (e.g., any of the combinations made by way of “and” or “or”) of the following:
Type 1A sidelink information conditions.
Type 1B sidelink information conditions.
Type 1C sidelink information conditions.
Type 1D sidelink information conditions.
Type 1E sidelink information conditions.
Type 1F sidelink information conditions.
Type 1G sidelink information conditions.

The type 1A sidelink information conditions may include one or more (e.g., any of the combinations made by way of “and” or “or”) of the following:
The UE is using sidelink resource allocation mode 1.
Part or all of the in

$${inf}_{0}^{S L}$$

are provided by the

$${DCI}_{0}^{S L} .$$

Part or all of the

$${inf}_{0}^{S L}$$

are configured and/or indicated in a higher layer protocol.

The type 1B sidelink information conditions may include one or more (e.g., any of the combinations made by way of “and” or “or”) of the following:
The DCI format corresponding to the

$${DCI}_{0}^{S L}$$

is a DCI format (e.g., DCI format 3_0) for scheduling PSCCH and/or PSSCH.
The

$${DCI}_{0}^{S L}$$

is used to schedule one or more PSCCH and/or PSSCH transmissions in the resource pool

$${e}_{0}^{SL , inf} .$$

The

$${DCI}_{0}^{S L}$$

is used to provide a sidelink dynamic grant (correspondingly, the

$${grant}_{0}^{S L}$$

is a sidelink dynamic grant).
The

$${DCI}_{0}^{S L}$$

is used to activate a type 2 sidelink configured grant (correspondingly, the

$${grant}_{0}^{S L}$$

is a type 2 sidelink configured grant).
The

$${DCI}_{0}^{S L}$$

is used to deactivate (or, release) a type 2 sidelink configured grant (accordingly, the

$${grant}_{0}^{S L}$$

is a type 2 sidelink configured grant).

The type 1C sidelink information conditions may include: the

$${grant}_{0}^{S L}$$

is a type 1 sidelink configured grant.

The type 1D sidelink information conditions may include: “cancellation of consistent LBT failure” is indicated in the

$${inf}_{0}^{S L} .$$

The type 1E sidelink information conditions may include one or more (e.g., any of the combinations made by way of “and” or “or”) of the following:
The resource pool

$${e}_{0}^{SL , inf}$$

is a resource pool associated with a consistent LBT failure (for example, a consistent LBT failure is triggered for the resource pool

$${e}_{0}^{SL , inf}$$

according to the method in Embodiment 1 of the present invention).
The reception resource pool (e.g., denoted as

$${e}_{0}^{SL , inf , RX} )$$

corresponding to the resource pool

$${e}_{0}^{SL , inf}$$

is a resource pool associated with a consistent LBT failure (for example, a consistent LBT failure is triggered for the resource pool

$${e}_{0}^{SL , inf , RX}$$

according to the method in Embodiment 1 of the present invention).

The type 1F sidelink information conditions may include one or more (e.g., any of the combinations made by way of “and” or “or”) of the following:
When the

$${DCI}_{0}^{S L}$$

is received (or applied), the consistent LBT failure associated with the resource pool

$${e}_{0}^{SL , inf}$$

has not been canceled.
After reception (or application) of the

$${DCI}_{0}^{S L}$$

and a pre-defined or configured period of time, the consistent LBT failure associated with the resource pool

$${e}_{0}^{SL , inf}$$

has not been canceled.
When the

$${DCI}_{0}^{S L}$$

is received (or applied), the consistent LBT failure associated with the resource pool

$${e}_{0}^{SL , inf , RX}$$

not been canceled.
After reception (or application) of the

$${DCI}_{0}^{S L}$$

and a pre-defined or configured period of time, the consistent LBT failure associated with the resource pool

$${e}_{0}^{SL , inf , RX}$$

has not been canceled.

The type 1G sidelink information conditions may include one or more (e.g., any of the combinations made by way of “and” or “or”) of the following:
When the configuration and/or indication information of the higher layer protocol is received (or applied), the consistent LBT failure associated with the resource pool

$${e}_{0}^{SL , inf}$$

has not been canceled.
After reception (or application) of the configuration and/or indication information of the higher layer protocol and a pre-defined or configured period of time, the consistent LBT failure associated with the resource pool

$${e}_{0}^{SL , inf}$$

has not been canceled.
When the configuration and/or indication information of the higher layer protocol is received (or applied), the consistent LBT failure associated with the resource pool

$${e}_{0}^{SL , inf , RX}$$

as not been canceled.
After reception (or application) of the configuration and/or indication information of the higher layer protocol and a pre-defined or configured period of time, the consistent LBT failure associated with the resource pool

$${e}_{0}^{SL , inf , RX}$$

has not been canceled.

The type 1 sidelink information operations may be related to the content of the

$${inf}_{0}^{S L} .$$

For example, in the two cases of “the

$${inf}_{0}^{S L}$$

comprises information related to the

$${grant}_{0}^{S L} ”$$

and “the

$${inf}_{0}^{S L}$$

does not comprise information related to the

$${grant}_{0}^{S L} ” ,$$

the type 1 sidelink information operations may be different. As another example, in the two cases of “the

$${inf}_{0}^{S L}$$

comprises information indicated by the

$${DCI}_{0}^{S L} ”$$

and “the

$${inf}_{0}^{S L}$$

does not comprise information indicated by the

$${DCI}_{0}^{S L} ” ,$$

the type 1 sidelink information operations may be different.

The type 1 sidelink information operations ma be related to the type of the

$${grant}_{0}^{S L} .$$

For example, in the two cases of “the

$${grant}_{0}^{S L}$$

is a sidelink dynamic grant” and “the

$${grant}_{0}^{S L}$$

is a type 1 sidelink configured grant”, the type 1 sidelink information operations may be different; as another example, in the two cases of “the

$${grant}_{0}^{S L}$$

is a sidelink dynamic grant” and “the

$${grant}_{0}^{S L}$$

is a type 2 sidelink configured grant”, the type 1 sidelink information operations may be different; as another example, in the two cases of “the

$${grant}_{0}^{S L}$$

is a type 1 sidelink configured grant” and “the

$${grant}_{0}^{S L}$$

is a type 2 sidelink configured grant”, the type 1 sidelink information operations may be different.

The type 1 sidelink information operations may include one or more of the following (performed according to the order of their occurrences, or according to any other order):
type 1A sidelink information operations.
type 1B sidelink information operations.
type 1C sidelink information operations.

The type 1A sidelink information operations may include one or more of the following (performed according to the order of their occurrences, or according to any other order):
Ignore the

$${DCI}_{0}^{S L} .$$

For example, do not perform any sidelink transmission scheduled by the

$${DCI}_{0}^{S L} ;$$

as another example, do not perform the operation of activating (or deactivating, or releasing) the

$${grant}_{0}^{S L}$$

indicated by the

$${DCI}_{0}^{S L} .$$

Perform (one or more) operations indicated by the

$${DCI}_{0}^{S L} .$$

For example, according to indication of the

$${DCI}_{0}^{S L} ,$$

cancel the consistent LBT failure associated with the resource pool

$${e}_{0}^{SL , inf} ;$$

as another example, according to indication of the

$${DCI}_{0}^{S L} ,$$

cancel the consistent LBT failure (if any) associated with the resource pool

$${e}_{0}^{SL , inf} ;$$

as another example, according to indication of the

$${DCI}_{0}^{S L} ,$$

cancel the consistent LBT failure associated with all of the resource pools in the set

$${E}_{cnc , 0}^{SL , inf} ;$$

as another example, according to indication of the

$${DCI}_{0}^{S L} ,$$

cancel e consistent LBT failure (if any) associated with all of the resource pools in the set

$${E}_{cnc , 0}^{SL , inf} ;$$

as another example, according to indication of the

$${DCI}_{0}^{SL} ,$$

Cancel all of the consistent LBT failures in the bandwidth part b; as another example, according to indication of the

$${DCI}_{0}^{SL} ,$$

cancel all of the consistent LBT failures any) in the bandwidth part b; as another example, according to indication of the

$${DCI}_{0}^{SL} ,$$

cancel all of the consistent LBT failures in the carrier c; as another example, according to indication of the

$${DCI}_{0}^{SL} ,$$

cancel all of the consistent LBT failures (if any) in the carrier c.

The type 1B sidelink information operations may include one or more of the following (performed according to the order of their occurrences, or according to any other order):
Ignore the

$${grant}_{0}^{SL} .$$

Ignore one or more (e.g., all) of the sidelink transmissions in the set

$${TR}_{g 0}^{SL} .$$

The type 1C sidelink information operations may be performed according to the configuration and/or indication of the configuration and/or indication information of the higher layer protocol.

The type 1C sidelink information operations may include one or more of the following (performed according to the order of their occurrences, or according to any other order):
Cancel the consistent LBT failure associated with the resource pool

$${e}_{0}^{SL , inf} .$$

Cancel the consistent LBT failure (if any) associated with the resource pool

$${e}_{0}^{SL , inf} .$$

Cancel the consistent LBT failure associated with the resource pool

$${e}_{0}^{SL , inf , RX} .$$

Cancel the consistent LBT failure (if any) associated with the resource pool

$${e}_{0}^{SL , inf , RX} .$$

Cancel the consistent LBT failure associated with all of the resource pools in the set

$${E}_{cnc , 0}^{SL , inf} .$$

Cancel the consistent LBT failure (if any) associated with all of the resource pools in the set

$${E}_{cnc , 0}^{SL , inf} .$$

Cancel all of the consistent LBT failures in the bandwidth part b.
Cancel all of the consistent LBT failures (if any) in the bandwidth part b.
Cancel all of the consistent LBT failures in the carrier c.
Cancel all of the consistent LBT failures (if any) in the carrier c.

The type 2 sidelink information conditions may include one or more (e.g., any of the combinations made by way of “and” or “or”) of the following:

Type 1A sidelink information conditions.
Type 1B sidelink information conditions.
Type 1C sidelink information conditions.
Type 1D sidelink information conditions.
Type 1E sidelink information conditions.
Type 2A sidelink information conditions.

The type 2A sidelink information conditions may include one or more (e.g., any of the combinations made b way of “and” or “or”) of the following:
When the

$${DCI}_{0}^{SL}$$

is received, the consistent LBT failure associated with the resource pool

$${e}_{0}^{SL , inf}$$

has not been canceled.
Upon reception of the configuration and/or indication information of the higher layer protocol, the consistent LBT failure associated with the resource pool

$${e}_{0}^{SL , inf}$$

has not been canceled.
When the time which is earlier than the start time of the

$$t {r}_{i}^{SL , g 0}$$

by a pre-defined or configured period of time arrives, the consistent LBT failure associated with the resource pool

$${e}_{0}^{SL , inf}$$

has not been canceled.
When a time which is earlier than the start time of slot in which the

$${tr}_{i}^{SL , g 0}$$

is by a pre-defined or configured period of time arrives, the consistent LBT failure associated with the resource pool

$${e}_{0}^{SL , inf}$$

has not been canceled.

The type 2 sidelink information operations may include: Ignore (or, discard) the

$$t {r}_{i}^{S L , g 0} .$$

Embodiment 3 of the present invention may be applicable to an operation with shared spectrum channel access.

Embodiment 3 of the present invention may be applicable to the sidelink resource allocation mode 1.

Therefore, according to what has been described for Embodiment 3, the present invention provides a method whereby, in an operation with shared spectrum channel access, the consistent LBT failure associated with one or more resource pools is canceled according to implicit or explicit indication of a base station, such that a UE can quickly recover from the consistent LBT failure.

### Embodiment 4

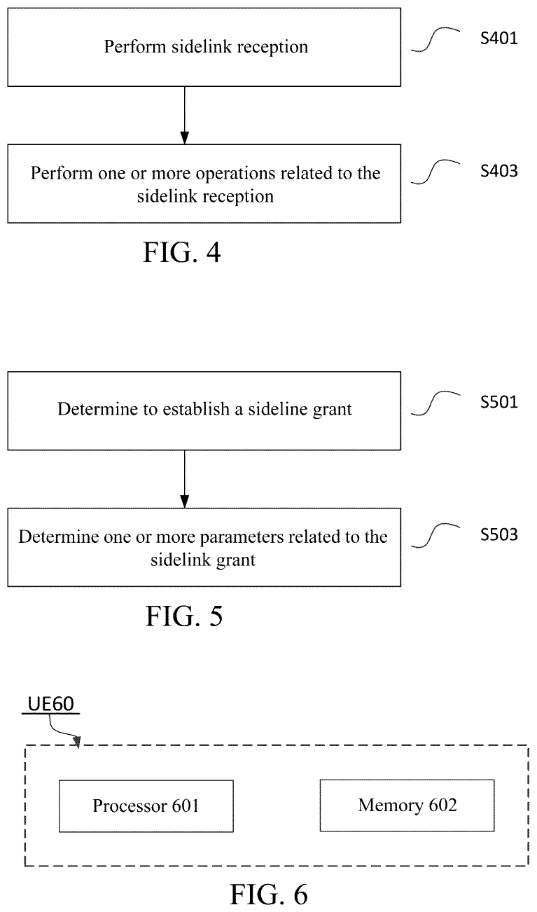

A method performed by a UE according to Embodiment 4 of the present invention will be described below with reference to FIG. 4.

FIG. 4 shows a flowchart corresponding to the method performed by a UE according to Embodiment 4 of the present invention.

As shown in FIG. 4, in Embodiment 4 of the present invention, the steps performed by the UE include: step S401 and step S403.

Specifically, in step S401, sidelink reception is performed.

For example, sidelink reception is performed in a slot (e.g., denoted as

$${t}_{0}^{S L , e} )$$

in a resource pool (e.g., the resource pool

$${e}_{0}^{S L}$$

in the bandwidth part b in the carrier c).

The “sidelink reception” may include detection and/or reception of one or more of the following:
PSCCH.
PSSCH.
PSCCH/PSSCH.
PSFCH.
S-SSB.

As a result of the sidelink reception, the number of sidelink transmissions detected and/or received by the UE may be denoted as

$${N}_{r c v}^{SL , TR} ,$$

wherein

$${N}_{r c v}^{SL , TR}$$

may be a value greater than or equal to 0. For example,

$${N}_{r c v}^{SL , TR} = 0 ,$$

i.e., no sidelink transmission is detected or received; as another example,

$${N}_{r c v}^{SL , TR} = 1 ,$$

and the corresponding sidelink transmission is a PSCCH/PSSCH in the slot

$${N}_{rcv}^{SL , TR}$$

another example,

$${N}_{r c v}^{SL , TR} > 1 ,$$

and the corresponding

$${N}_{r c v}^{SL , TR}$$

sidelink transmissions are

$${N}_{r c v}^{SL , TR}$$

PSFCHs in the same PSFCH occasion in the slot

$${t}_{0}^{SL , e}$$

(e.g., the

$${N}_{rcv}^{SL , TR}$$

PSFCHs may correspond to the HARQ feedback for the same PSCCH/PSSCH transmission). For

$${N}_{rcv}^{SL , TR} \geq 1 , the {N}_{rcv}^{SL , TR}$$

sidelink transmissions may be denoted as

$${tr}_{0}^{SL} , {tr}_{1}^{SL} , … , and {tr}_{{N}_{rcv}^{SL , TR} - 1}^{SL} ,$$

respectively.

The number of type 1 sidelink transmissions in the

$${N}_{rcv}^{SL , TR}$$

sidelink transmissions may be denoted as

$${N}_{rcv}^{SL , TR , 1} ,$$

wherein

$${N}_{rcv}^{SL , TR , 1}$$

may be a integer that satisfies

$$0 \leq {N}_{rcv}^{SL , TR , 1} \leq {N}_{rcv}^{SL , TR} .$$

The type 1 sidelink transmission may be defined as a sidelink transmission that satisfies the type 1 sidelink transmission conditions. For example, for sidelink transmission

$${tr}_{i}^{SL} ( i ∈ \{ 0 , 1 , … , {N}_{rcv}^{SL , TR} - 1 \} ) ,$$

the type 1 sidelink transmission conditions may include one or more (e.g., any of the combinations made by way of “and” or “or”) of the following:
The

$${tr}_{i}^{SL}$$

is an S-SSB transmission.
The

$${tr}_{i}^{SL}$$

is a PSCCH transmission.
The

$${tr}_{i}^{SL}$$

is a PSSCH transmission.
The

$${tr}_{i}^{SL}$$

is a PSCCH/PSSCH transmission.
The

$${tr}_{i}^{SL}$$

(or the carried in the

$${tr}_{i}^{SL} )$$

enables HARQ feedback (e.g., the value in the “HARQ feedback enabling/disenabling indicator” field in the SCI is 1).
The

$$t {r}_{i}^{S L}$$

(or, the SCI carried in the

$$t {r}_{i}^{S L} )$$

triggers a (or, one or more) PSFCH transmission(s) (e.g., an intended PSFCH transmission in a slot later than the slot

$${t}_{0}^{S L , e} ) .$$

The

$$t {r}_{i}^{S L}$$

is a PSFCH transmission.
The “destination UE” corresponding to the

$$t {r}_{i}^{S L}$$

is the UE. For example, the cast type indicated in the SCI carried in the

$$t {r}_{0}^{S L}$$

is unicast, and the destination ID indicated in the SCI corresponds to a source ID of the UE.
A plurality of “destination UEs” corresponding to the

$$t {r}_{i}^{S L}$$

include the UE. For example, the cast type indicated in the SCI carried in the

$$t {r}_{0}^{S L}$$

is groupcast, and the destination ID indicated in the SCI corresponds to a destination ID of the UE; as another example, the cast type indicated in the SCI is broadcast, and the destination ID indicated in the SCI corresponds to a destination ID of the UE.
The

$$t {r}_{i}^{S L}$$

carries the HARQ feedback for a sidelink transmission (e.g., PSCCH/PSSCH transmission) of the UE.
The resources corresponding to the

$$t {r}_{i}^{S L}$$

are HARQ feedback resources corresponding to a sidelink transmission (e.g., PSCCH/PSSCH transmission) of the UE.

The

$${N}_{rcv}^{SL , TR , 1}$$

may be an integer equal to

$${N}_{r c v}^{SL , TR} ,$$

and correspondingly, the type 1 sidelink transmission may be defined as any sidelink transmission.

The result of the “sidelink reception” may be indicated by one protocol layer entity (e.g., the physical layer entity) of the UE to another protocol layer entity (e.g., the MAC layer entity).

Further, in step S403, one or more operations related to the sidelink reception are performed.

For example, if type 1A sidelink reception conditions and/or type 1B sidelink reception conditions are met, then one or more type 1A sidelink operations are performed; as another example, if the type 1A sidelink reception conditions and/or the type 1B sidelink reception conditions are met, then one or more type 1A sidelink operations and/or one or more type 1B sidelink operations are performed; as another example, if the type 1A sidelink reception conditions and/or the type 1B sidelink reception conditions are met, then one or more type 1A sidelink operations and/or one or more type 1C sidelink operations are performed.

The type 1A sidelink reception conditions may include one or more (e.g., any of the combinations made by way of “and” or “or”) of the following:
The resource pool

$${e}_{0}^{S L}$$

is a resource pool associated with a consistent LBT failure (for example, a transmission resource pool associated with a consistent LBT failure; as another example, a reception resource pool associated with a consistent LBT failure), and the consistent LBT failure has not been canceled. For example, a consistent LBT failure has been triggered for the resource pool

$${e}_{0}^{S L}$$

according to the method in Embodiment 1 of the present invention, and the consistent LBT failure has not been canceled.
The resource pool

$${e}_{0}^{S L}$$

is a reception resource pool, and the transmission resource pool corresponding to the resource pool

$${e}_{0}^{SL}$$

(e.g., denoted as

$${e}_{0}^{SL , TX} )$$

is a resource pool associated with a consistent LBT failure, and the consistent LBT failure has not been canceled. For example, a consistent LBT failure has been triggered for the resource pool

$${e}_{0}^{SL , TX}$$

according to the method in Embodiment 1 of the present invention, and the consistent LBT failure has not been canceled.
The resource pool

$${e}_{0}^{SL}$$

is a transmission resource pool, and the reception resource pool corresponding to the resource pool

$${e}_{0}^{SL}$$

(e.g., denoted as

$${e}_{0}^{SL , RX} )$$

is a resource pool associated with a consistent LBT failure, and the consistent LBT failure has not been canceled. For example, a consistent LBT failure has been triggered for the resource pool

$${e}_{0}^{SL , RX}$$

according to the method in Embodiment 1 of the present invention, and the consistent LBT failure has not been canceled.

$${N}_{ttl}^{SL , TR , 1} \geq {N}_{ttl , thresh}^{SL , TR , 1} .$$

$${N}_{ttl}^{SL , TR , 1} > {N}_{ttl , thresh}^{SL , TR , 1} .$$

$${N}_{ttl}^{SL , TS , 1} \geq {N}_{ttl , thresh}^{SL , TS , 1} .$$

$${N}_{ttl}^{SL , TS , 1} > {N}_{ttl , thresh}^{SL , TS , 1} .$$

The

$${N}_{ttl}^{SL , TR , 1}$$

may be defined as the total number of type 1 sidelink transmissions (including the

$${N}_{rcv}^{SL , TR , 1}$$

type 1 sidelink transmissions) received in the resource pool

$${e}_{0}^{SL}$$

(or the corresponding transmission resource pool

$${e}_{0}^{SL , TX} ,$$

or the corresponding reception resource pool

$${e}_{0}^{SL , RX} )$$

since source pool

$${e}_{0}^{SL}$$

has been associated with a consistent LBT failure (e.g., mostly recently associated with a consistent LBT failure). The

$${N}_{ttl , thresh}^{SL , TR , 1}$$

may be a pre-defined or configured value

$$( e . g . , {N}_{ttl , thresh}^{SL , TR , 1} = 1 ) ,$$

or may be determined according to one or more pre-defined or configured values.

The

$${N}_{ttl}^{SL , TS , 1}$$

may be defined as the number of slots where the

$${N}_{ttl}^{SL , TR , 1}$$

type 1 sidelink transmissions are located. The

$${N}_{ttl , thresh}^{SL , TS , 1}$$

may e a pre-defined or configured value (e.g.,

$${N}_{ttl , thresh}^{SL , TS , 1} = 1 ) ,$$

or may be determined according to one or more pre-defined or configured values.

The type 1A sidelink operations may include one or more of the following (performed according to the order of their occurrences, or according to any other order):
Cancel the consistent LBT failure associated with the resource pool

$${e}_{0}^{SL} .$$

Cancel the consistent LBT failure (if any) associated with the resource pool

$${e}_{0}^{SL} .$$

Cancel the consistent LBT failure associated with the resource pool

$${e}_{0}^{SL , TX} .$$

Cancel the consistent LBT failure if an associated with the resource pool

$${e}_{0}^{SL , TX} .$$

Cancel the consistent LBT failure associated with the resource pool

$${e}_{0}^{SL , RX} .$$

Cancel the consistent LBT failure (if any) associated with the resource pool

$${e}_{0}^{SL , RX} .$$

Cancel all of the consistent LBT failures in the bandwidth part b.
Cancel all of the consistent LBT failures (if any) in the bandwidth part b.
Cancel all of the consistent LBT failures in the carrier c.
Cancel all of the consistent LBT failures (if any) in the carrier c.

The type 1B sidelink reception conditions may include one or more (e.g., any of the combinations made by way of “and” or “or”) of the following:

$${N}_{rcv}^{SL , TR , 1} = 1 , and the “ {N}_{rcv}^{SL , TR , 1}$$

type 1 sidelink transmissions” correspond to a PSCCH/PSSCH transmission (e.g., denoted as

$${PSCCH}_{0}^{SL , TR} {\_ PSSCH}_{0}^{SL , TR} ) .$$

The

$${PSCCH}_{0}^{SL , TR} {\_ PSSCH}_{0}^{SL , TR}$$

(or, the SCI carried in the

$${PSCCH}_{0}^{SL , TR} {\_ PSSCH}_{0}^{SL , TR} )$$

enables HARQ feedback (e.g., the value in the “HARQ feedback enabling/disenabling indicator” field in the SCI is 1)
The

$$P S C C {H}_{0}^{S L , T R} {\_PSSCH}_{0}^{S L , T R}$$

(or, the SCI carried in the

$$PSCC {H}_{0}^{S L , T R} {\_PSSCH}_{0}^{S L , T R} )$$

triggers a (or, one or more) PSFCH transmission(s) (e.g., a PSFCH transmission in a slot later than the slot

$${t}_{0}^{S L , e} ) .$$

The type 1B sidelink operations may include: Ignore (or, discard) the PSFCH transmission triggered by the

$$PSCC {H}_{0}^{S L , T R} {\_PSSCH}_{0}^{S L , T R}$$

(or, the SCI carried in the

$$PSCC {H}_{0}^{S L , T R} {\_PSSCH}_{0}^{S L , T R} ) .$$

The type 1C sidelink operations amy include: Perform the PSFCH transmission triggered by the

$$PSCC {H}_{0}^{S L , T R} {\_PSSCH}_{0}^{S L , T R}$$

(or the SCI carried in the

$$PSCC {H}_{0}^{S L , T R} {\_PSSCH}_{0}^{S L , T R} ) .$$

Embodiment 4 of the present invention may be applicable to an operation with shared spectrum channel access.

In Embodiment 4 of the present invention, “reception” may refer to “successful reception”. For example, the CRC of the information carried in the corresponding sidelink transmission (e.g. the CRC added during channel coding) is successfully checked.

Therefore, according to what has been described for Embodiment 4, the present invention provides a method whereby, in an operation with shared spectrum channel access, when particular information is received in a resource pool associated with a consistent LBT failure, the consistent LBT failure associated with the resource pool is canceled, such that a UE can recover from the consistent LBT failure autonomously.

### Embodiment 5

A method performed by a UE according to Embodiment 5 of the present invention will be described below with reference to FIG. 5.

FIG. 5 shows a flowchart corresponding to the method performed by the UE according to Embodiment 5 of the present invention.

As shown in FIG. 5, in Embodiment 5 of the present invention, the steps performed by the UE include: step S501 and step S503.

Specifically, in step S501, it is determined to establish a sidelink grant (e.g., denoted as

$${grant}_{0}^{S L , s e l} ) .$$

For example, the

$${grant}_{0}^{S L , s e l}$$

may be a sidelink grant established by the MAC layer entity of the UE for a sidelink process according to sidelink resource allocation mode 2.

The

$${grant}_{0}^{S L , s e l}$$

may be established by the UE autonomously.

The

$${grant}_{0}^{S L , s e l}$$

may correspond to one or more resources in the resource pool (e.g., denoted as

$${e}_{0}^{S L , s e l} )$$

in the bandwidth part b in the carrier c. The one or more resources may be selected by the UE autonomously, and correspondingly, the sidelink grant may be referred to as a “selected sidelink grant” so as to be distinguished from other sidelink grants (e.g., a sidelink dynamic grant; or, a type 1 sidelink configured grant; or, a type 2 sidelink configured grant).

The

$${grant}_{0}^{S L , s e l}$$

may be related to a logical channel (e.g., denoted as

$$l {c}_{0}^{S L , s e l} ) .$$

For example, the

$${grant}_{0}^{S L , s e l}$$

may correspond to one or more resources (e.g., time/frequency resources) selected (or re-selected) for transmitting the data in the logical channel

$$l {c}_{0}^{S L , sel} .$$

The one or more resources may be used to transmit a single MAC PDU, or used to transmit multiple MAC PDUs.

The

$${grant}_{0}^{S L , s e l}$$

may be related to one or more messages carried via MAC CE (e.g., a sidelink CSI report; or, a sidelink DRX command indication; or, a sidelink inter-UE coordination information report; or, a sidelink inter-UE coordination request). One or more resources corresponding to the

$${grant}_{0}^{S L , s e l}$$

to transmit the one or more messages carried via the MAC CE.

Further, in step S503, one or more parameters related to the sidelink grant is determined.

For example, the resource pool

$${e}_{0}^{S L , s e l}$$

is determined. Specifically, for example, a resource pool is selected from resource pools

$${E}_{c n d}^{SL , A}$$

as the resource pool

$${e}_{0}^{S L , s e l} .$$

The resource pool

$${e}_{0}^{S L , s e l}$$

may be considered to be a resource pool selected for the sidelink grant

$${grant}_{0}^{S L , s e l} .$$

The selection of the resource pool

$${e}_{0}^{S L , s e l}$$

may be triggered by the logical channel

$$l {c}_{0}^{S L , s e l} .$$

For example, type 1 resource pool selection triggering means may be defined as: if the

$${grant}_{0}^{S L , s e l}$$

corresponds to transmission of multiple MAC PDUs, and the logical channel

$$l {c}_{0}^{S L , s e l}$$

has data available for transmission (also referred to as “has data available”), and the MAC layer entity of the UE has not yet selected a resource pool that is allowed to be used for the logical channel

$$l {c}_{0}^{S L , s e l} ,$$

then a resource pool is selected for the

$${grant}_{0}^{S L , s e l}$$

(or, for the data transmission corresponding to the

$${grant}_{0}^{S L , s e l} ;$$

or the logical channel

$$l {c}_{0}^{S L , s e l} ) ;$$

as another example, type 2 resource pool selection triggering means may be defined as: if the

$${grant}_{0}^{S L , s e l}$$

corresponds to transmission of a single MAC PDU, and the logical channel

$$l {c}_{0}^{S L , s e l}$$

has data available for transmission (also referred to as “has data available”), then a resource pool is selected for the

$${grant}_{0}^{S L , s e l}$$

(or, for the data transmission corresponding to the

$${grant}_{0}^{S L , s e l} ;$$

or, for the logical channel

$$l {c}_{0}^{S L , s e l} ) .$$

The selection of the resource pool

$${e}_{0}^{S L , s e l}$$

may be triggered by one or more messages carried via MAC CE. For example, type 3 resource pool selection triggering means may be defined as: if the

$${grant}_{0}^{S L , s e l}$$

corresponds to transmission of a single MAC PDU, and the one or more messages carried via MAD CE are triggered, then a resource pool is selected for the

$${grant}_{0}^{S L , s e l}$$

(or, for the one or more messages carried via MAD CE).

The resource pool

$${e}_{0}^{S L , s e l}$$

may be any resource pool in the set

$${E}_{c n d}^{SL , A} .$$

The set

$${E}_{c n d}^{SL , A}$$

may be a subset of the set of resource pools

$${E}_{c f g}^{SL , A} ,$$

wherein the set

$${E}_{c f g}^{SL , A}$$

may be determined according to one or more pre-defined or configured sets of resource pools (e.g., the set

$${E}_{c f g}^{SL , A}$$

may be a union set of the one or more pre-defined or configured sets of resource pools).

The set

$${E}_{c f g}^{SL , A}$$

may be related to the resource pool selection triggering means. For example, in the type 1 resource pool selection triggering means or the type 2 resource pool selection triggering means, if the data is used for sidelink discovery and a set of resource pools specific to sidelink discovery has been configured (e.g., a set of resource pools configured by the parameter sl-DiscTxPoolSelected), then the set

$${E}_{c f g}^{SL , A}$$

may be the set of resource pools specific to sidelink discovery; as another example, in the type 1 resource pool selection triggering means or the type 2 resource pool selection triggering means, if the data is used for sidelink discovery and the set of resource pools specific to sidelink discovery has not been configured, then the set

$${E}_{c f g}^{SL , A}$$

may be a set of all of the resource pools (or, all of the transmission resource pools) configured for the UE; as another example, in the type 1 resource pool selection triggering means or the type 2 resource pool selection triggering means, if the data is used for sidelink communication, then the set

$${E}_{c f g}^{SL , A}$$

may be a set of all of the resource pools (or, all of the transmission resource pools) configured for the UE. As another example, in the type 3 resource pool selection triggering means, the set

$${E}_{c f g}^{SL , A}$$

may be a set of all of the resource pools (or, all of the transmission resource pools) configured for the UE.

The set

$${E}_{cnd}^{SL , A}$$

may be a set consisting of all of the resource pools remaining after zero, one, or more resource pools are removed from the set

$${E}_{c f g}^{SL , A} .$$

A set consisting of the zero, one, or more resource pools removed may be denoted as

$${E}_{cfg , exc}^{SL , A} ,$$

wherein if zero resource pools are removed, then

$${E}_{cfg , exc}^{SL , A}$$

an empty set.

In the type 1 resource pool selection triggering means (e.g., when the data is used for sidelink communication, or when the data is used for sidelink discovery), and/or the type 2 resource pool selection triggering means (e.g., when the data is used for sidelink communication, or when the data is used for sidelink discovery), and/or the type 3 resource pool selection triggering means, the set

$${E}_{cfg , exc}^{SL , A}$$

may comprise all of the resource pools that satisfy type 1 resource pool removal conditions.

For the resource pool e

$$∈ {E}_{cfg}^{SL , A} ,$$

the type 1 resource pool removal conditions may include one or more (e.g., any of the combinations made by way of “and” or “or”) of the following:
The carrier c is configured with (or, “enabled with”) a consistent LBT failure recovery procedure. For example, the carrier c is configured with one or more parameters of the consistent LBT failure recovery procedure.
The bandwidth part b is configured (or enabled) with the consistent LBT failure recovery procedure. For example, the bandwidth part b is configured with one or more parameters of the consistent LBT failure recovery procedure.
The resource pool e is associated with a consistent LBT failure.
The resource pool e is associated with a consistent LBT failure, and the consistent LBT failure has not been canceled.

In the type 1 resource pool selection triggering means (e.g., when the data is used for sidelink communication), and/or the type 2 resource pool selection triggering means (e.g., when the data is used for sidelink communication), and/or the type 3 resource pool selection triggering means, if the logical channel

$$l {c}_{0}^{S L , s e l}$$

is enabled with HARQ feedback, then the set

$${E}_{c f g ,}^{S L A}$$

may comprise all of the resource pools which are not configured with the PSFCH resource.

In the type 1 resource pool selection triggering means (e.g., when the data is used for sidelink communication), and/or the type 2 resource pool selection triggering means (e.g., when the data is used for sidelink communication), and/or the type 3 resource pool selection triggering means, the set

$${E}_{c fg , exec}^{SL , A}$$

may comprise all of the resource pools in the set of resource pools specific to sidelink discovery.

In the type 1 resource pool selection triggering means (e.g., when the data is used for sidelink communication), and/or the type 2 resource pool selection triggering means (e.g., when the data is used for sidelink communication), if the set of resource pools specific to sidelink discovery has been configured, then the set

$${E}_{c fg , exc}^{SL , A}$$

may be an empty set.

Embodiment 5 of the present invention may be performed by a MAC layer entity of the UE.

Embodiment 5 of the present invention may be applicable to an operation with shared spectrum channel access.

Thus, based on what has been described for Embodiment 5, the present invention provides a method whereby, in an operation with shared spectrum channel access, when a resource pool is selected for a sidelink grant, a resource pool associated with a consistent LBT failure is excluded, thereby ensuring the reliability of sidelink communication and/or sidelink discovery.

### Variant Embodiment

Below, FIG. 6 is used to illustrate a user equipment, as a variant embodiment, that can perform the method performed by a user equipment of the present invention, which has been described in detail hereinabove.

FIG. 6 is a block diagram showing the user equipment according to the present invention.

As shown in FIG. 6, the user equipment (UE) 60 includes a processor 601 and a memory 602. The processor 601 may include, for example, a microprocessor, a microcontroller, or an embedded processor. The memory 220 may, for example, include a volatile memory (e.g., a random access memory (RAM)), a hard disk drive (HDD), a non-volatile memory (e.g., a flash memory), or other memories. The memory 602 has program instructions stored thereon. The instructions, when run by the processor 601, can perform the method performed by a user equipment of the present invention, which has been described in detail hereinabove.

The method and related user equipment according to the present invention have been described above in combination with preferred embodiments. It should be understood by those skilled in the art that the method shown above is only exemplary, and the above-described embodiments can be combined with one another as long as no contradiction arises. The method of the present invention is not limited to the steps or sequences illustrated above. The user equipment illustrated above may include more modules. Various identifiers illustrated above are only exemplary, and are not meant to be limiting. The present invention is not limited to specific information elements serving as examples of these identifiers. Those skilled in the art could make various alterations and modifications according to the teachings of the illustrated embodiments.

It should be understood by those skilled in the art that any set is its own subset. An empty set is a subset of any set. Part or all of the mathematical expressions, mathematical equations, or mathematical inequalities may be simplified or transformed or rewritten to some extent (e.g., merging constant terms, or interchanging two addition terms, or interchanging two multiplication terms, or moving a term from the left side of an equation or inequality to the right side after changing the plus or minus sign thereof, or moving a term from the right side of an equation or inequality to the left side after changing the plus or minus sign thereof, or the like). Mathematical expressions, mathematical equations, or mathematical inequalities before and after the simplification or transformation or rewriting may be considered to be equivalent to each other.

It should be understood that the above-described embodiments of the present invention may be implemented by software, hardware, or a combination of software and hardware. For example, various components in the user equipment in the above embodiments may be implemented by multiple devices, and these devices include, but are not limited to: an analog circuit device, a digital circuit device, a digital signal processing (DSP) circuit, a programmable processor, an application-specific integrated circuit (ASIC), a field-programmable gate array (FPGA), a complex programmable logic device (CPLD), and the like.

In the present invention, the term “base station” may refer to a mobile communication data and/or control switching center having a certain transmission power and a certain coverage area, and, for example, having functions such as resource allocation and scheduling, and data reception and transmission. The term “user equipment” may refer to user mobile terminals, such as terminal devices that can wirelessly communicate with a base station or a micro base station, including a mobile phone, a laptop computer, and the like.

In addition, the embodiments of the present invention disclosed herein may be implemented on a computer program product. More specifically, the computer program product is a product provided with a computer-readable medium having computer program logic encoded thereon. When executed on a computing device, the computer program logic provides related operations to implement the above technical solutions of the present invention. When executed on at least one processor of a computing system, the computer program logic enables the processor to execute the operations (methods) described in the embodiments of the present invention. Such an arrangement of the present invention is typically provided as software, code, and/or other data structures that are configured or encoded on a computer-readable medium, such as an optical medium (e.g., a CD-ROM), a floppy disk or a hard disk, or, for example, firmware or other media of microcodes on one or more ROM or RAM or PROM chips, or downloadable software images, shared database and so on in one or more modules. Software or firmware or such configuration may be installed on a computing device such that one or more processors in the computing device performs the technical solutions described in the embodiments of the present invention.

In addition, each functional module or each feature of the user equipment used in each of the above embodiments may be implemented or executed by a circuit, the circuit is usually one or more integrated circuits. Circuits designed to execute various functions described in this description may include general-purpose processors, digital signal processors (DSPs), application specific integrated circuits (ASICs) or general-purpose integrated circuits, field programmable gate arrays (FPGAs) or other programmable logic devices, discrete gates or transistor logic, or discrete hardware components, or any combination of the above. The general-purpose processor may be a microprocessor, or the processor may be an existing processor, a controller, a microcontroller, or a state machine. The aforementioned general-purpose processor or each circuit may be configured by a digital circuit or may be configured by a logic circuit. Furthermore, when advanced technology capable of replacing current integrated circuits emerges due to advances in semiconductor technology, the present invention can also use integrated circuits obtained using this advanced technology.

While the present invention has been illustrated in combination with the preferred embodiments of the present invention, it will be understood by those skilled in the art that various modifications, substitutions, and alterations may be made to the present invention without departing from the spirit and scope of the present invention. Therefore, the present invention should not be limited by the above-described embodiments, but should be defined by the appended claims and their equivalents.

1-2. (canceled)

3: A method performed by a user equipment (UE), the method comprising:
determining a channel access priority class (CAPC) value for a Type 1 channel access procedure for initiating a channel occupancy time (COT) for multiple sidelink transmissions, wherein,
the CAPC value is the largest value of CAPC values associated with the multiple sidelink transmissions; and
performing the Type 1 channel access procedure based on the determined CAPC value.

4: A user equipment (UE), comprising:
a processor; and
a memory storing instructions,
wherein the processor is configured by the instructions to cause the UE to:
determine a channel access priority class (CAPC) value for a Type 1 channel access procedure for initiating a channel occupancy time (COT) for multiple sidelink transmissions, wherein,
the CAPC value is the largest value of CAPC values associated with the multiple sidelink transmissions; and
perform the Type 1 channel access procedure based on the determined CAPC value.

5: The UE according to claim 4, wherein, the multiple sidelink transmissions are in a slot.

6: The UE according to claim 4, wherein, the multiple sidelink transmissions are in multiple slots.
